(19) United States
(12) Patent Application Publication
(10) Pub. No.: US 2026/0339265 A1
(43) Pub. Date: Oct. 29, 2026

(54) RESTORATION METHOD, METHOD FOR MANUFACTURING UNIT, METHOD FOR MANUFACTURING CONTAINER, AND METHOD FOR DISASSEMBLING CONTAINER

(71) Applicant: CANON KABUSHIKI KAISHA, Tokyo (JP)

(72) Inventors: YASUNORI TORIYAMA, Shizuoka (JP); EMI MACHII, Shizuoka (JP); JUN MIYAMOTO, Shizuoka (JP); KAORI HIRATSUKA, Shizuoka (JP)

(21) Appl. No.: 19/653,303

(22) Filed: Apr. 21, 2026

(30) Foreign Application Priority Data
Apr. 25, 2025 (JP) 2025-072945
Apr. 25, 2025 (JP) 2025-073052

(51) Int. Cl. G03G 21/18; G03G 21/12

(52) U.S. Cl. CPC G03G 21/181; G03G 21/1814; G03G 21/12

(57) ABSTRACT

A restoration method is provided for restoring a first member of a unit so as to be in a reusable state. The unit includes the first member having a first engagement portion, a second member having a second engagement portion, and a connecting member connecting the first member with the second member. The restoration method for the first member includes: a separating step of separating the first member and the second member; an adhering step of adhering the connecting member, which remains on the first engagement portion and which is heated, to a third engagement portion of a removal tool by putting the third engagement portion into a state of engagement with the first engagement portion of the first member; and a removing step of removing the connecting member from the first member by separating the removal tool from the first engagement portion of the first member.

### BACKGROUND

### Field of the Technology

The present disclosure relates to a restoration method for restoring a component of a unit included in an image forming apparatus, a method for manufacturing the unit, an image forming apparatus, a unit included in the image forming apparatus, a developing apparatus including a developer storage container, and reproducing a process cartridge.

### Description of the Related Art

A configuration including a process cartridge, in which a photosensitive drum, charging means, developing means, cleaning means, and the like are combined as a cartridge in a frame body is known as an image forming apparatus using an electrophotographic image forming method (electrophotographic process).

Japanese Patent Application Publication No. 2024-58549 and Japanese Patent Application Publication No. 2002-91267 disclose a process cartridge, in which a hot melt adhesive is used as a connecting member for connecting a plurality of frame components. Japanese Patent Application Publication No. 2002-91267 discloses a method for heating a joint portion as a disassembly method for reusing a component of a process cartridge after toner is consumed.

### SUMMARY

The present disclosure is directed to provide a method for efficiently restoring components of a unit joined using a connecting member.

According to some embodiments, a restoration method for restoring a first member of a unit used in an image forming apparatus to a reusable state, the unit including the first member having a first engagement portion, a second member having a second engagement portion engaged with the first engagement portion, and a connecting member interposed between the first engagement portion and the second engagement portion and connected to both the first member and the second member, at least one of the first engagement portion and the second engagement portion includes a recessed portion and the other of the first engagement portion and the second engagement portion being configured to be engageable with the recessed portion by entering into the recessed portion, the restoration method comprising:
a separating step of separating the first member and the second member;
an adhering step of adhering the connecting member, which remains on the first engagement portion and which is heated, to a third engagement portion of a removal tool by bringing the third engagement portion into engagement with the first engagement portion of the first member; and
a removing step of removing the connecting member from the first member by separating the removal tool from the first engagement portion of the first member.

According to some other embodiments, a method for manufacturing a unit used in an image forming apparatus, the unit including the first member having a first engagement portion, a second member having a second engagement portion engaged with the first engagement portion, and a connecting member interposed between the first engagement portion and the second engagement portion and connected to both the first member and the second member, at least one of the first engagement portion and the second engagement portion includes a recessed portion and the other of the first engagement portion and the second engagement portion being configured to be engageable with the recessed portion by entering into the recessed portion, the manufacturing method comprising:
a joining step of joining the first member restored by a restoration method with the second member using the connecting member, wherein
the restoration method for the first member comprises:
a separating step of separating the first member and the second member;
an adhering step of adhering the connecting member, which remains on the first engagement portion and which is heated, to a third engagement portion of a removal tool by bringing the third engagement portion into engagement with the first engagement portion of the first member; and
a removing step of removing the connecting member from the first member by separating the removal tool from the first engagement portion of the first member.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating the overall configuration of an image forming apparatus according to Embodiment 1.

FIGS. 2A and 2B are perspective views of the exterior of a process cartridge.

FIG. 3 is a cross-sectional view of a process cartridge.

FIG. 4 is a perspective view illustrating a divided configuration of a developing unit.

FIGS. 5A and 5B are diagrams illustrating a joint portion between a developing container and a developing cover.

FIGS. 6A and 6B are perspective views illustrating an assembly process of a developing subunit.

FIG. 7 is a perspective view illustrating a process for applying a connecting member to a developing cover.

FIGS. 8A to 8C are cross-sectional views illustrating the configuration of a joint portion between a developing container and a developing cover in detail.

FIGS. 9A and 9B are perspective views illustrating a developing unit connection process.

FIGS. 10A to 10C are partial perspective views illustrating a method for engaging a developing container and a developing cover.

FIG. 11 is a perspective view illustrating a process for attaching a side cover to a developing container.

FIGS. 12A and 12B are perspective views illustrating a process for filling a developing container with toner.

FIGS. 13A and 13B are perspective views illustrating a process for removing a toner cap from a developing cover.

FIG. 14 is a perspective view illustrating a process for removing side covers from a developing unit.

FIGS. 15A to 15C are schematic diagrams illustrating a method for softening a hot melt of a developing unit.

FIGS. 16A and 16B are perspective views illustrating a process for separating a joint portion between a developing container and a developing cover.

FIG. 17 is a perspective view illustrating a developing container and a developing cover after separation.

FIG. 18 is a perspective view illustrating a removal tool for removing a hot melt from a developing cover.

FIG. 19 is a top view illustrating a coupling portion between a removal tool and a developing cover.

FIG. 20 is a cross-sectional view illustrating an engagement state of a removal tool and a developing cover.

FIG. 21 is a perspective view illustrating a state of a removal tool and a developing cover before engagement.

FIGS. 22A to 22E are cross-sectional views illustrating a process for removing a hot melt using a removal tool.

FIG. 23 is a cross-sectional view illustrating Variation 1 on a removal tool.

FIGS. 24A to 24C are cross-sectional views illustrating a process for removing a hot melt using a removal tool according to Variation 1.

FIG. 25 is a cross-sectional view illustrating Variation 2 on a removal tool.

FIGS. 26A to 26C are cross-sectional views illustrating a process for removing a hot melt using a removal tool according to Variation 2.

FIG. 27 is a perspective view illustrating a removal tool for removing a hot melt from a developing container.

FIG. 28 is a top view illustrating a coupling portion between a removal tool and a developing container.

FIG. 29 is a cross-sectional view illustrating an engagement state of a removal tool and a developing container.

FIG. 30 is a perspective view illustrating a state of a removal tool and a developing container before engagement.

FIGS. 31A to 31C are cross-sectional views illustrating a process for removing a hot melt using a removal tool.

FIG. 32 is a schematic cross-sectional view illustrating the overall configuration of an image forming apparatus according to Embodiment 3.

FIG. 33 is a cross-sectional view illustrating an example of the configuration of a joint portion of a (waste) toner collection portion according to Embodiment 3.

FIG. 34 is a cross-sectional view illustrating the overall configuration of an image forming apparatus.

FIGS. 35A and 35B are perspective views of the exterior of a process cartridge.

FIG. 36 is a cross-sectional view of a process cartridge.

FIG. 37 is a perspective view illustrating a divided configuration of a developing unit.

FIGS. 38A and 38B are diagrams illustrating a joint portion between a developing container and a developing cover.

FIGS. 39A and 39B are perspective views illustrating an assembly process of a developing subunit.

FIG. 40 is a perspective view illustrating a processing for applying a joint member to a developing cover.

FIGS. 41A to 41C are cross-sectional views illustrating the configuration of a joint portion between a developing container and a developing cover in detail.

FIGS. 42A and 42B are perspective views illustrating a developing unit connection process.

FIGS. 43A to 43C are partial perspective views illustrating a method for engaging a developing container and a developing cover.

FIG. 44 is a perspective view illustrating a process for attaching a side cover to a developing container.

FIGS. 45A and 45B are perspective views illustrating a process for filling a developing container with toner.

FIGS. 46A and 46B are perspective views illustrating residual toner processing in a restoration process.

FIG. 47 is a perspective view illustrating a process for disassembling a developing unit in a restoration process.

FIGS. 48A to 48C are schematic diagrams illustrating a method for warming a hot melt in a unit state in a restoration process.

FIGS. 49A and 49B are perspective views illustrating a process for separating a developing container and a developing cover in a restoration process.

FIGS. 50A and 50B are perspective views illustrating a method for warming a hot melt for each of components in a restoration process.

FIG. 51 is a perspective view illustrating a side cover attachment process in a restoration process.

FIGS. 52A to 52C are cross-sectional views illustrating (a variation on) the configuration of a joint portion between a developing container and a developing cover in detail.

FIGS. 53A to 53C are detailed views of a toner cap.

FIGS. 54A and 54B are detailed views of the vicinity of a toner filling port of a developing cover.

FIGS. 55A to 55C are perspective views illustrating a process for attaching a toner cap.

FIG. 56 is a cross-sectional view illustrating an overview of an image forming apparatus body including an internal unit.

### DESCRIPTION OF THE EMBODIMENTS

Exemplary embodiments for carrying out this disclosure will be described in detail hereinafter, on the basis of embodiments, with reference to the drawings. It should be noted, however, that the dimensions, materials, shapes, and relative dispositions of the constituent elements described in the embodiments are to be changed as appropriate depending on the configurations, conditions, and the like of the apparatus to which the disclosure is applied. That is, the scope of the present disclosure is not intended to be limited to the embodiments described below. Furthermore, all the features described in the following embodiments are not necessarily essential to the disclosed solution.

### Embodiment 1

An electrophotographic image forming apparatus according to Embodiment 1 of the present disclosure will be described hereinafter with reference to the drawings. Here, “electrophotographic image forming apparatus” (“image forming apparatus”, hereinafter) refers to an apparatus that forms an image on a recording material using an electrophotographic image forming method. Examples of the image forming apparatus include an electrophotographic copier, an electrophotographic facsimile apparatus, an electrophotographic printer (a laser printer, an LED printer, or the like), a multifunction peripheral combining these (a multifunction printer), an electrophotographic word processor, and the like. As a recording material, a sheet-shaped recording medium such as recording paper or a plastic sheet is included.

The image forming apparatus according to the present embodiment is an image forming apparatus that employs a what is known as a process cartridge system. A process cartridge is a unit that can be attached to and removed from the image forming apparatus, and is a unit having a photosensitive member and a process unit (e.g., a charging member, a developing member, a cleaning member, and the like) that works on the photosensitive member.

A mono-color laser printer to which one process cartridge is attachable and detachable will be described as the image forming apparatus in the following embodiments. Note that the number of process cartridges to be mounted in the image forming apparatus is not limited thereto, and for example, in a full-color laser printer, a plurality of process cartridges forming toner images of different colors from each other are configured in a removable manner.

The configuration of Embodiment 1 will be described in the following order:
1. Laser Printer Configuration
2. Laser Printer Operations
3. Process Cartridge Configuration
4. Developing Unit Configuration
5. Method for Producing New Process Cartridge
6. Process Cartridge Reproduction Method

### 1. Laser Printer Configuration

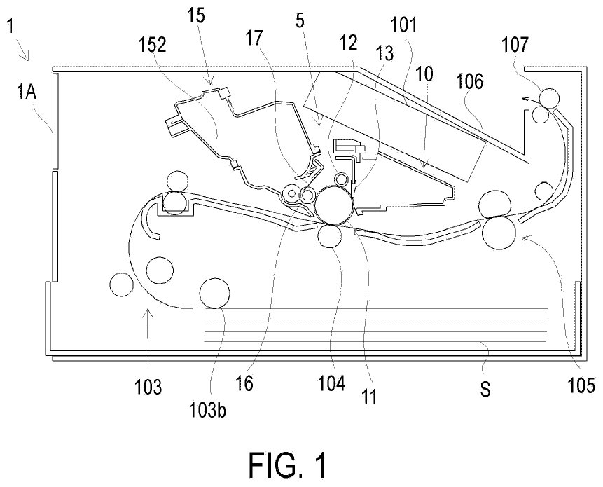

FIG. 1 is a schematic cross-sectional view illustrating the overall configuration of a laser printer 1 serving as an example of the image forming apparatus according to Embodiment 1. The configuration of the laser printer 1 will be described with reference to FIG. 1. A sheet feeding portion 103, a transfer roller 104, a fixing portion 105 (a fixing apparatus), and a laser scanner 101 are installed in the laser printer 1 serving as the image forming apparatus. A process cartridge 5 is removably disposed in a laser printer body 1A.

The process cartridge 5 includes a cleaning unit 10 including a photosensitive drum 11 serving as an image bearing member, and a developing unit 15 including a developing roller 16 serving as a developer bearing member that bears toner serving as a developer.

### 2. Laser Printer Operations

Operations by the laser printer 1 according to Embodiment 1 will be described next. The photosensitive drum 11, which is rotationally driven by a drive source (not shown), is uniformly charged to a predetermined potential by a charging roller 12 (a charging member). A surface of the charged photosensitive drum 11 is subjected to image exposure by the laser scanner 101 based on image information, and the charge of the exposed portion is removed to form an electrostatic latent image. The electrostatic latent image on the photosensitive drum 11 is visualized as a toner image by supplying the toner from the developing roller 16.

Meanwhile, a sheet S is conveyed along the sheet feeding portion 103 in parallel with such toner image forming operations. Specifically, a feeding roller 103b rotates to feed the sheet S. Thereafter, at the timing at which the toner image on the photosensitive drum 11 reaches a transfer portion between the photosensitive drum 11 and the transfer roller 104, the sheet S is also conveyed to the transfer portion. When the sheet S passes through the transfer portion, the toner image is transferred to the sheet S as an unfixed image by applying a DC voltage to the transfer roller 104. Thereafter, the sheet S to which the toner image has been transferred is conveyed to the fixing portion 105. While the sheet S conveyed to the fixing portion 105 passes through the fixing portion 105, the unfixed image is heated and pressurized to be fixed on the surface of the sheet S. Thereafter, the sheet S is further conveyed by a discharge roller pair 107, and is discharged to and stacked on a discharge tray 106.

### 3. Process Cartridge Configuration

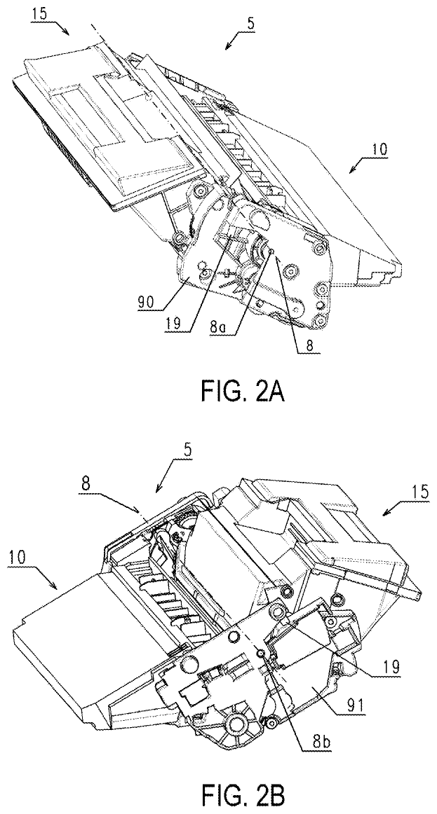

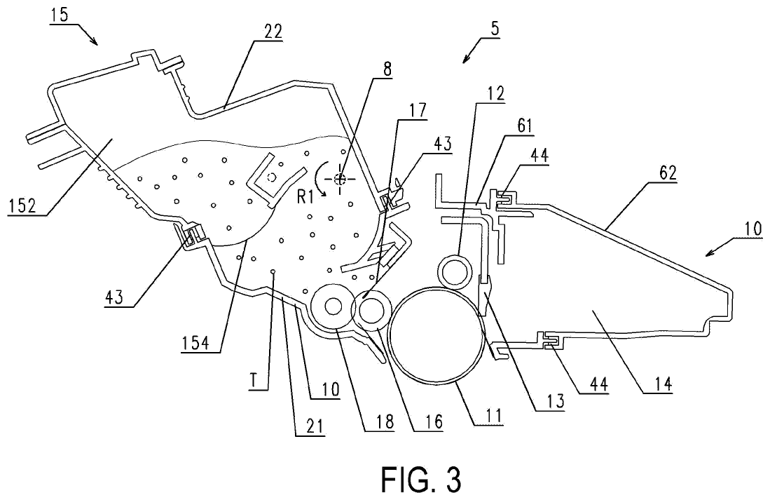

The configuration of the process cartridge 5 according to Embodiment 1 will be described in detail with reference to FIGS. 2A and 2B and FIG. 3. FIGS. 2A and 2B are perspective views of the exterior of the process cartridge 5. FIG. 2A is a schematic perspective view taken from one side of the process cartridge 5 in a direction perpendicular to FIG. 1 (an axial direction of the photosensitive drum 11), and FIG. 2B is a schematic perspective view taken from the other side. FIG. 3 is a schematic cross-sectional view of the process cartridge 5 when the process cartridge 5 is cut in a direction perpendicular to the axis of the photosensitive drum 11.

As illustrated in FIGS. 2A and 2B, the process cartridge 5 includes the developing unit 15 and the cleaning unit 10, and the developing unit 15 and the cleaning unit 10 are connected by coupling pins 8a and 8b. The developing unit 15 is coupled to the cleaning unit 10 so as to be capable of rotating about a straight line connecting the center axes of the coupling pins 8a and 8b (a rotation center 8). The rotation center 8 is a straight line substantially parallel to the axis of the photosensitive drum 11.

As illustrated in FIG. 3, the charging roller 12 provided in the cleaning unit 10 is a contact charging-type charging member that contacts the photosensitive drum 11 and rotates under the rotation of the photosensitive drum 11. A cleaning blade 13 is an elastic rubber blade, and a tip portion thereof is disposed in contact with the photosensitive drum 11. The cleaning blade 13 serves to remove toner remaining on the photosensitive drum 11. The toner collected by the cleaning blade 13 is stored in a waste toner containment portion 14 in the cleaning unit 10.

The developing unit 15 includes a developing roller 16, a developing blade 17, and a developer supply roller 18 as a developer. The developing unit 15 further includes a developing chamber 151, a developer storage chamber 152, and a stirring member 154. The toner in the developer storage chamber 152 is conveyed to the developer supply roller 18 while being stirred by the stirring member 154. The developer supply roller 18 contacts the developing roller 16 disposed in the developing chamber 151 to supply the toner. The developing blade 17 is disposed with the tip portion thereof in contact with the developing roller 16. The developing blade 17 serves to regulate the toner borne on the circumferential surface of the developing roller 16 to a thin layer.

The developing unit 15 is biased by a pressure spring 19 (see FIGS. 2A and 2B), which is an elastic member, and is configured such that the developing roller 16 contacts the photosensitive drum 11 about the rotation center 8. A moment in the direction R1 in FIG. 3 acts on the developing unit 15 by the biasing force from the pressure spring 19. As a result, the developing roller 16 can contact the photosensitive drum 11 at a predetermined pressure.

### 4. Developing Unit Configuration

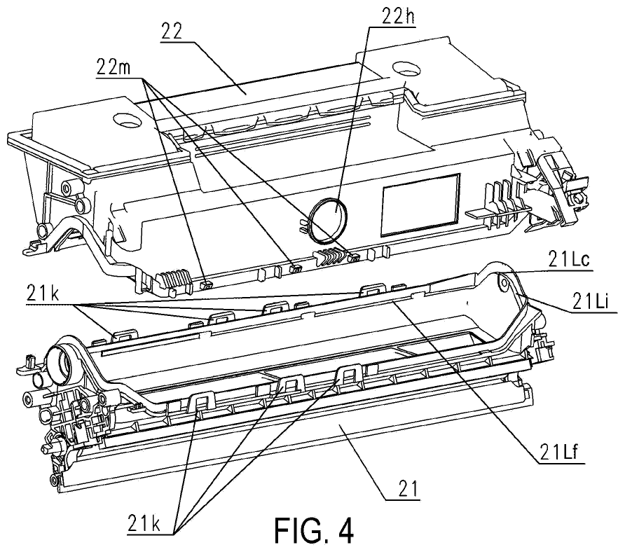

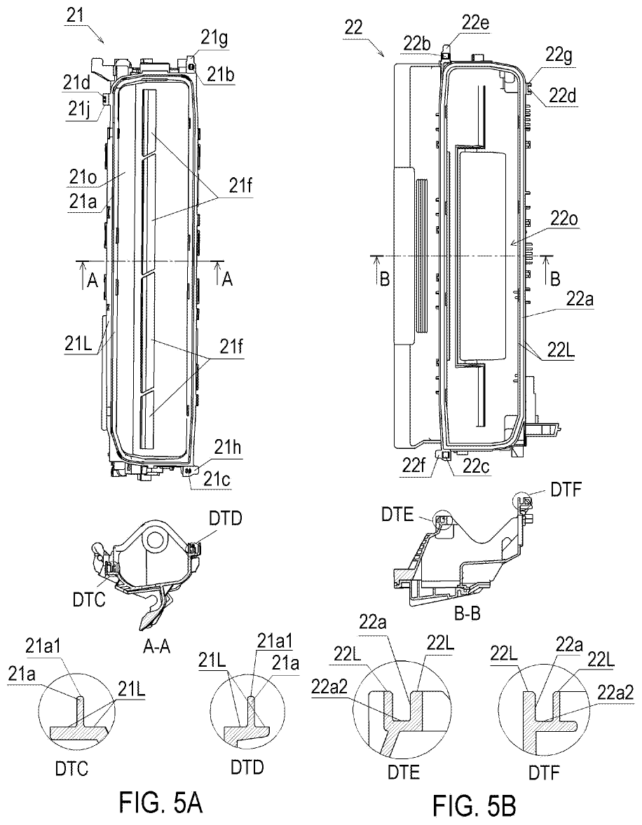

The configuration of the developing unit 15 of the process cartridge 5 will be described with reference to FIGS. 3 and 4 and FIGS. 5A and 5B. FIG. 4 is a perspective view illustrating a divided configuration of the developing unit 15. FIGS. 5A and 5B are diagrams illustrating joint portions between a developing container 21 and a developing cover 22, and are diagrams, cross-sectional views, and detailed views from opposite sides of each joint portion (the sides where each of openings is open). FIG. 5A is a diagram illustrating the developing container 21, and illustrates an A-A cross-section, as well as an enlarged view DTC and an enlarged view DTD in which the joint portion in the A-A cross-section is enlarged. FIG. 5B is a diagram illustrating the developing cover 22, and illustrates a B-B cross-section, as well as an enlarged view DTE and an enlarged view DTF in which the joint portion in the B-B cross-section is enlarged. The A-A cross-section and the B-B cross-section are both cross-sections perpendicular to the rotation center 8, which is the rotation axis of the developing unit 15.

As illustrated in FIGS. 3 and 4, the developing unit 15 is constituted by the developing container 21 as a resin first frame body that holds the developing roller 16 and the developing blade 17, which are main components, and the developing cover 22 as a resin second frame body that occupies a large frame part of the developer storage chamber 152. The interior space of the developing unit 15, and in particular the developer storage chamber 152, is formed by connecting the interior space of the developing container 21 with the interior space of the developing cover 22.

As illustrated in FIG. 5A, the developing container 21 has an opening 21o (a first opening) that leaves the interior space thereof open. The opening 21o in the developing container 21 is an opening for the interior of the developing container 21 to communicate with the interior of the developing cover 22. As illustrated in FIG. 5B, the developing cover 22 has an opening 22o (a second opening) that leaves the interior space thereof open. The opening 22o in the developing cover 22 is an opening for the interior of the developing cover 22 to communicate with the interior of the developing container 21. That is, the openings 21o and 22o are connected to each other, such that the interior space of the developing container 21 and the interior space of the developing cover 22 communicate with each other.

The developing container 21 and the developing cover 22 are joined to each other by joining the open edge portions of the respective openings 21o and 22o to each other in a sealed manner. A joint line 21L (a joint surface), which is an annular joint surface, is provided at the open edge portions of the opening 21o of the developing container 21 so as to surround the opening 21o of the developing container 21. Likewise, a joint line 22L (a joined surface), which is an annular joint surface, is provided at the open edge portions of the opening 22o of the developing cover 22 so as to surround the opening 22o of the developing cover 22.

A rib 21a (a protruding portion) is provided in the surface of the joint line 21L of the developing container 21, annularly along the direction in which the joint line 21L extends surrounding the opening 21o, so as to protrude from the surface of the joint line 21L. In addition, a groove 22a (a recessed portion) is provided in the surface of the joint line 22L of the developing cover 22, annularly along the direction in which the joint line 22L extends surrounding the opening 22o, so as to be recessed from the surface of the joint line 22L.

The annular rib 21a is inserted into the annular groove 22a, and a hot melt 43, which is a hot melt adhesive serving as a connecting member (described later) in the gap therebetween, so as to join and seal the developing container 21 and the developing cover 22 together. In other words, an annular joint portion is formed between the developing container 21 and the developing cover 22, and the developing container 21 and the developing cover 22 are integrated over the hot melt 43 serving as the connecting member.

The joint line 21L includes a flat surface portion 21Lf (a first portion) extending in a flat form, an inclined surface portion 21Li (a second portion) extending in a direction inclined relative to the flat surface portion 21Lf, a curved surface portion 21Lc (a third portion) extending in a curved shape, and the like. In other words, an inclined portion such as the inclined surface portion 21Li and the curved surface portion 21Lc, located in a position different from the flat surface portion 21Lf, includes a portion extending in such a manner as to be farther away from the flat portion 21Lf in a direction orthogonal to the flat portion 21Lf as the inclined portions extend in a direction along the opening edge of the opening 21o. The inclined surface portion 21Li may also include a portion that extends in a curved shape. In other words, the joint line 21L is a joint line having a height that changes in a direction opposite the joint line 22L. In addition, a tip surface 21a1 of the rib 21a is formed along the joint line 21L. In other words, the tip surface 21a1 of the rib 21a also includes a flat surface portion (a first portion) extending in a flat form, an inclined surface portion (a second portion) extending in a direction inclined relative to the flat surface portion, a curved surface portion (a third portion) extending in a curved shape, and the like.

Similarly, the joint line 22L includes a flat surface portion 22Lf (a first portion) extending in a flat form, an inclined surface portion 22Li (a second portion) extending in a direction inclined relative to the flat surface portion 22Lf, a curved surface portion 22Lc (a third portion) extending in a curved shape, and the like. In other words, an inclined portion such as the inclined surface portion 22Li and the curved surface portion 22Lc, located in a position different from the flat surface portion 22Lf, includes a portion extending in such a manner as to be farther away from the flat portion 22Lf in a direction orthogonal to the flat portion 22Lf as the inclined portions extend in a direction along the opening edge of the opening 22o. The inclined surface portion 22Li may also include a portion that extends in a curved shape. In other words, the joint line 22L is a joint line having a height that changes in a direction opposite the joint line 21L. In addition, a bottom surface 22a2 of the groove 22a is formed along the joint line 22L. In other words, the bottom surface 22a2 of the groove 22a also includes a flat surface portion (a first portion) extending in a flat form, an inclined surface portion (a second portion) extending in a direction inclined relative to the flat surface portion, a curved surface portion (a third portion) extending in a curved shape, and the like.

### 5. Method for Producing New Process Cartridge

A method for producing (a method for manufacturing) the process cartridge 5 according to the present embodiment will be described next. A method for producing the developing unit 15 in particular will be described in detail hereinafter, with a configuration for positioning a frame body. Note that many components such as a stirring member, a sealing member, and gears are assembled in the developing unit 15, but a method for assembling components related to main portions of the developing unit 15 according to the present embodiment will be described here, and descriptions of other components will be omitted as appropriate. Each process for producing the new process cartridge 5 will be described hereinafter as a production process. Note that “new process cartridge 5” here means that the main components provided in the process cartridge 5 are not restored or reused, but rather are new.

### Production Process 1: Assembly of Developing Subunit

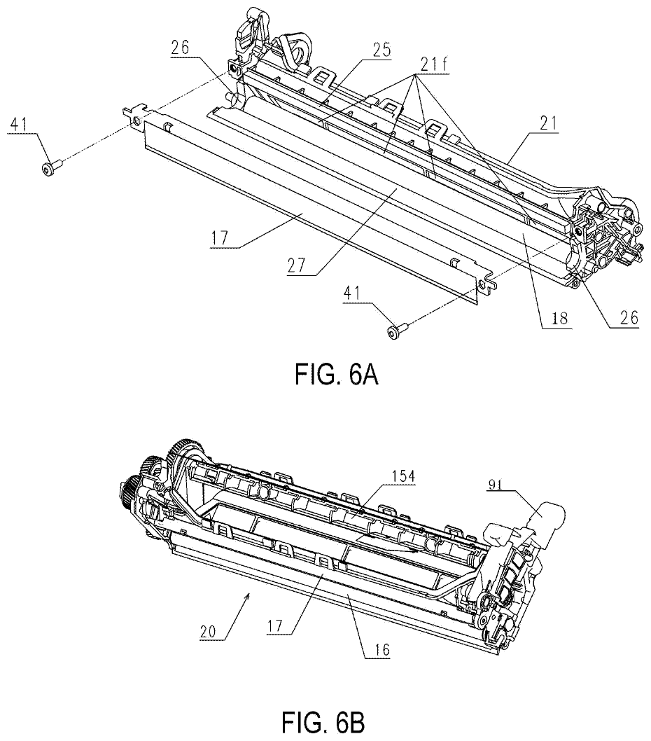

An assembly process (Production Process 1) for a developing subunit 20 will be described with reference to FIGS. 6A and 6B. FIG. 6A is an assembly perspective view illustrating a process for assembling a developing blade with the developing container 21, and FIG. 6B is a completed perspective view of the developing subunit 20.

First, as illustrated in FIG. 6A, the developer supply roller 18 is attached to the developing container 21. Next, a blade back seal 25, an end seal 26, and a blowout prevention member 27, which are sealing members for sealing a periphery of a developing opening 21f of the developing container 21, are attached. Then, the developing blade 17 is assembled and fixed with screws 41, as illustrated. Furthermore, other components, such as the developing roller 16, gears, the stirring member 154, a side cover 91, and the like, are assembled, and the developing subunit 20 illustrated in FIG. 6B is complete.

In the present embodiment, prior to the joining of the developing unit 15, most of the components constituting the developing unit 15 are assembled in the developing container 21 to become the developing subunit 20.

### Production Process 2: Application of Connecting Member to Developing Cover

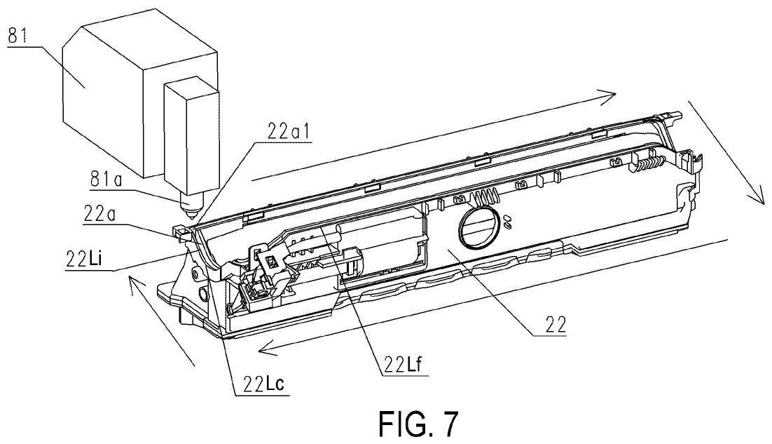

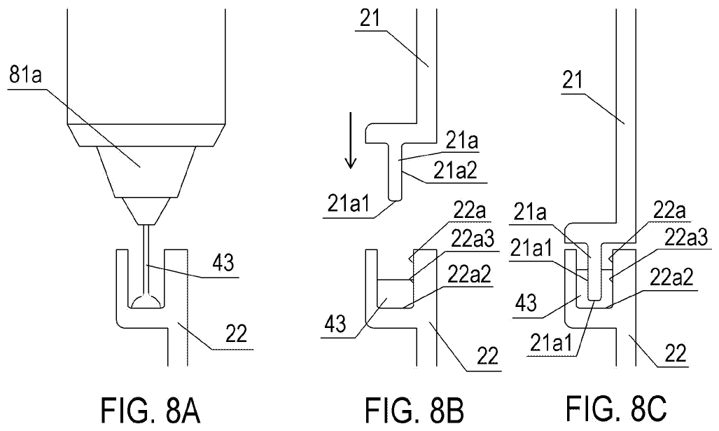

An application process (Production Process 2) for the hot melt 43, which is the connecting member that connects (joins) the developing container 21 and the developing cover 22, will be described with reference to FIG. 7 and FIGS. 8A to 8C. FIG. 7 is a perspective view illustrating a process for applying a hot melt to the developing cover 22, and FIGS. 8A to 8C are schematic cross-sectional views illustrating the configuration of the joint portion between the developing container 21 and the developing cover 22 in detail. FIG. 8A illustrates a state in which the hot melt 43 is injected into the groove 22a. FIG. 8B illustrates a state immediately prior to engagement between the rib 21a and the groove 22a. FIG. 8C illustrates a state in which the rib 21a and the groove 22a are engaged.

As illustrated in FIG. 7, the hot melt 43, which is the connecting member, is applied to the groove 22a formed across the entire periphery of the opening in the frame body of the developing cover 22. Starting from a buffer portion 22a1 of the groove 22a, an application nozzle 81a for a hot melt applicator apparatus 81 moves relative to the groove 22a along the direction in which the groove 22a extends annularly, and the hot melt 43 is applied in a single stroke in the direction of the arrow in the figure (over the entirety of the annular groove 22a at one time). At this time, the state in which the application nozzle 81a is brought toward the groove 22a and the hot melt 43 is injected is illustrated in FIG. 8A.

### Production Process 3: Joining of Developing Container and Developing Cover

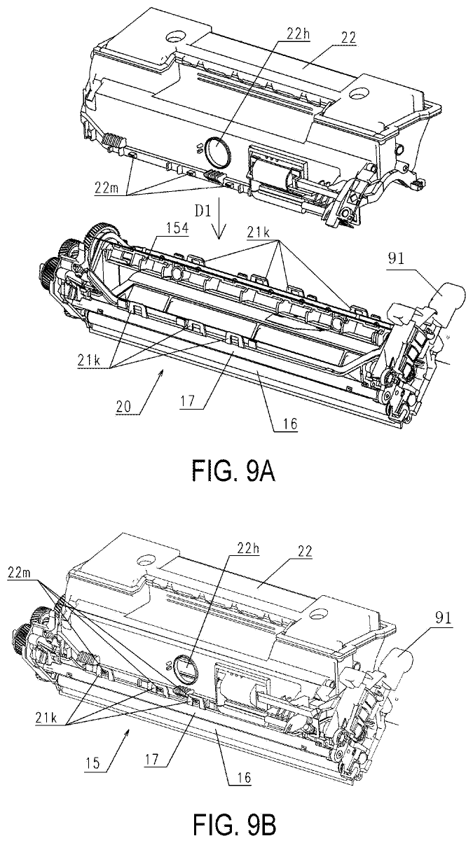

A joining process (Production Process 3) and a positioning configuration for the developing subunit 20 including the developing container 21 and the developing cover 22 will be described with reference to FIGS. 5A and 5B, FIGS. 8A to 8C and FIGS. 9A and 9B. FIGS. 9A and 9B are perspective views illustrating states before and after the developing subunit 20 and the developing cover 22 are joined. FIG. 9A illustrates a state immediately before the developing subunit 20 and the developing cover 22 are joined, and FIG. 9B illustrates a state immediately after the developing subunit 20 and the developing cover 22 are joined.

In the joining process, the developing cover 22 to which the hot melt 43 has been applied is assembled with the developing subunit 20 as illustrated in FIG. 9A while the hot melt 43 is in a molten state, which results in the joined state illustrated in FIG. 9B. Through this assembly, the joint portion between the developing subunit 20 and the developing cover 22 changes from the state illustrated in FIG. 8B to that illustrated in FIG. 8C, in which the rib 21a is inserted into the groove 22a such that at least the tip portion of the rib 21a is immersed in the hot melt 43 in the molten state.

Note that in Embodiment 1, the developing container 21 and the developing cover 22 are joined in a state where abutting surfaces (described later) provided in the developing container 21 and the developing cover 22 abut each other. Each abutting surface is a surface facing the joining direction between the developing container 21 and the developing cover 22, like the joint line 21L and the joint line 22L.

As illustrated in FIG. 8C, in the state where the developing container 21 and the developing cover 22 are joined, the joint line 21L and the joint line 22L are opposed to each other such that a gap is present in the joining direction. Likewise, the tip surface 21a1 of the rib 21a and the bottom surface 22a2 of the groove 22a are opposed to each other such that a gap is present in the joining direction. The width of the rib 21a is smaller than the width of the groove 22a, and a vertical wall surface 21a2 of the rib 21a and a vertical wall surface 22a3 of the groove 22a (a surface connecting the joint line 22L and the bottom surface 22a2) are also opposed. Note that the vertical wall surface 21a2 is a surface connecting the joint line 21L with the tip surface 21a1 and facing in the width direction of the rib 21a (the left-right direction in FIG. 8C), and the vertical wall surface 22a3 is a surface connecting the joint line 22L with the bottom surface 22a2 and facing in the width direction of the groove 22a. The hot melt 43 is provided between the rib 21a and the groove 22a so as to contact at least both of the tip surface 21a1 of the rib 21a and the bottom surface 22a2 of the groove 22a.

As illustrated in FIG. 5A, the developing container 21 is provided with a first positioning boss 21b and a second positioning boss 21c as positioning portions for regulating the position in a longitudinal direction (a direction parallel to the center axis of the photosensitive drum 11). On the other hand, as illustrated in FIG. 5B, the developing cover 22 is provided with a positioning hole 22b in a position opposite the first positioning boss 21b, and a rotation stopping hole 22c in a position opposite the second positioning boss 21c. The position in the longitudinal direction is regulated by fitting the first positioning boss 21b with the positioning hole 22b and fitting the second positioning boss 21c with the rotation stopping hole 22c. In this manner, the first positioning boss 21b, the positioning hole 22b, the second positioning boss 21c, and the rotation stopping hole 22c function as a positioning configuration for the developing container 21 (the developing subunit 20) and the developing cover 22.

Additionally, as illustrated in FIG. 5A, the developing container 21 is provided with a first abutting surface 21g, a second abutting surface 21h, and a third abutting surface 21j. On the other hand, as illustrated in FIG. 5B, the developing cover 22 is provided with a first abutting surface 22e, a second abutting surface 22f, and a third abutting surface 22g in positions opposite the stated abutting surfaces. These abutting surfaces constitute positioning portions for the assembling direction, in the developing subunit 20 and the developing cover 22. FIG. 9A illustrates the assembling direction for the developing subunit 20 of the developing cover 22 as an arrow direction D1. When the developing subunit 20 and the developing cover 22 are assembled, the first abutting surface 21g and the first abutting surface 22e abut each other, the second abutting surface 21h and the second abutting surface 22f abut each other, and the third abutting surface 21j and the third abutting surface 22g abut each other. Such a configuration regulates a relative position of the developing subunit 20 and the developing cover 22 in the assembling direction. Each abutting surface is provided on the outer side of the joint line with respect to the interior space of the frame body.

When the developing cover 22 is positioned with respect to the developing container 21 (the developing subunit 20), the joint portion is in the joined state illustrated in FIG. 8C. Accordingly, the developing container 21 (the developing subunit 20) and the developing cover 22 illustrated in FIG. 8C are joined over the hot melt 43 across the entirety of the joint portion.

In this manner, in Embodiment 1, the developing cover 22 serving as a first member (a first frame body) and the developing container 21 serving as a second member (a second frame body) are positioned and joined to each other, which forms the developing unit 15. Specifically, the developing cover 22 (the first member) has a first positioning portion including a rotation stopping hole, an abutting surface, and the like, and the developing container 21 (the second member) has a second positioning portion including a positioning boss, an abutting surface, and the like that engage the first positioning portion. Note that the configurations of the positioning portions are not limited to the configurations of the present embodiment. For example, the configuration may be such that the developing cover 22 has a positioning boss, and the developing container 21 has a rotation stopping hole that engages with the positioning boss. In addition, the developing cover 22 has the joint line 22L as a first surface, and the developing container 21 has the joint line 21L, located opposite the joint line 22L, as a second surface. Here, the “first” and “second” of the first member and the second members herein are numbers assigned for identification purposes, and thus for the sake of convenience, the developing container 21 may be regarded as the first member and the developing cover 22 as the second member. Likewise, the “first” and “second” of the first positioning portion and the second positioning portion are numbers assigned for identification purposes, and for the sake of convenience, the positioning portion of the developing container 21 may be regarded as the first positioning portion and the positioning portion of the developing cover 22 as the second positioning portion.

In addition, in a state where the developing cover 22 (the first member) and the developing container 21 (the second member) are positioned and joined to each other, the groove 22a serving as a first engagement portion of the developing cover 22 and the rib 21a serving as a second engagement portion of the developing container 21 engage each other. Note that the configurations of the engagement portions are not limited to the configurations of the present embodiment. For example, the configuration may be such that the developing cover 22 has a rib, and the developing container 21 has a groove that engages with the rib. The “first” and “second” of the first member and the second member herein are numbers assigned for identification purposes, and for the sake of convenience, the rib 21a may be regarded as the first engagement portion and the groove 22a as the second engagement portion.

### Production Process 4: Engagement of Developing Container and Developing Cover

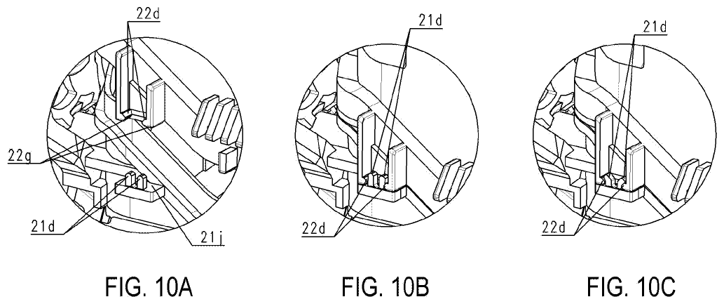

An engagement process (Production Process 4) and an engagement method for the developing subunit 20 and the developing cover 22 will be described next with reference to FIGS. 9A and 9B and FIGS. 10A to 10C. FIGS. 10A to 10C are enlarged perspective views of the vicinity of engagement portions provided in the third abutting surfaces 21j and 22g of the developing subunit 20 and the developing cover 22.

For example, if the cartridge is exposed to high temperatures during transport, or if pressure changes occur during air transport or transport at high altitudes, the internal pressure within the developer storage chamber 152 (FIG. 3), which is sealed to prevent toner leakage, will rise. Then, a load is applied to the developing subunit 20 and the developing cover 22 in the direction in which the joining of the two disengages (the direction opposite from the arrow direction D1 in FIG. 9A). At this time, the frame body deformed easily at the center part in the longitudinal direction of the developing subunit 20 and the developing cover 22 (the direction parallel to the center axis of the photosensitive drum 11), and there is a risk that the joint created by the hot melt will disengage.

As illustrated in FIG. 9A, in the present embodiment, a snap-fit shape 21k is provided on the developing container 21 side, and an engagement claw 22m is provided on the developing cover 22 side, at seven locations each. As illustrated in FIG. 9B, in the state where the developing subunit 20 and the developing cover 22 are joined, the engagement claw 22m engages with the snap-fit shape 21k, which prevents the joint portion from disengaging when the internal pressure in the developer storage chamber 152 rises.

Furthermore, the engagement portions provided at the same locations as the third abutting surfaces 21j and 22g among the three abutting surfaces will be described with reference to FIGS. 10A to 10C. In FIGS. 10A to 10C, the third abutting surface 21j on the developing container 21 side is provided with a fixed rib 21d as the engagement portion, and the third abutting surface 22g of the developing cover 22 is provided with a notch shape 22d (a notch portion) as an engaged portion. FIG. 10A illustrates a state immediately before the developing subunit 20 and the developing cover 22 are joined, FIG. 10B illustrates a state immediately after being joined, and FIG. 10C illustrates a state after the engagement.

After the developing subunit 20 and the developing cover 22 approach each other as illustrated in FIG. 10A, when the developing subunit 20 and the developing cover 22 are joined as illustrated in FIG. 10B, the third abutting surfaces 21j and 22g abut each other. Upon doing so, the fixed rib 21d is inserted into the notch portion of the notch shape 22d. At this time, the fixed rib 21d and the notch shape 22d have a gap in the longitudinal direction of the developing unit 15 (the direction parallel to the center axis of the photosensitive drum 11), and thus are not involved in regulation in the longitudinal direction. Then, as illustrated in FIG. 10C, the tip of the fixed rib 21d is heated and deformed to engage with the notch shape 22d, which completes the fixing that regulates the distance between the third abutting surfaces 21j and 22g.

Through the engagement process described above, the developing subunit 20 and the developing cover 22 are positioned and fixed to each other, and the hot melt 43, which is a molten resin, is cooled and cured (a curing process), which integrates the developing subunit 20 with the developing cover 22 and completes the frame body of the developing unit 15.

Production Process 5: Filling Developing Unit with Toner

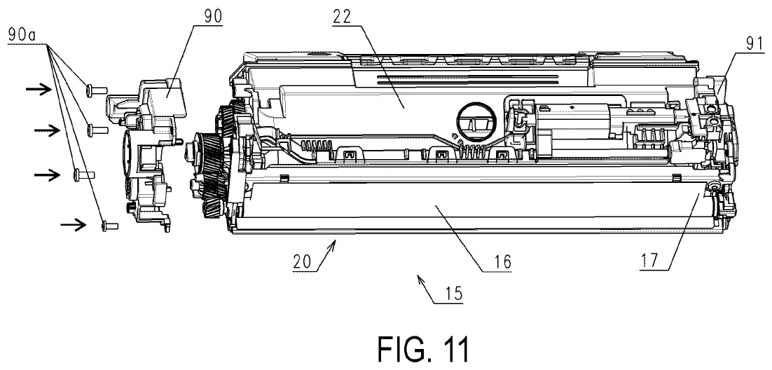

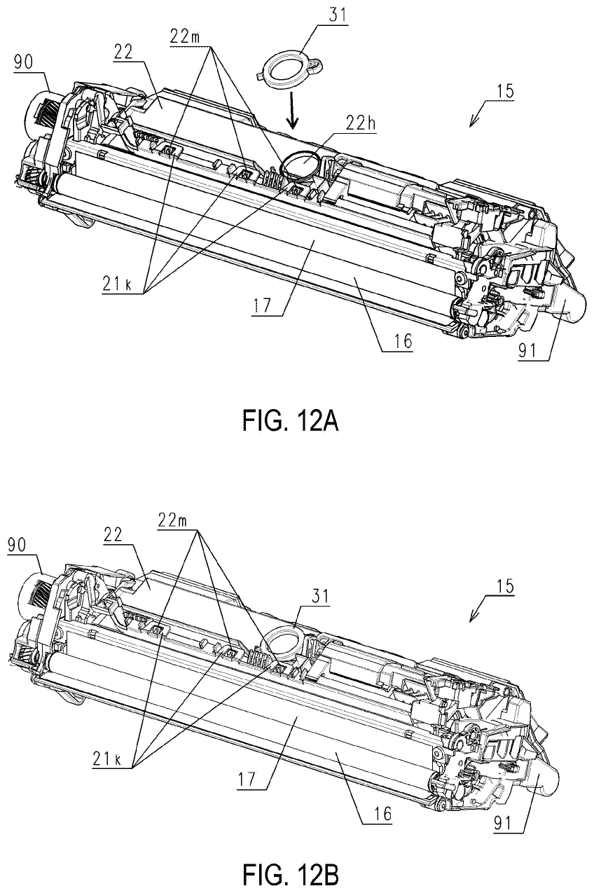

A process for filling the developing unit 15 with toner (Production Process 5) as the remaining process for completing the developing unit 15 will be described with reference to FIG. 11 and FIGS. 12A and 12B. FIG. 11 illustrates a process for attaching a side cover 90 to the developing unit 15, and FIGS. 12A and 12B illustrate a process for filling the developing unit 15 with toner. FIG. 12A illustrates a state before a cap member 31 is attached to the developing cover 22 of the developing unit 15, and FIG. 12B illustrates a state after the cap member 31 is attached to the developing cover 22.

First, as illustrated in FIG. 11, the side cover 90 is assembled to the joined developing unit 15 with screws 90a. Thereafter, a predetermined amount of toner is filled from a toner filling port 22h, which is a hole for filling toner provided in the developing cover 22 illustrated in FIG. 12A. Then, as illustrated in FIG. 12B, the developing unit 15 is completed by sealing the toner filling port 22h with the cap member 31 (a toner cap).

### Production Process 6: Coupling Cleaning Unit and Developing Unit

A process for coupling the cleaning unit 10 and the developing unit 15 (Production Process 6) will be described with reference to FIGS. 2A and 2B and FIG. 3. As illustrated in FIGS. 2A and 2B and FIG. 3, the cleaning unit 10 and the developing unit 15 are aligned such that holes in the developing unit 15 into which the coupling pins 8a and 8b of the cleaning unit 10 are to enter overlap. Then, the cleaning unit 10 and the developing unit 15 are coupled by inserting the coupling pins 8a and 8b into the overlapping holes. Finally, the pressure spring 19 that biases the developing unit 15 such that the developing roller 16 contacts the photosensitive drum 11 with the rotation center 8 as a support point is attached between the cleaning unit 10 and the developing unit 15. This completes the process for manufacturing a new process cartridge 5.

### 6. Process Cartridge Reproduction Method

Next, a method for reproducing (a method for remanufacturing) the process cartridge 5 will be described in order, according to the following Reproduction Process 1 to Reproduction Process 6.
Reproduction Process 1: Separation of Cleaning Unit and Developing Unit
Reproduction Process 2: Residual Toner Processing
Reproduction Process 3: Side Cover Separation
Reproduction Process 4: Developing Frame Body Restoration
Reproduction Process 5: Developing Unit Interior Maintenance
Reproduction Process 6: Reassembly (Same as Production Processes 1 to 6)

Note that the reproduction method according to the present embodiment includes a preparation process for preparing the process cartridge 5 serving as the base material before performing the stated Reproduction Processes 1 to 6. For example, a used process cartridge 5 from which the toner has been consumed through image forming operations is used as the process cartridge 5 serving as the base material. The reproduction method according to the present embodiment is a method for reproducing a new developing unit 15 from the developing unit 15 of the process cartridge 5 serving as the base material. Furthermore, the reproduction method according to the present embodiment is a method for reproducing a new process cartridge 5 from the process cartridge 5 serving as the base material. In other words, the “reproduction” of the process cartridge 5 refers to producing a new process cartridge 5 by disassembling a used process cartridge 5 that was once produced as a product and then reusing the obtained components to produce a new process cartridge 5.

### Reproduction Process 1: Separation of Cleaning Unit and Developing Unit

Reproduction Process 1 is a process for separating the cleaning unit 10 and the developing unit 15. Reproduction Process 1 will be described with reference to FIGS. 2A and 2B and FIG. 3.

Reproduction Process 1 is a process that performs Production Process 6 in reverse order. First, the pressure spring 19 that biases the developing unit 15 such that the developing roller 16 contacts the photosensitive drum 11 with the rotation center 8 as a support point is removed from the process cartridge 5. Next, the coupling pins 8a and 8b that couple the cleaning unit 10 and the developing unit 15 are pulled from the holes provided in the cleaning unit 10 and the developing unit 15, respectively, to separate the cleaning unit 10 and the developing unit 15.

### Reproduction Process 2: Residual Toner Processing

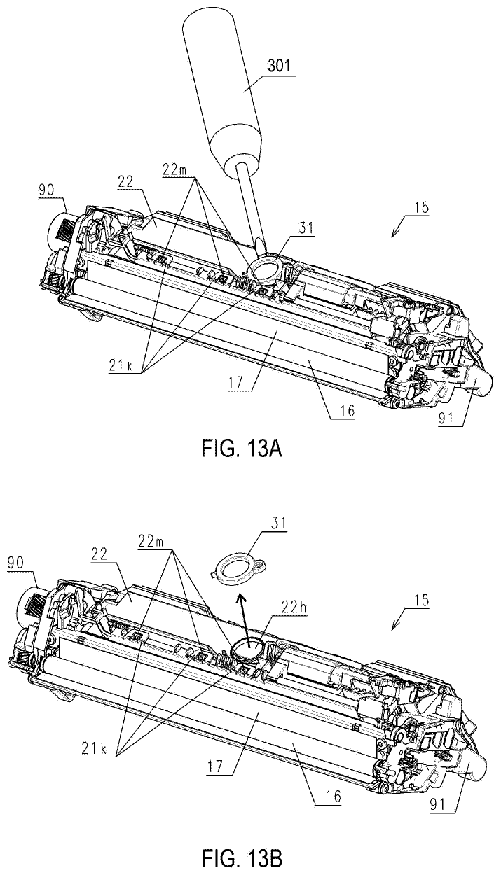

Reproduction Process 2 is a process for removing toner remaining in the developing unit 15. Reproduction Process 2 will be described with reference to FIGS. 13A and 13B. FIGS. 13A and 13B are perspective views of the developing unit 15, illustrating a process for removing the cap member 31 from the developing cover 22.

FIG. 13A illustrates an example of an operation for removing the cap member 31 from the developing cover 22. When removing the cap member 31, as illustrated in FIG. 13A, the developing unit 15 is held while the cap member 31 and the toner filling port 22h of the developing cover 22 are facing upward in the vertical direction. This is to prevent residual toner from spilling out from the open toner filling port 22h.

First, the cap member 31 sealing the toner filling port 22h is removed. As illustrated in FIG. 13A, a flathead screwdriver 301 is inserted into the gap between the cap member 31 and the toner filling port 22h. The cap member 31 is then removed from the developing cover 22 using the principle of a lever or the like. Although an example of using the flathead screwdriver 301 is described here, the method for removing the cap member 31 is not limited to such a method.

FIG. 13B illustrates a state in which the cap member 31 has been removed from the developing cover 22. After the cap member 31 is removed, the toner filling port 22h of the developing cover 22 is open, as illustrated in FIG. 13B. In this state, a nozzle (not shown) joined to a suction apparatus (not shown) is inserted into the toner filling port 22h, and the residual toner in the developing cover 22 is sucked out by the suction apparatus.

### Reproduction Process 3: Side Cover Separation

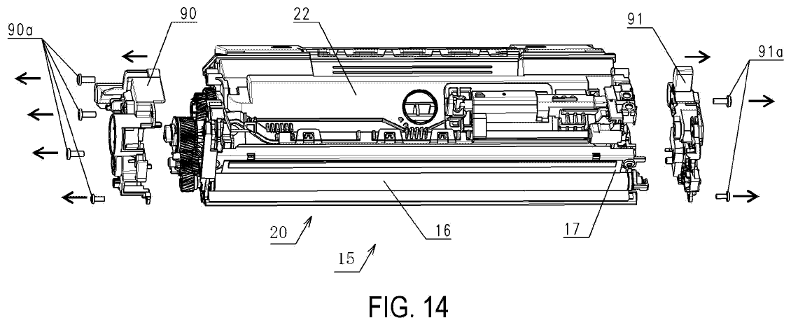

Reproduction Process 3 is a process for separating the side covers 90 and 91. Reproduction Process 3 will be described with reference to FIG. 14. FIG. 14 is a perspective view illustrating a process for removing the side covers 90 and 91 from the developing unit 15.

As illustrated in FIG. 14, screws 90a and 91a securing the side covers 90 and 91 to the developing unit 15 are removed with a flathead screwdriver or the like, and the side covers 90 and 91 are removed from the developing unit 15. Furthermore, gears, the developing roller 16, the developing blade 17, and the like attached to the developing unit 15 are removed as necessary. At this time, maintenance is performed on the removed components by checking the state of wear, dirt, change in performance, and the like due to use, or are replaced during the reassembly in Reproduction Process 6.

### Reproduction Process 4: Developing Frame Body Restoration

Next, a developing frame body restoration process for reusing the developing frame body (the developing cover 22 and the developing container 21) will be described as Reproduction Process 4. In the following, A. Developing Cover Reproduction Process 4, B. Variations on Removal Tool for Developing Cover, C. Developing Container Reproduction Process 4, and D. Method for Removing Hot Melt from Removal Tool will be described in order. In addition, Reproduction Process 4 of the developing cover 22 and the developing container 21 will be described in three processes (first to third processes), respectively.

### A. Developing Cover Reproduction Process 4

First, Reproduction Process 4 for the developing cover 22, which is the developing frame body, will be described. Reproduction Process 4 for the developing cover 22 is a process for restoring the developing cover 22 separated from the used process cartridge 5 into a state in which the developing cover 22 can be used as a component of a new process cartridge 5.

### A-1. Reproduction Process 4-1 (First Process): Process for Separating Developing Cover and Developing Container

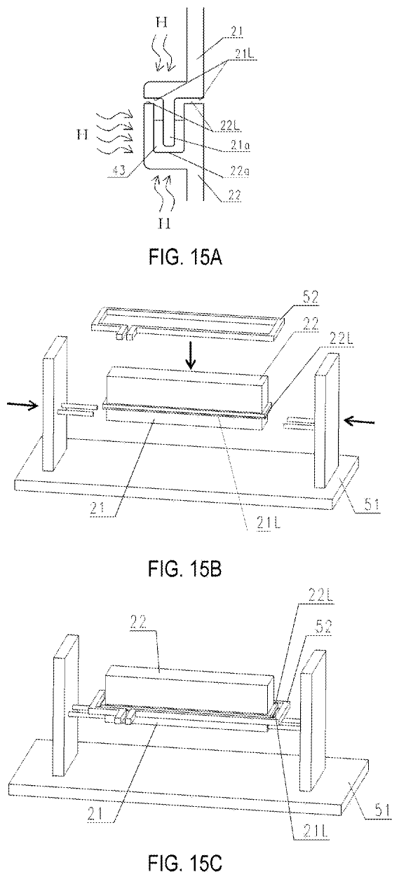

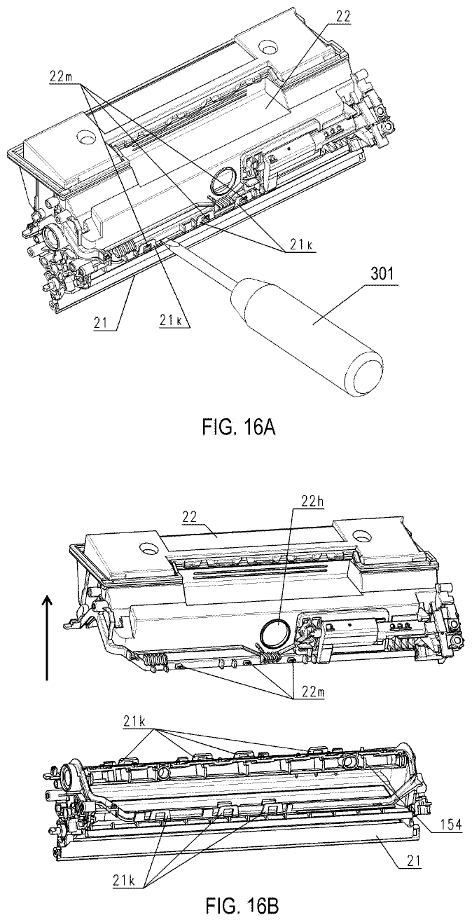

First, Reproduction Process 4-1, which is a first process, will be described with reference to FIGS. 15A to 15C and FIGS. 16A and 16B. Reproduction Process 4-1 is a process for separating the joint portion between the developing container 21 and the developing cover 22. As described in Production Processes 3 and 4, the developing container 21 and the developing cover 22 are joined using the hot melt 43, which is a connecting member, and furthermore, movement in the separation direction is regulated using snap-fitting or thermal caulking.

FIGS. 15A to 15C are schematic diagrams illustrating a method for warming the joint portion of the developing unit 15 to soften the hot melt 43, which is the connecting member of the developing unit 15. FIG. 15A is an enlarged cross-sectional view of the joint portion of the developing container 21 and the joint portion of the developing cover 22 joined by the hot melt 43, and FIGS. 15B and 15C illustrate a method for warming the joint portion of the developing unit 15 using a jig. FIGS. 15A to 15C schematically illustrate the developing container 21, the developing cover 22, the hot melt 43, and the like. FIGS. 16A and 16B are diagrams illustrating a process for separating the joint portion between the developing container 21 and the developing cover 22 when the hot melt 43, which is a molten resin, is in a softened state.

First, the tip portion of the fixed rib 21d (FIG. 10C), which is engaged with the notch shape 22d serving as a fixing portion through the heating and deformation of Production Process 4 to prevent slipping out, is cut with a nipper or the like. Next, as illustrated in FIG. 15A, the annular joint portion formed by the hot melt 43 is warmed to soften the hot melt 43.

A method using a jig 51, as illustrated in FIGS. 15B and 15C, can be given as an example of a method for heating the annular joint portion. The jig 51 can keep the developing unit 15 in a set orientation, and includes an annular-shaped heat conducting portion 52 along the annular joint portion (the joint lines 21L and 22L) of the developing unit 15. FIG. 15B illustrates a state before the heat conducting portion 52 is disposed around the developing unit 15, and FIG. 15C illustrates a state after the heat conducting portion 52 is disposed around the developing unit 15.

A heating method using the jig 51 will be described as an example of a method for heating the joint portion. First, the developing unit 15, where the developing container 21 and the developing cover 22 remain joined, is set in the jig 51. The heat conducting portion 52 is then moved closer to a position opposite the outer peripheral side of the annular joint portion of the developing unit 15. The entire joint portion is warmed by warming the heat conducting portion 52 with a heat generating element or a water pipe through which hot water passes, or by heating a heat conducting member itself of the heat conducting portion 52.

The hot melt 43 is softened by warming the joint portion such that the hot melt 43 inside the wall of the resin components is held at a predetermined temperature for a predetermined time. At this time, it is preferable to control the temperature such that components other than the hot melt 43 are not deformed or degenerated by the heat. For example, it is preferable to control the temperature such that the temperature of the joint portion of the hot melt 43 does not exceed the glass transition point of the resin material used for the developing frame body. In the present embodiment, the hot melt 43 was heated by holding the heat conducting portion 52 at about 60 °C for 40 seconds.

With the hot melt 43 softened, the flathead screwdriver 301 is inserted into the gap in the joint portion between the developing container 21 and the developing cover 22, as illustrated in FIG. 16A. Then, while disengaging the seven snap-fit shapes 21k from the seven engagement claws 22m, the inserted flathead screwdriver 301 is moved according to the principle of the lever, and the developing container 21 and the developing cover 22 are separated as illustrated in FIG. 16B. At this time, it is necessary to disengage the snap-fit shapes 21k from the engagement claws 22m while taking care not to break the snap-fit shapes 21k. To improve the work efficiency, the developing unit 15 may be set onto a base (not shown) where the snap fit can be disengaged, and a flathead screwdriver or the like may be inserted into the gap in the joint portion between the developing container 21 and the developing cover 22 to separate the two.

The hot melt 43 may remain on the rib 21a of the developing container 21 and the groove 22a of the developing cover 22 that have been separated. Accordingly, it is preferable to store the separated developing container 21 and developing cover 22 such that the rib 21a, the groove 22a, and the like do not come into contact with other components, apparatuses, or the like.

The following methods can be given as other methods for softening the hot melt 43. For example, the developing unit 15, with the developing container 21 and the developing cover 22 still joined, may be placed in a thermostatic chamber to be warmed evenly. A method can also be used in which the joint portion is warmed evenly by applying warm air using a dryer or the like. In either method, the hot melt 43 can be warmed at a predetermined temperature for a predetermined time (about 60 °C for 40 seconds, in this example). In other words, any heating method may be used as long as the hot melt 43 can be heated to a temperature that softens the joint portion without exceeding the glass transition point of the resin material.

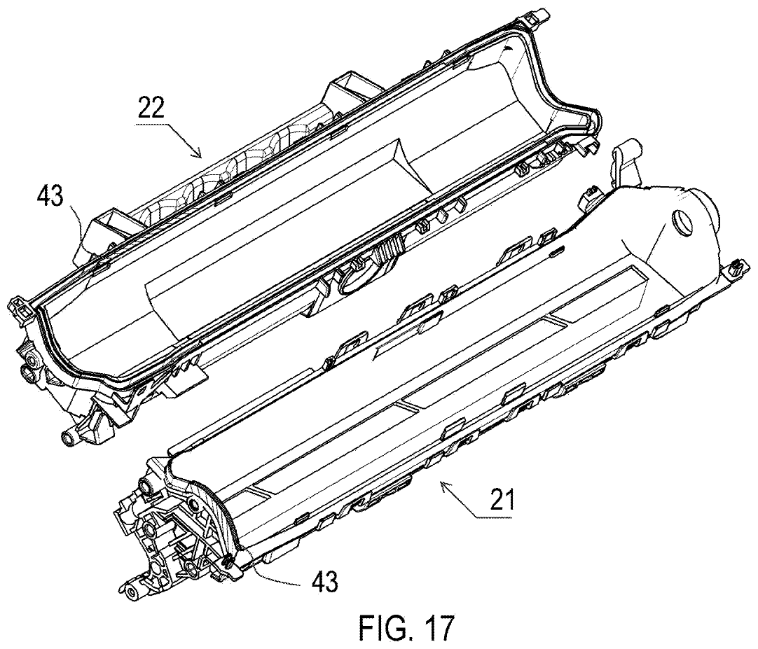

FIG. 17 is a perspective view illustrating a state in which the developing cover 22 and the developing container 21 are separated. The hot melt 43 may remain on one or both of the developing container 21 and the developing cover 22. To restore the developing container 21 and the developing cover 22 from this state to a state in which the developing container 21 and the developing cover 22 can be reused in the same manner as new products, it is necessary to remove the remaining hot melt 43.

### A-2. Restoration Process (Second Process) 4-2: Adhering Process of Causing Hot Melt to Adhere to Removal Tool

Reproduction Process 4-2, which is a second process, will be described next. In Reproduction Process 4-2 and Reproduction Process 4-3 (described later), a removal tool 70 for efficiently removing the hot melt 43 from the developing cover 22 is used. Accordingly, the configuration of the removal tool 70 will be described first, and the operations performed in Reproduction Process 4-2 will be described after.

A-2a. Configuration of Removal Tool

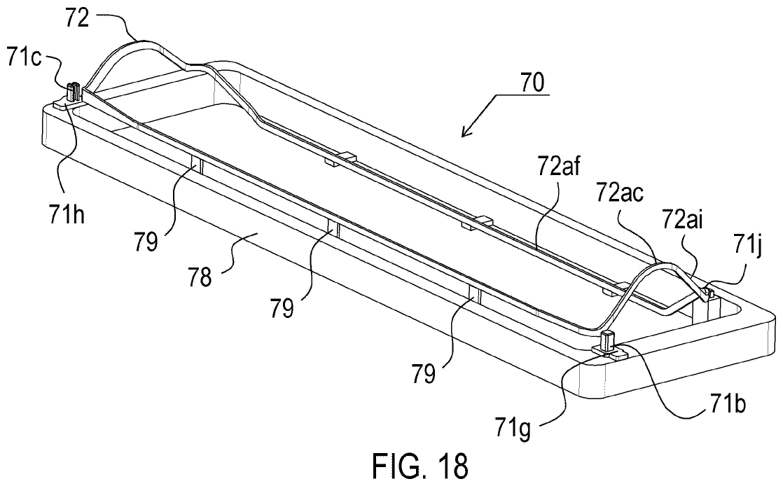

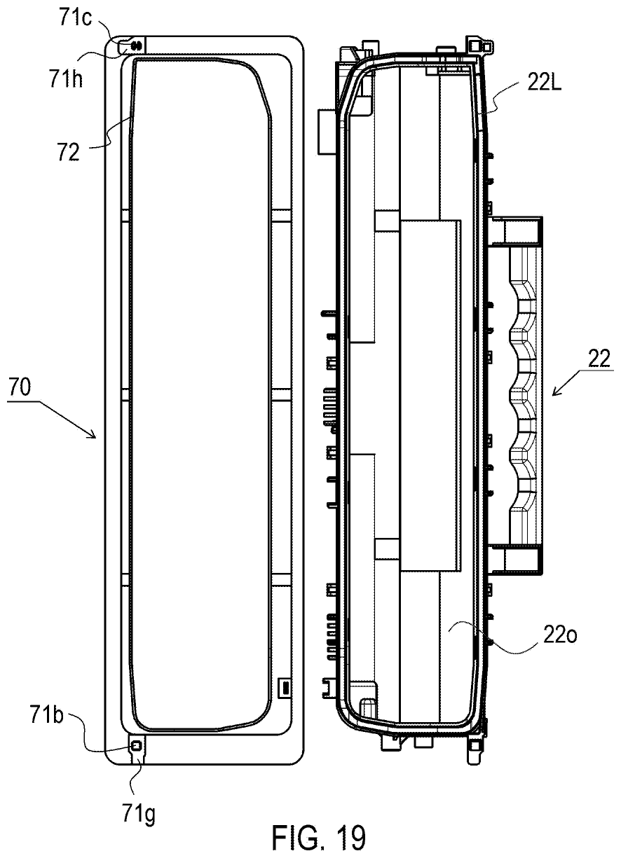

The removal tool 70 for efficiently removing the hot melt 43 from the developing cover 22 will be described. FIG. 18 is a perspective view illustrating the exterior of the removal tool 70 (a separating tool), which is a tool for removing (separating) the hot melt 43 from the developing cover 22. FIG. 19 is a diagram illustrating the joint portion between the removal tool 70 and the developing cover 22.

As illustrated in FIG. 18, the removal tool 70 has a shape similar to that of the developing container 21, and the positioning configuration with respect to the developing cover 22 is the same as that of the developing container 21. Specifically, the removal tool 70 is provided with a first positioning boss 71b and a second positioning boss 71c for regulating the position in the longitudinal direction (the direction parallel to the center axis of the photosensitive drum 11). Additionally, in order to position the positioning bosses 71b and 71c in the vertical direction, the removal tool 70 is provided with a first abutting surface 71g, a second abutting surface 71h, and a third abutting surface 71j. The positioning portion of the removal tool 70 (a third positioning portion) is engaged with the positioning portion of the developing cover 22 to position the removal tool 70 relative to the developing cover 22.

As illustrated in FIGS. 18 and 19, the removal tool 70 is provided with an engagement portion 72 (a third engagement portion) for engaging with the groove 22a provided in the open edge portion of the opening 22o of the developing cover 22 and removing the hot melt 43. The engagement portion 72 is an annular protruding portion formed annularly in the same manner as the rib 21a so as to be capable of engaging the groove 22a.

The removal tool 70 further includes a base portion 78, which is provided with a plurality of positioning bosses and a plurality of abutting surfaces and which supports the engagement portion 72, and a connecting portion 79 that connects the engagement portion 72 and the base portion 78. A plurality of the connecting portions 79 are provided along the annular extension direction of the engagement portion 72.

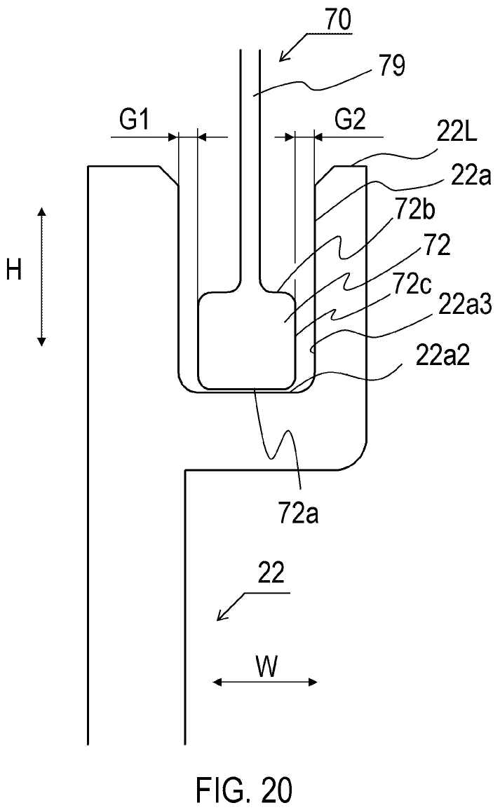

FIG. 20 is a cross-sectional view illustrating a state in which the engagement portion 72 and the groove 22a are engaged, and illustrating a cross-section perpendicular to the annular extension direction of the groove 22a. In FIG. 20, the hot melt 43 is not shown in order to show the configuration of the removal tool 70 and the developing cover 22. In the following descriptions, as illustrated in FIG. 20, the direction of engagement between the removal tool 70 and the developing cover 22 is represented by H, and the width direction of the groove 22a, which is also an orthogonal direction orthogonal to the engagement direction H and the annular extension direction of the groove 22a, is represented by W. The engagement direction H according to the present embodiment is parallel to the depth direction of the groove 22a, and is a direction orthogonal to the flat surface portion of the bottom surface 22a2 of the groove 22a and the flat surface portion 22Lf of the joint line 22L. In addition, of the engagement direction H, an approach direction in which the removal tool 70 approaches the bottom surface 22a2 of the developing cover 22 is represented by H1, and a separation direction of separation from the bottom surface 22a2 is represented by H2.

As illustrated in FIG. 20, the cross-sectional shape of the engagement portion 72 is a rounded-corner rectangle. The engagement portion 72 has a tip surface 72a facing in the approach direction H1, a rear end surface 72b on the side opposite from the tip surface 72a and facing in the separation direction H2, and two side surfaces 72c connecting the tip surface 72a with the rear end surface 72b and facing in the orthogonal direction W. The tip surface 72a is an end surface of the removal tool 70 in the approach direction H1. The connecting portion 79 is connected to the rear end surface 72b. In the orthogonal direction W, the width of the engagement portion 72 is larger than the connecting portion 79, and the rear end surface 72b is formed on both sides of the connecting portion 79. The engagement portion 72 having such a cross-sectional shape is formed annularly corresponding to the groove 22a. That is, one of the two side surfaces 72c is an inner circumferential surface of the annular engagement portion 72, and the other is an outer circumferential surface of the engagement portion 72. In addition, like the rib 21a and the groove 22a, the tip surface 72a of the engagement portion 72 includes a flat surface portion 72af extending in a flat form, an inclined surface portion 72ai extending in a direction inclined relative to the flat surface portion 72af, a curved surface portion 72ac extending in a curved shape, and the like.

As illustrated in FIG. 20, the engagement portion 72 and the groove 22a engage such that the engagement portion 72 is inserted into the groove 22a. In the orthogonal direction W, the width of the engagement portion 72 is smaller than the width of the groove 22a. Accordingly, in a state in which the engagement portion 72 and the groove 22a are engaged, the side surfaces 72c of the engagement portion 72 oppose the vertical wall surfaces 22a3 of the groove 22a, and the engagement portion 72 has gaps G1 and G2 from the groove 22a in the orthogonal direction W. In addition, the height of the engagement portion 72 (the distance from the tip surface 72a to the rear end surface 72b) is smaller than the depth of the groove 22a (the distance from the bottom surface 22a2 to the joint line 22L). In a state where the removal tool 70 and the developing cover 22 are engaged and positioned relative to each other, the tip surface 72a of the engagement portion 72 and the bottom surface 22a2 of the groove 22a are closest in the engagement direction H, and the rear end surface 72b is located between the bottom surface 22a2 and the joint line 22L in the engagement direction H. A state in which the removal tool 70 and the developing cover 22 are positioned relative to each other, and the engagement portion 72 and the groove 22a are the closest, is taken as a state in which the engagement portion 72 and the groove 22a are engaged. In Embodiment 1, in the state in which the engagement portion 72 and the groove 22a are engaged, the tip surface 72a of the engagement portion 72 and the bottom surface 22a2 of the groove 22a are opposed with a gap therebetween.

The material of the removal tool 70 heats and cools the removal tool 70 itself, and it is therefore desirable to use a material that is heat-resistant and has high thermal conductivity. Although the present embodiment describes using aluminum, the material is not limited to aluminum, and ceramics, stainless steel, or the like may be used instead. Additionally, it is particularly preferable for the engagement portion 72 to have high thermal conductivity, and the engagement portion 72 and the base portion 78 may therefore be formed from different materials.

A-2b. Operations of Reproduction Process 4-2

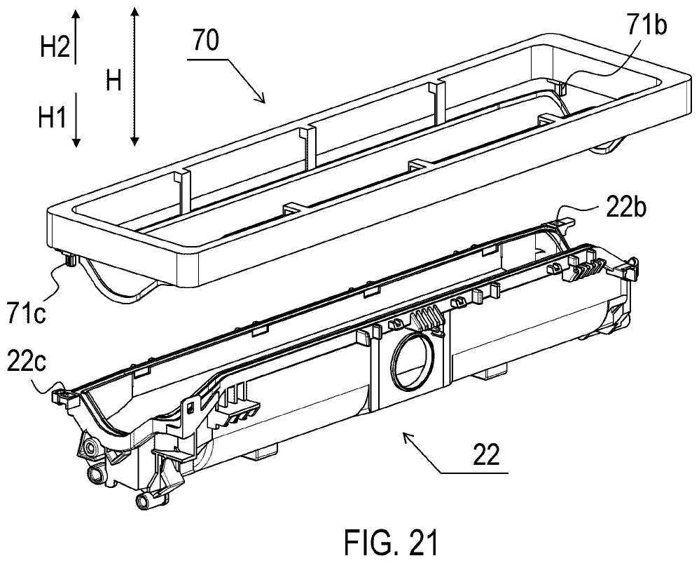

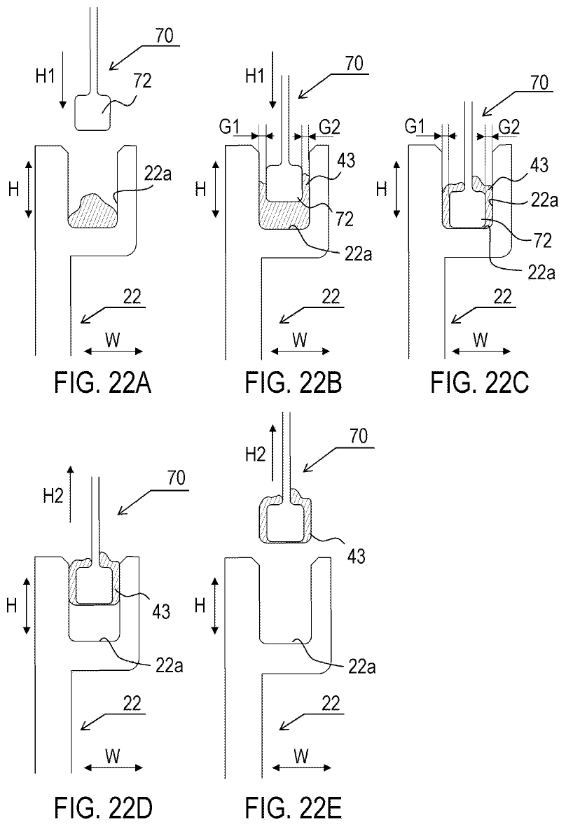

Operations of Reproduction Process 4-2, which is the second process, will be described next with reference to FIG. 21 and FIGS. 22A to 22E. Reproduction Process 4-2 is an adhering process in which the removal tool 70 is brought into contact with the hot melt 43 of the developing cover 22, and the hot melt 43 is caused to adhere to the removal tool 70. FIG. 21 is a perspective view illustrating a state before the removal tool 70 is engaged with the developing cover 22. FIGS. 22A to 22E are cross-sectional views illustrating a process for removing the hot melt 43 using the removal tool 70 (a separation process).

A heating process in which the removal tool 70 is heated is performed as a preliminary preparation for Reproduction Process 4-2. It is preferable that the removal tool 70 be heated to a temperature greater that is at least the temperature at which the hot melt 43 softens, but that is lower than the glass transition point of the resin material of the developing cover 22, using a heater, an electric heating wire, or the like. In the present embodiment, the removal tool 70 is heated to a range of 40 °C or more and 80 °C or less.

The heated removal tool 70 is moved in the approach direction H1 toward the developing cover 22 so as to engage the developing cover 22, and the positioning portion of the removal tool 70 and the positioning portion of the developing cover 22 are engaged. FIG. 22A illustrates a state in which the removal tool 70 is approaching the developing cover 22.

FIG. 22B illustrates a state in which the removal tool 70 begins to engage with the developing cover 22, and the engagement portion 72 contacts the hot melt 43 adhering to the groove 22a. Because the engagement portion 72 is warmed above the temperature at which the hot melt 43 softens, the hot melt 43 gradually begins to soften from the surface of contact with the engagement portion 72, as illustrated in FIG. 22B.

FIG. 22C illustrates a state in which the removal tool 70 further approaches the bottom surface 22a2 of the groove 22a of the developing cover 22 from the state illustrated in FIG. 22B, and the heated engagement portion 72 engages with the groove 22a. When the removal tool 70 and the developing cover 22 come closer together after the engagement portion 72 contacts the hot melt 43, the hot melt 43 is pushed out through the gaps G1 and G2 by the engagement portion 72. In Embodiment 1, the height of the engagement portion 72 is smaller than the depth of the groove 22a, and the rear end surface 72b is located between the joint line 22L and the bottom surface 22a2 in the engagement direction H. Because the hot melt 43 passing through the gaps G1 and G2 attempts to move into the open space, in this example, the hot melt 43 moves toward the center of the groove 22a in the orthogonal direction W, opposite from the wall surfaces of the groove 22a, i.e., toward the rear end surface 72b. In other words, the side surfaces 72c of the engagement portion 72 function as guide portions for guiding the hot melt 43 to the rear end surface 72b along the vertical wall surfaces 22a3 of the groove 22a, and the rear end surface 72b of the engagement portion 72 functions as an adhering surface to which the hot melt 43 adheres.

By inserting the engagement portion 72 into the groove 22a in this manner, the softened hot melt 43 moves around the periphery of the engagement portion 72 and adheres to the rear end surface 72b and the like. A state in which the hot melt 43 envelops at least part of the engagement portion 72 and contacts at least a surface facing in the separation direction H2 of the engagement portion 72 (the rear end surface 72b) will be referred to hereinafter as the hot melt 43 forming an anchor shape.

### A-3. Reproduction Process 4-3 (Third Process): Process for Removing Hot Melt Using Removal Tool

FIG. 22D illustrates a state in which the removal tool 70 begins to separate from the developing cover 22. After the hot melt 43 forms the anchor shape with respect to the removal tool 70, the removal tool 70 is separated from the developing cover 22 in the separation direction H2. The removal tool 70 is separated from the developing cover 22 after the temperature of the removal tool 70 drops below the melting temperature of the hot melt 43 and the hot melt 43 has integrated with the removal tool 70. FIG. 22D illustrates the hot melt 43 moving together with the removal tool 70 and being removed (separated) from the bottom surface 22a2 of the groove 22a.

In this manner, according to the configuration of the present embodiment, the hot melt 43 adheres to the rear end surface 72b facing in the separation direction H2 of the removal tool 70, and thus the hot melt 43 can be pulled away from the developing cover 22 more reliably when the removal tool 70 is separated. In other words, configuring the removal tool 70 such that the hot melt 43 adheres to a surface facing in the separation direction H2 when removing the hot melt 43 from a recessed portion such as the groove 22a makes it possible to remove the hot melt 43 efficiently and more reliably.

FIG. 22E illustrates a state in which the entirety of the engagement portion 72 has exited the interior of the groove 22a, and the removal tool 70 is completely separated from the developing cover 22. As illustrated in FIG. 22E, the removal tool 70 is removed from the groove 22a with the hot melt 43 forming the anchor shape and the hot melt 43 integrated with the removal tool 70. The hot melt 43 adhering to the engagement portion 72 is also removed from the interior of the groove 22a with the removal tool 70 by the separation operation of the removal tool 70. Such a removal method makes it possible to efficiently remove the hot melt 43 from the developing cover 22 and restore the developing cover 22 to a state equivalent to that of a new product.

Although the present embodiment describes a configuration in which the gaps G1 and G2 are provided on both sides of the removal tool 70, the configuration may be such that only one of the gaps G1 and G2 is provided. Even with such a configuration, the hot melt 43 contacts the rear end surface 72b of the engagement portion 72, and the hot melt 43 forms the anchor shape. Although a method for bringing the heated removal tool 70 into contact with the hot melt 43 has been described as the method for melting the hot melt 43, the method is not limited thereto. For example, the method for removing the hot melt 43 may involve bringing the removal tool 70 into contact with the hot melt 43 after the hot melt 43 is directly heated with a heater or an electric heating wire. Additionally, although the foregoing describes the developing cover 22 as being fixed and the removal tool 70 as being moved, instead, the removal tool 70 may be fixed and the developing cover 22 may be moved.

### B. Variations on Removal Tool for Developing Cover

Note that the shape of the tool for removing the hot melt 43 remaining in the recessed portion such as the groove 22a of the developing cover 22 is not limited to a shape like that of the removal tool 70. Accordingly, examples of shapes different from the above-described configuration of the removal tool 70 will be described hereinafter as Variations 1 and 2.

### B-1. Variation 1 on Removal Tool

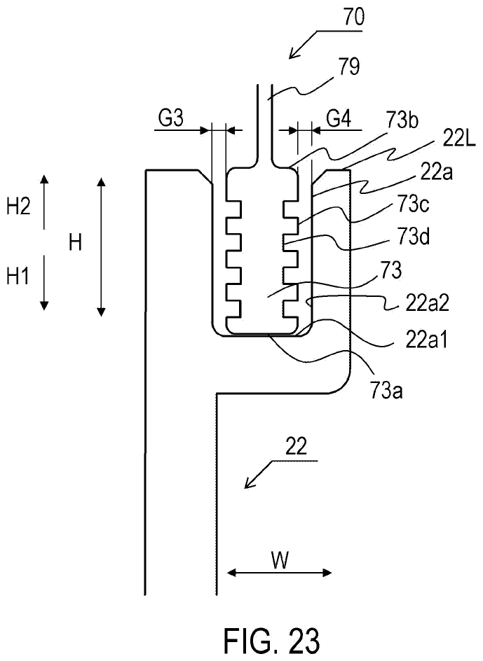

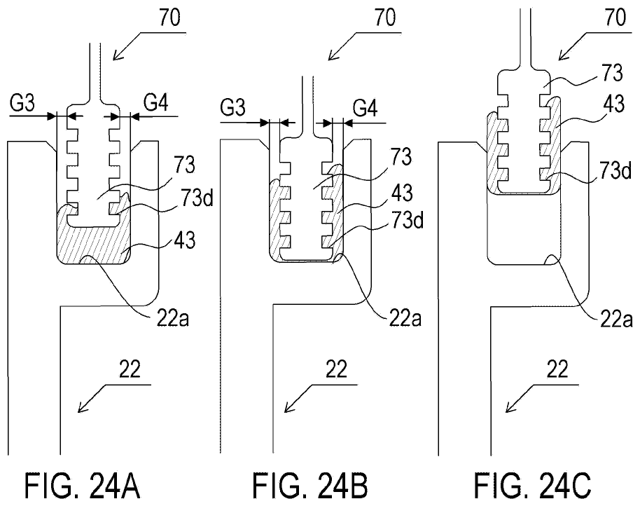

Variation 1 on the removal tool 70 for removing the hot melt 43 will be described with reference to FIG. 23 and FIGS. 24A to 24C. The removal tool 70 according to Variation 1 has an engagement portion 73 having a shape different from that of the engagement portion 72. FIG. 23 is a cross-sectional view illustrating Variation 1 on the removal tool 70, and illustrating a cross-sectional view of a state in which the engagement portion 73 and the groove 22a are engaged. The cross-section in FIG. 23 is a cross-section perpendicular to the extension direction of the groove 22a that extends annularly. In FIG. 23, the hot melt 43 is not shown in order to show the configuration of the removal tool 70 and the developing cover 22. FIGS. 24A to 24C are cross-sectional views illustrating a process for removing the hot melt 43 using the removal tool 70 according to Variation 1.

The engagement portion 73 has a tip surface 73a facing in the approach direction H1, a rear end surface 73b on the side opposite from the tip surface 73a and facing in the separation direction H2, and two side surfaces 73c connecting the tip surface 73a with the rear end surface 73b and facing in the orthogonal direction W. The tip surface 73a is an end surface of the removal tool 70 in the approach direction H1. The connecting portion 79 is connected to the rear end surface 73b. In the orthogonal direction W, the width of the engagement portion 73 is larger than the connecting portion 79, and the rear end surface 73b is formed on both sides of the connecting portion 79. The engagement portion 73 having such a cross-sectional shape is formed annularly corresponding to the groove 22a. That is, one of the two side surfaces 73c is an inner circumferential surface of the annular engagement portion 73, and the other is an outer circumferential surface of the engagement portion 73.

The engagement portion 73 has a plurality of recessed portions 73d (notch portions) recessed in the orthogonal direction W. The recessed portions 73d are provided in each of the two side surfaces 73c, in a plurality of different positions in the engagement direction H. Like the engagement portion 72, the engagement portion 73 is formed annularly, and the recessed portions 73d are formed throughout the entire circumference of the engagement portion 73. As illustrated in FIG. 23, the cross-sectional shape of the recessed portions 73d in Variation 1 is rectangular, but the configuration is not limited thereto; the shape may be hemispherical, for example, and adhering surfaces facing in the separation direction H2 may be provided. In other words, in Variation 1, a plurality of adhering surfaces are formed in the engagement portion 73 of the removal tool 70.

As illustrated in FIG. 23, the engagement portion 73 and the groove 22a engage such that the engagement portion 73 is inserted into the groove 22a. In the orthogonal direction W, the width of the engagement portion 73 is smaller than the width of the groove 22a. Accordingly, the engagement portion 73 has gaps G3 and G4 from the groove 22a in the orthogonal direction W.

In Variation 1, the height of the engagement portion 73 (the distance from the tip surface 73a to the rear end surface 73b) is greater than the depth of the groove 22a (the distance from the bottom surface 22a2 to the joint line 22L). Accordingly, in a state where the removal tool 70 and the developing cover 22 are engaged and positioned relative to each other, and the tip surface 73a and the bottom surface 22a2 are closest in the engagement direction H, the distance from the bottom surface 22a2 to the rear end surface 73b is greater than the distance from the bottom surface 22a2 to the joint line 22L. In other words, in a state where the removal tool 70 and the developing cover 22 are engaged, the rear end surface 73b is located outside the groove 22a. On the other hand, in a state where the removal tool 70 and the developing cover 22 are positioned and engaged relative to each other, all the recessed portions 73d are positioned between the bottom surface 22a2 and the joint line 22L in the engagement direction H, i.e., within the groove 22a. In other words, the distance from the tip surface 73a to the adhering surface of each recessed portion 73d facing in the separation direction H2 is smaller than the depth of the groove 22a.

A method for removing the hot melt 43 using the removal tool 70 according to Variation 1 will be described next. FIG. 24A illustrates a state in which the removal tool 70 begins to engage with the developing cover 22, and the engagement portion 73 contacts the hot melt 43 adhering to the groove 22a. As in Embodiment 1, In Variation 1, the removal tool 70 contacts the hot melt 43 in the heated state, and the hot melt 43 begins to soften as the removal tool 70 makes contact. The hot melt 43 adhering to the groove 22a is then pushed into the gaps G3 and G4 as the tip surface 73a of the engagement portion 73 approaches the bottom surface 22a2 of the groove 22a.

FIG. 24B illustrates a state in which the removal tool 70 further approaches the bottom surface 22a2 of the groove 22a of the developing cover 22 from the state illustrated in FIG. 24A, and the engagement portion 73 engages with the groove 22a. The hot melt 43 pushed into the gaps G3 and G4 moves into the open space. In this example, while the hot melt 43 moves toward the outlets of the gaps G3 and G4, some of the hot melt 43 enters the recessed portions 73d provided in the engagement portion 73. In other words, the side surfaces 73c of the engagement portion 73 function as guide portions that, along with the vertical wall surfaces 22a3 of the groove 22a, guide the hot melt 43 to the recessed portions 73d. The hot melt 43 then adheres to the side surfaces 73c and the recessed portions 73d so as to envelop at least a part of the engagement portion 73. At this time, the hot melt 43 also contacts the surfaces of the recessed portion 73d facing in the separation direction H2 to form an anchor shape.

FIG. 24C illustrates a state in which the removal tool 70 separates from the developing cover 22. As illustrated in FIG. 24C, the removal tool 70 is removed from the groove 22a with the hot melt 43 forming the anchor shape and the hot melt 43 integrated with the removal tool 70. The hot melt 43 adhering to the engagement portion 73 is also removed from the interior of the groove 22a with the removal tool 70 by the separation operation of the removal tool 70. Such a removal method puts the developing cover 22 into a state equivalent to that of a new product, and makes it possible to reuse the developing cover 22.

In this manner, even if the configuration is such that the removal tool 70 is provided with recessed portions having adhering surfaces, to which the hot melt 43 is caused to adhere, facing in the separation direction H2, the hot melt 43 can be efficiently removed from the developing cover 22, and the developing cover 22 can be restored to a state equivalent to that of a new product.

### B-2. Variation 2 on Removal Tool

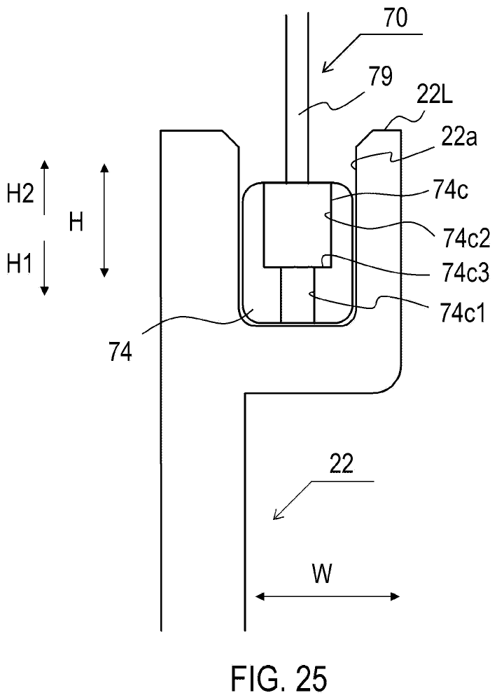

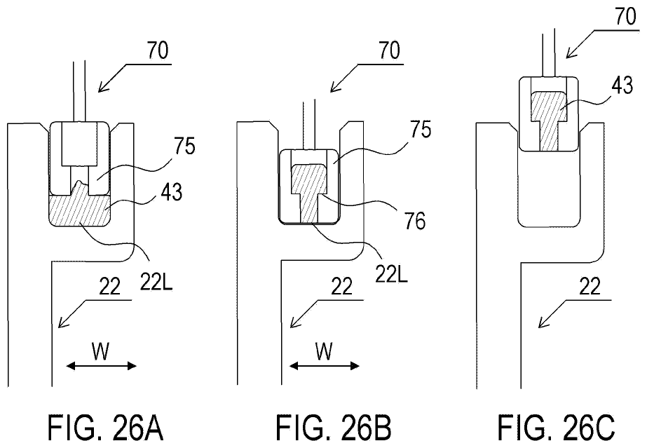

Variation 2 on the removal tool 70 for removing the hot melt 43 will be described next with reference to FIG. 25 and FIGS. 26A to 26C. The removal tool 70 according to Variation 2 has an engagement portion 74 having a shape different from that of the engagement portion 72. FIG. 25 is a cross-sectional view illustrating Variation 2 on the removal tool 70, and illustrating a cross-sectional view of a state in which the engagement portion 74 and the groove 22a are engaged. The cross-section in FIG. 25 is a cross-section perpendicular to the extension direction of the groove 22a that extends annularly. In FIG. 25, the hot melt 43 is not shown in order to show the configuration of the removal tool 70 and the developing cover 22. FIGS. 26A to 26C are cross-sectional views illustrating a process for removing the hot melt 43 using the removal tool 70 according to Variation 2.

The engagement portion 74 has a tip surface 74a facing in the approach direction H1, a rear end surface 74b facing in the separation direction H2 on the side opposite from the tip surface 74a, and a through-hole portion 74c penetrating from the tip surface 74a to the rear end surface 74b. The tip surface 74a is an end surface of the removal tool 70 in the approach direction H1. The connecting portion 79 is connected to the rear end surface 74b. In the orthogonal direction W, the width of the engagement portion 74 is larger than the connecting portion 79, and the rear end surface 74b is formed on both sides of the connecting portion 79. The engagement portion 74 having such a cross-sectional shape is formed annularly corresponding to the groove 22a.

The through-hole portion 74c includes a first hole 74c1 that opens in the tip surface 74a, a second hole 74c2 that communicates with the first hole 74c1 and opens on the rear end surface 74b, and a step surface 74c3 that is an interface between the first hole 74c1 and the second hole 74c2. The opening widths of the first hole 74c1 and the second hole 74c2 in the orthogonal direction W are constant throughout the penetration direction, and the opening width of the first hole 74c1 in the orthogonal direction W (a first opening width) is smaller than the opening width of the second hole 74c2 in the orthogonal direction W (a second opening width). In other words, the through-hole portion 74c is formed in a stepped shape in which the opening width changes at the step surface 74c3 facing in the separation direction H2.

Like the engagement portion 72, the engagement portion 74 is formed annularly. In Variation 2, a plurality of the through-hole portions 74c are formed intermittently along the annular extension direction. However, the configuration is not limited thereto, and the through-hole portion 74c may be formed continuously throughout the entire circumference of the engagement portion 74. In Variation 2, the step surface 74c3 of the through-hole portion 74c is a flat plane orthogonal to the engagement direction H, as illustrated in FIG. 25, but the configuration is not limited thereto, and the step surface 74c3 may be a curved surface.

As illustrated in FIG. 25, the engagement portion 74 and the groove 22a engage such that the engagement portion 74 is inserted into the groove 22a. In the orthogonal direction W, the width of the engagement portion 74 is slightly smaller than the width of the groove 22a, and a gap between the groove 22a and the engagement portion 74 in the orthogonal direction W is small to the extent that insertion of the engagement portion 74 into to the groove 22a is not hindered. On the other hand, in a state where the removal tool 70 and the developing cover 22 are positioned and engaged relative to each other, the step surface 74c3 is positioned between the bottom surface 22a2 and the joint line 22L in the engagement direction H, i.e., within the groove 22a. In other words, the distance from the tip surface 74a to the step surface 74c3 facing in the separation direction H2 is smaller than the depth of the groove 22a.

A method for removing the hot melt 43 using the removal tool 70 according to Variation 2 will be described next. FIG. 26A illustrates a state in which the removal tool 70 begins to engage with the developing cover 22, and the engagement portion 74 contacts the hot melt 43 adhering to the groove 22a. As in Embodiment 1, In Variation 2, the removal tool 70 contacts the hot melt 43 in the heated state, and the hot melt 43 begins to soften as the removal tool 70 makes contact. When the tip surface 74a of the engagement portion 74 approaches the bottom surface 22a2 of the groove 22a, almost no gap is present between the engagement portion 74 and the groove 22a, and the hot melt 43 adhering to the groove 22a is therefore pushed into the through-hole portion 74c.

FIG. 26B illustrates a state in which the removal tool 70 further approaches the bottom surface 22a2 of the groove 22a of the developing cover 22 from the state illustrated in FIG. 26A, and the engagement portion 74 engages with the groove 22a. The hot melt 43 pushed out into the through-hole portion 74c and passing through the first hole 74c1 moves toward the open space, which in this case is the step surface 74c3, and contacts the step surface 74c3. In other words, the first hole 74c1 of the engagement portion 74 functions as a guide portion that guides the hot melt 43 to the second hole 74c2 and the step surface 74c3. In this manner, the hot melt 43 adheres to the engagement portion 74 so as to cover the inner circumferential surface of the engagement portion 74 (the surface of the through-hole portion 74c). At this time, the hot melt 43 also contacts the surface of the engagement portion 74 facing in the separation direction H2 (the step surface 74c3) to form an anchor shape.

FIG. 26C illustrates a state in which the removal tool 70 separates from the developing cover 22. As illustrated in FIG. 26C, the removal tool 70 is removed from the groove 22a with the hot melt 43 forming the anchor shape and the hot melt 43 integrated with the removal tool 70. The hot melt 43 adhering to the engagement portion 74 is also removed from the interior of the groove 22a with the removal tool 70 by the separation operation of the removal tool 70. Such a removal method restores the developing cover 22 to a state equivalent to that of a new product, and makes it possible to reuse the developing cover 22.

In this manner, even if the configuration is such that a through-hole portion having an adhering surface, to which the hot melt 43 is caused to adhere, is provided facing in the separation direction H2, the hot melt 43 can be efficiently removed from the developing cover 22, and the developing cover 22 can be restored to a state equivalent to that of a new product.

In this manner, the removal tool 70 for removing the hot melt 43 from the developing cover 22 is not limited to a single configuration. In other words, as long as the removal tool 70 has an adhering surface, facing in the separation direction H2, to which the hot melt 43 is caused to adhere when pulling out from the developing cover 22, and a guide portion for guiding the hot melt 43 to the adhering surface during engagement with the developing cover 22, the configuration of the removal tool 70 is not limited to the foregoing examples. For example, the removal tool 70 may be configured to combine the recessed portions of Variation 1 with the through-hole portion of Variation 2.

### C. Developing Container Reproduction Process 4

Reproduction Process 4 for the developing container 21, which is the developing frame body, will be described next. Reproduction Process 4 for the developing container 21 is a process for restoring the developing container 21 separated from the used process cartridge 5 to a state in which the developing container 21 can be used as a component of a new process cartridge 5.

### C-1. Reproduction Process 4-1 (First Process): Process for Separating Developing Cover and Developing Container

Reproduction Process 4-1 for the developing container 21 is similar to Reproduction Process 4-1 for the developing cover 22. In other words, although the developing container 21 is separated from the developing cover 22, the hot melt 43 may remain on the rib 21a, which is the joint portion.

C-2. Restoration Process (second Process) 4-2: Adhering Process of Causing Hot Melt to Adhere to Removal Tool

Reproduction Process 4-2, which is a second process, will be described next. A removal tool 100 for efficiently removing the hot melt 43 from the developing container 21 is used in Reproduction Process 4-2 for the developing container 21 as well. Accordingly, the configuration of the removal tool 100 will be described first, and the operations performed in Reproduction Process 4-2 will be described after.

C-2a. Configuration of Removal Tool

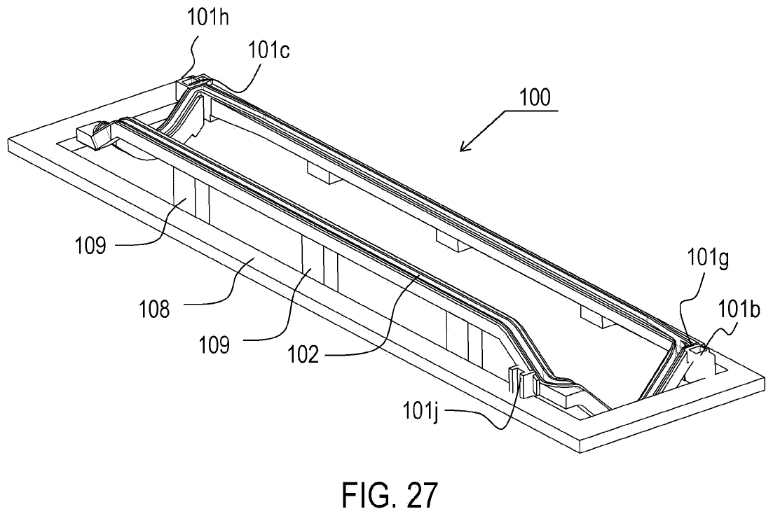

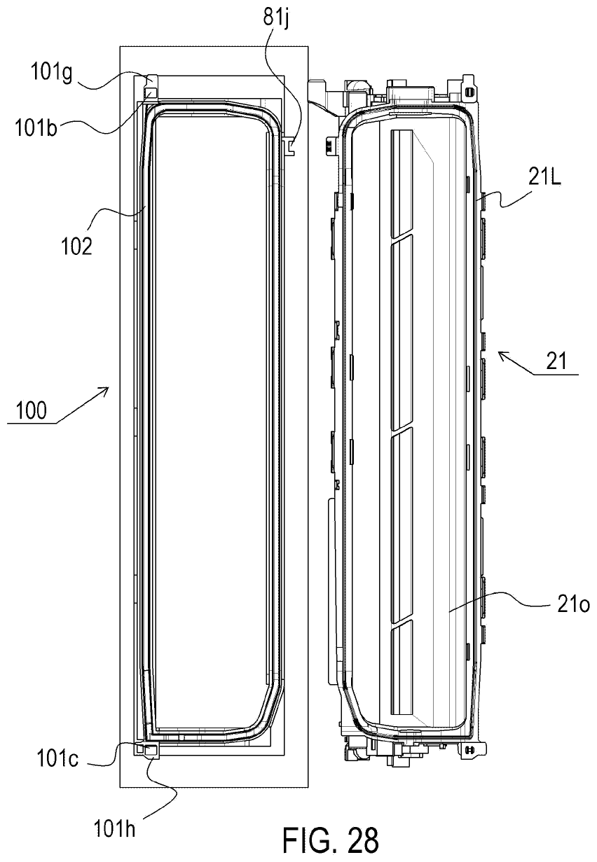

The removal tool 100 for efficiently removing the hot melt 43 from the developing container 21 will be described. FIG. 27 is a perspective view illustrating the removal tool 100, which is a tool for removing the hot melt 43 from the developing container 21. FIG. 28 is a top view illustrating a coupling portion between the removal tool 100 and the developing container 21.

As illustrated in FIG. 27, the removal tool 100 has a shape similar to that of the developing cover 22, and the positioning configuration with respect to the developing container 21 is similar to that of the developing cover 22 as well. Specifically, the removal tool 100 is provided with a first positioning boss 101b and a second positioning boss 101c for regulating the position in the longitudinal direction (the direction parallel to the center axis of the photosensitive drum 11). Additionally, in order to position the positioning bosses 101b and 101c in the vertical direction, the removal tool 100 is provided with a first abutting surface 101g, a second abutting surface 101h, and a third abutting surface 101j. The positioning portions of the removal tool 100 (a third positioning portion) are engaged with the positioning portions of the developing container 21 to position the removal tool 100 relative to the developing container 21.

As illustrated in FIGS. 27 and 28, the removal tool 100 is provided with an engagement portion 102 (a third engagement portion) for engaging with the rib 21a provided in the open edge portion of the opening 21o of the developing container 21 and removing the hot melt 43. The engagement portion 102 has a groove formed annularly in the same manner as the groove 22a, so as to be capable of engaging the rib 21a.

The removal tool 100 further includes a base portion 108, which is provided with a plurality of positioning bosses and a plurality of abutting surfaces and which supports the engagement portion 102, and a connecting portion 109 that connects the engagement portion 102 and the base portion 108. A plurality of the connecting portions 109 are provided along the annular extension direction of the engagement portion 102.

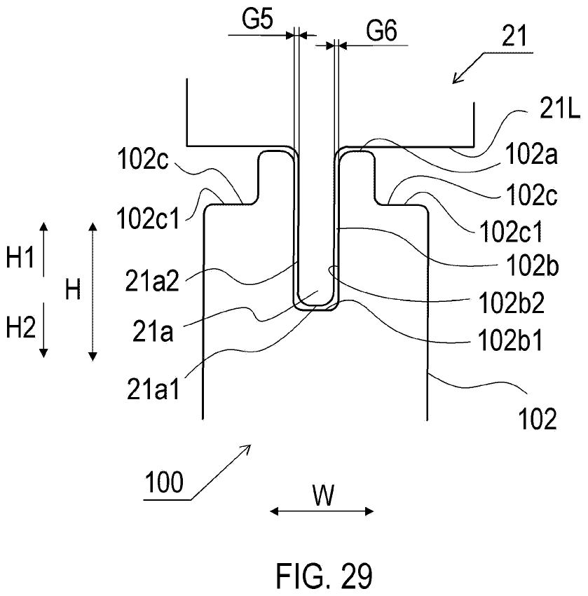

FIG. 29 is a cross-sectional view illustrating a state in which the engagement portion 102 and the rib 21a are engaged in a cross-section, and illustrating a cross-section perpendicular to the annular extension direction of the rib 21a. In FIG. 29, the hot melt 43 is not shown in order to show the configuration of the removal tool 100 and the developing container 21. In the following descriptions, as illustrated in FIG. 29, the direction of engagement between the removal tool 100 and the developing container 21 is represented by H, and the width direction of the rib 21a, which is also an orthogonal direction orthogonal to the engagement direction H and the annular extension direction of the rib 21a, is represented by W. The engagement direction H according to the present embodiment is parallel to the height direction of the rib 21a, and is a direction orthogonal to the tip surface 21a1 of the rib 21a and the joint line 21L. In addition, of the engagement direction H, an approach direction in which the removal tool 100 approaches the tip surface 21a1 of the developing container 21 and the joint line 21L is represented by H1, and a separation direction of separation from the tip surface 21a1 and the joint line 21L is represented by H2.

As illustrated in FIG. 29, the engagement portion 102 of the removal tool 100 has a tip surface 102a facing in the approach direction H1, a groove 102b recessed from the tip surface 102a in the separation direction H2, and a step 102c recessed from the tip surface 102a in the separation direction H2. The groove 102b and the step 102c are provided throughout the entirety of the annular extension direction of the engagement portion 102. The step 102c is provided at both ends of the removal tool 100 in the orthogonal direction W, and is disposed adjacent to the groove 102b when viewed in the engagement direction H. The step 102c has a step surface 102c1 facing in the approach direction H1 as an adhering surface that receives the hot melt 43 and to which the hot melt 43 adheres when the hot melt 43 adhering to the rib 21a is pushed out from the groove 102b. In the present embodiment, the depth of the step 102c in the engagement direction H is smaller than the depth of the groove 102b in the engagement direction H. In addition, like the rib 21a and the groove 22a, the tip surface 102a and a bottom surface 102b1 of the engagement portion 102 include a flat surface portion extending in a flat form, an inclined surface portion extending in a direction inclined relative to the flat surface portion, a curved surface portion extending in a curved shape, and the like.

As illustrated in FIG. 29, the engagement portion 102 and the rib 21a engage such that the rib 21a is inserted into the groove 102b of the engagement portion 102. In the orthogonal direction W, the width of the groove 102b is larger than the width of the rib 21a. Accordingly, in a state in which the engagement portion 102 and the rib 21a are engaged, vertical wall surfaces 102b2 of the groove 102b oppose the vertical wall surfaces 21a2 of the rib 21a, and the groove 102b has gaps G5 and G6 from the rib 21a in the orthogonal direction W. In a state in which the removal tool 100 and the developing container 21 are engaged and positioned relative to each other, the tip surface 102a of the engagement portion 102 and the joint line 21L are closest in the engagement direction H, and the bottom surface 102b1 of the groove 102b and the tip surface 21a1 of the rib 21a are closest in the engagement direction H. A state in which the removal tool 100 and the developing container 21 are positioned relative to each other, and the bottom surface 102b1 and the tip surface 21a1 are closest, is taken as a state in which the engagement portion 102 and the rib 21a are engaged. In Embodiment 1, in the state in which the engagement portion 102 and the rib 21a are engaged, the tip surface 102a and the joint line 21L are opposed with a gap therebetween, and the bottom surface 102b1 and the tip surface 21a1 are opposed with a gap therebetween.

The material of the removal tool 100 heats and cools the removal tool 100 itself, and it is therefore desirable to use a material that is heat-resistant and has high thermal conductivity. Like the removal tool 70, although the present embodiment describes using aluminum, the material is not limited to aluminum, and ceramics, stainless steel, or the like may be used instead. Additionally, it is particularly preferable for the engagement portion 102 to have high thermal conductivity, and the engagement portion 102 and the base portion 108 may therefore be formed from different materials.

C-2b. Operations of Reproduction Process 4-2

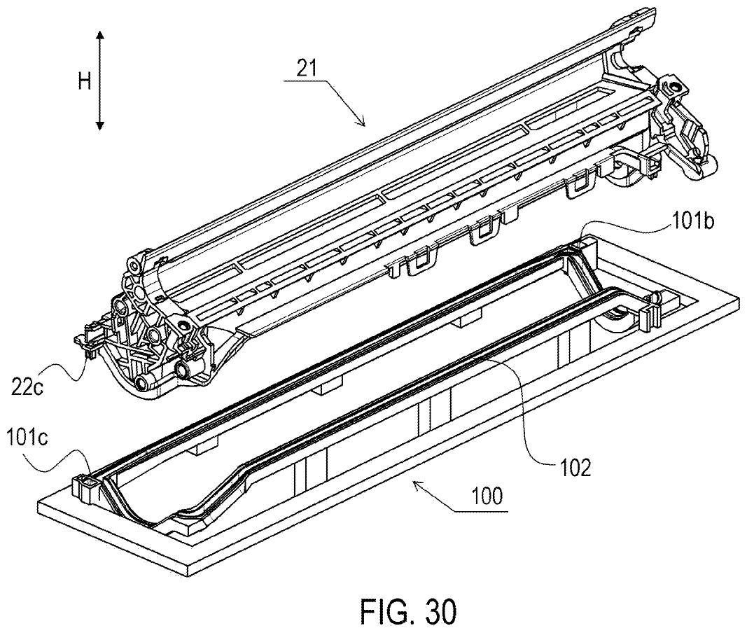

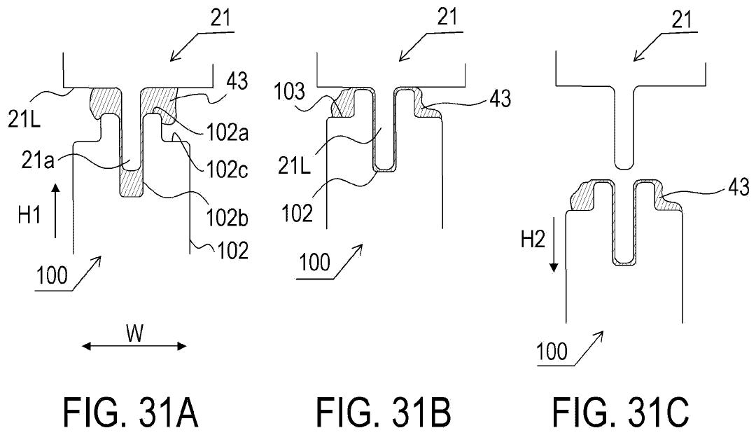

Operations of Reproduction Process 4-2, which is the second process, will be described next with reference to FIG. 30 and FIGS. 31A to 31C. Reproduction Process 4-2 is an adhering process in which the removal tool 100 is brought into contact with the hot melt 43 of the developing container 21, and the hot melt 43 is caused to adhere to the removal tool 100. FIG. 30 is a perspective view illustrating a state before the removal tool 100 is engaged with the developing container 21. FIGS. 31A to 31E are cross-sectional views illustrating a process for removing the hot melt 43 using the removal tool 100 (a separation process).

A heating process in which the removal tool 100 is heated is performed as a preliminary preparation for Reproduction Process 4-2. It is preferable that the removal tool 100 be heated to a temperature greater that is at least the temperature at which the hot melt 43 softens, but that is lower than the glass transition point of the resin material of the developing container 21, using a heater, an electric heating wire, or the like. In the present embodiment, the removal tool 100 is heated to a range of 40 °C or more and 80 °C or less.

The heated removal tool 100 is moved in the approach direction H1 toward the developing container 21 so as to engage with the developing container 21, and the positioning portion of the removal tool 100 and the positioning portion of the developing container 21 engage. The tip surface 102a of the engagement portion 102 contacts the hot melt 43 adhering to the rib 21a as the developing container 21 approaches the removal tool 100. Then, the rib 21a is inserted into the groove 102b in the engagement portion 102 while the hot melt 43 is pushed in the approach direction H1 by the tip surface 102a.

FIG. 31A illustrates a state in which the removal tool 100 begins to engage with the developing container 21, the engagement portion 102 contacts the hot melt 43 adhering to the rib 21a, and the hot melt 43 is pressed against the tip surface 102a. Because the engagement portion 102 is warmed above the temperature at which the hot melt 43 softens, the hot melt 43 gradually begins to soften from the surface of contact with the engagement portion 102, as illustrated in FIG. 31A. The softened hot melt 43 flows in the direction of the step 102c from between the tip surface 102a and the joint line 21L, i.e., away from the rib 21a in the orthogonal direction W, by being pushed by the removal tool 100.

FIG. 31B illustrates a state in which the removal tool 100 further approaches the tip surface 21a1 of the developing container 21 and the joint line 21L from the state illustrated in FIG. 31A, and the engagement portion 102 engages with the rib 21a. When the removal tool 100 and the developing container 21 come closer together after the engagement portion 102 contacts the hot melt 43, the hot melt 43 inside the groove 102b also flows to the outside of the groove 102b through the gaps G5 and G6. The hot melt 43 flowing to the outside of the groove 102b passes between the tip surface 102a and the joint line 22L and flows toward the open space, i.e., toward the step 102c, and adheres to the step surface 102c1. In other words, the groove 102b and the tip surface 102a of the engagement portion 102 function, along with the rib 21a of the developing container 21 and the joint line 21L, as a guide portion for guiding the hot melt 43 to the step 102c. In this manner, the hot melt 43 adheres to the tip surface 102a, the groove 102b, and the step 102c of the engagement portion 102. Accordingly, when the removal tool 100 engages with the developing container 21, the contact area between the hot melt 43 and the removal tool 100 is greater than the contact area between the hot melt 43 and the developing container 21 by the size over which the step 102c is formed.

As illustrated in FIGS. 31A to 31C, the Reproduction Process 4-2 of the developing container 21 is preferably performed with the joint line 21L facing downward in the vertical direction, and the tip surface 102a and the step surface 102c1 facing upward. This is because keeping both members in such an orientation allows the hot melt 43 to flow to the step 102c under its own weight and contact the step surface 102c1.

C-3. Reproduction Process 4-3 (third Process): Process for Removing Hot Melt Using Removal Tool

FIG. 31C illustrates a state in which the removal tool 100 is separated from the developing container 21. After the hot melt 43 adheres to the removal tool 100, the removal tool 100 is separated from the developing container 21 in the separation direction H2. The removal tool 100 is separated from the developing container 21 after the temperature of the removal tool 100 drops below the melting temperature of the hot melt 43 and the hot melt 43 has integrated with the removal tool 100. FIG. 31C illustrates the hot melt 43 moving together with the removal tool 100 and being separated from the rib 21a. Configuring the removal tool 100 such that the contact area with the hot melt 43 is larger than the developing container 21 makes it possible to efficiently remove the hot melt 43 from the developing container 21. Such a removal method makes it possible to efficiently remove the hot melt 43 from the developing container 21 and restore the developing container 21 to a state equivalent to that of a new product. Note that although the foregoing describes the developing container 21 as being fixed and the removal tool 100 as being moved, instead, the removal tool 100 may be fixed and the developing container 21 may be moved.

D. Method for Removing Hot Melt from Removal Tool

A method for removing the hot melt 43 adhering to the removal tool 100 for the developing container 21 and the removal tool 70 for the developing cover 22 will be described next. The hot melt 43 adheres to exposed portions of the removal tools 70 and 100. As a result, the hot melt 43 can be removed using a scraper, tweezers, or the like. In addition, performing the removal task (separation task) while the removal tools 70 and 100 and the hot melt 43 are heated makes it possible to separate the hot melt 43 from the removal tools 70 and 100 more efficiently and easily. In this manner, removing the hot melt 43 from the removal tools 70 and 100 makes it possible to use the removal tools 70 and 100 repeatedly, and developing frame bodies can be repeatedly restored to a state equivalent to that of a new product by the same removal tools 70 and 100.

Removing the hot melt 43 from the frame member using a scraper, tweezers, or the like by hand requires significant time and effort, and hot melt 43 left behind may be missed. In addition, in a configuration in which the height of the joint surface changes in the extension direction, as in the present embodiment, removing the hot melt by hand is even more difficult, and requires even more time and effort. However, according to the configuration and method of Embodiment 1, the hot melt 43 can be removed from a member such as the developing container 21 or the developing cover 22 more efficiently and reliably, which makes it possible to greatly reduce the work hours involved in removing the hot melt 43. This makes it possible to recycle more process cartridges, which makes it possible to contribute to reducing the environmental impact.

### Reproduction Process 5: Developing Unit Interior Maintenance

Reproduction Process 5 is a maintenance process for the interior of the developing unit 15. The maintenance process is performed in a state where the developing container 21 and the developing cover 22 are separated. Reproduction Process 5 will be described with reference to FIG. 16B.

As illustrated in FIG. 16B, when the developing container 21 and the developing cover 22 are separated, the developer storage chamber 152 is exposed. Using the nozzle (not shown) connected to the suction apparatus (not shown) used in Reproduction Process 3, the residual toner remaining inside the developing container 21 side and the developing cover 22 side, respectively, is sucked and cleaned out. In addition, the states of components such as the internal stirring member 154 and the developer supply roller 18 are confirmed, and maintenance and replacement are performed as necessary. Although the present embodiment describes an order in which the process for removing the hot melt from the developing frame body (Reproduction Process 4) is performed first, the Reproduction Process 4 may be performed after the maintenance (Reproduction Process 5) is first performed.

### Reproduction Process 6: Reassembly Process (Production Processes 1 to 6)

Reproduction Process 6 is a reassembly process for assembling a process cartridge 5 using a restored developing frame body. The reassembly process is the same process as Production Processes 1 to 6, and will therefore not be described. In the reassembly process, both the developing container 21 and the developing cover 22 may be members that have been restored, or only one of the members may be a member that has been restored. The reproduction (manufacturing) of the process cartridge 5 is completed through Reproduction Processes 1 to 6 described above.

As described above, using a removal tool having a shape that follows the joint line to remove the hot melt makes it possible to remove the hot melt efficiently. This makes it possible to efficiently reuse many process cartridges.

### Embodiment 2

Embodiment 2 according to the present disclosure will be described next. Embodiment 2 differs from Embodiment 1 in the method for melting the hot melt 43 in Reproduction Process 4 (the frame member restoration process). Only configurations of Embodiment 2 that are different from those of Embodiment 1 will be described hereinafter. In the configuration of Embodiment 2, elements similar to those in Embodiment 1 will be denoted by the same reference signs, and descriptions of such elements will not be repeated.

Reproduction Process 4 according to Embodiment 2 will be described. In Embodiment 1, in Reproduction Process 4, the removal tools 70 and 100 were heated to melt the hot melt 43. Embodiment 2 will describe a method for heating the developing frame body to melt the hot melt 43. Although the following will describe the developing cover 22 as an example, the method for removing the hot melt 43 from the developing container 21 is the same as that for the developing cover 22.

In Embodiment 2, after the developing cover 22 and the developing container 21 are separated from each other, the developing cover 22 is warmed to a temperature at which the hot melt 43 melts. At this time, the removal tool 70 need not be warmed. The heating of the developing cover 22 may be performed using the jig 51 as illustrated in FIG. 15, or may be performed through another method. Alternatively, both heating of the joint portion of the developing frame body for separating the developing cover 22 and the developing container 21, and heating of the developing cover 22 for removing the hot melt 43, may be performed. Performing the process of removing the hot melt 43 using the removal tool 70 promptly after the developing cover 22 and the developing container 21 are separated, before the hot melt 43 cools down, means the hot melt 43 only needs to be heated once, which makes it possible to restore the developing cover 22 efficiently.

Aside from the method for heating the hot melt 43 in Reproduction Process 4, the method for removing the hot melt 43 from the developing cover 22, by causing the hot melt 43 to adhere to the removal tool 70, for example, is the same as in Embodiment 1. Even with such a method, the hot melt 43 can be efficiently and reliably removed by separating the removal tool 70 from the developing cover 22 in a state where the removal tool 70 and the hot melt 43 are integrated.

### Embodiment 3

Embodiment 3 according to the present disclosure will be described next. Embodiment 3 differs from Embodiment 1 in that the hot melt is also subject to removal and restoration. Only configurations of Embodiment 3 that are different from those of Embodiment 1 will be described hereinafter. In the configuration of Embodiment 3, elements similar to those in Embodiment 1 will be denoted by the same reference signs, and descriptions of such elements will not be repeated.

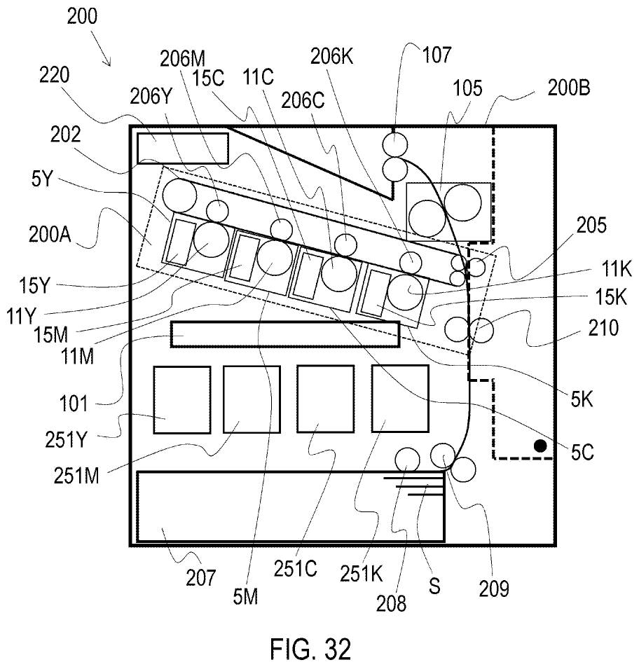

Embodiment 3 will describe a reproduction process for an internal unit attached to the image forming apparatus body. FIG. 32 is a schematic cross-sectional view illustrating the overall configuration of a laser printer 200, which is a full-color laser printer, serving as an example of an image forming apparatus according to Embodiment 3.

An overview of the laser printer 200 will be described with reference to FIG. 32. Note that components having the same functions as the monochrome laser printer 1, which is the image forming apparatus according to Embodiment 1, will be given the same reference signs, and the functions will not be described again. The internal units according to the present embodiment are toner cartridges 251Y, 251M, 251C, and 251K, and a waste toner collection container 220, which will be described later.

The laser printer 200 includes an apparatus body 200B including an electrophotographic image forming portion 200A. Additionally, the laser printer 200 includes, as a plurality of cartridges, the toner cartridges 251Y, 251M, 251C, and 251K, each of which is removable from (attachable to/detachable from) the apparatus body 200B. Note that “apparatus body 200B” according to the present embodiment refers to a part of the laser printer 200 excluding the toner cartridges 251Y, 251M, 251C, and 251K.

The image forming portion 200A includes four process cartridges 5Y, 5M, 5C, and 5K, the laser scanner 101, an intermediate transfer belt 202, primary transfer rollers 206 (206Y, 206M, 206C, and 206K), and a secondary transfer roller 205.

The four process cartridges 5Y, 5M, 5C, and 5K have substantially identical configurations, except that the colors of toner contained in the developing units 15 (15Y, 15M, 15C, and 15K) differ from each other. In other words, each of the process cartridges 5Y to 5K includes a photosensitive drum 11 (11Y, 11M, 11C, or 11K) serving as an image bearing member and the developing unit 15 (15Y to 15K) serving as a developer, as well as a charging apparatus and a cleaning apparatus (not shown). The process cartridges 5Y, 5M, 5C, and 5K are image forming units that form a monochrome toner image on the photosensitive drum 11 using yellow, magenta, cyan, and black toners, respectively.

The toner cartridges 251Y to 251K contain yellow, magenta, cyan, and black toners, respectively, as a developer for refilling the developing unit 15. The plurality of toner cartridges 251Y to 251K correspond to the plurality of developing units 15 (15Y to 15K). The toner cartridges 251Y to 251K mounted in the apparatus body 200B are connected to (communicate with) the corresponding developing unit 15 via a refilling apparatus (a hopper) provided in the apparatus body 200B. If the toner contained in the toner cartridges 251Y to 251K is consumed and an image of a quality satisfactory to the user can no longer be formed, the toner cartridges can be replaced by the user.

Note that the developer contained in the developing unit 15 may be a two-component developer containing toner and a carrier, or may be a single-component developer mainly composed of toner. In addition, the developer contained in the toner cartridges 251Y to 251K may be composed of only toner, or a small amount of carrier may be mixed with the toner.

The intermediate transfer belt 202 is an endless intermediate transfer member. The intermediate transfer belt 202 is stretched over a plurality of rollers so as to contact the photosensitive drum 11 of each of the process cartridges 5Y to 5K, and is rotationally driven in the counterclockwise direction in the figure. The four primary transfer rollers 206 are disposed at positions opposite the photosensitive drums 11 of the process cartridges 5Y to 5K, respectively, with the intermediate transfer belt 202 therebetween. The secondary transfer roller 205 is disposed at a position opposite one of the rollers on which the intermediate transfer belt 202 is stretched (a secondary transfer inner roller), with the intermediate transfer belt 202 therebetween. A transfer portion where the image (the toner image) is transferred onto the sheet S (a secondary transfer portion) is formed as a nip portion between the intermediate transfer belt 202 and the secondary transfer roller 205. The process cartridges 5Y to 5K are disposed below the intermediate transfer belt 202, and the laser scanner 101 serving as an exposer is disposed below the process cartridges 5Y to 5K. The waste toner collection container 220, which collects toner remaining on the intermediate transfer belt 202 after the secondary transfer, is disposed at the upper-left part the intermediate transfer belt 202 in the figure. The toner remaining on the intermediate transfer belt 202 is collected by a cleaning unit (not shown) and collected in the waste toner collection container 220. The waste toner collection container 220 can be replaced by the user when filled with waste toner.

The laser printer 200 also includes the fixing portion 105 (a fixing apparatus) as a fixer. The fixing portion 105 is a thermal fixing apparatus having, for example, a fixing roller, a pressure roller that is pressed against the fixing roller, and a halogen lamp serving as a heater for heating a toner image. The configuration is not limited to the foregoing, however, and for example, a ceramic heater may be disposed in an interior space of a flexible tubular film, and the toner image may be thermally fixed by a film heated by non-radiant heat from the ceramic heater.

Additionally, the laser printer 200 includes a mechanism for conveying the sheets S one by one and supplying the sheets to the image forming portion 200A. Specifically, a cassette 207 serving as a stacking portion (a storage portion) where the sheets S are stacked and stored, a pickup roller 208 that picks up the sheets S from the cassette 207, and a separation roller pair 209 that conveys the sheets S while separating the sheets S one by one are disposed in the apparatus body 200B. A registration roller pair 210, which conveys the sheet S fed from the cassette 207 to the secondary transfer portion, and the discharge roller pair 107, which discharges the sheet S that has passed through the secondary transfer portion and the fixing portion 105 to the outside of the apparatus body 200B, are also provided.

As described in the foregoing overall description of the laser printer 200, the toner cartridges 251Y to 251K and the waste toner collection container 220, which are internal units, can be replaced by the user. Each of the toner cartridges 251Y to 251K includes a container constituting a toner storage portion (a developer storage chamber) as a first member, and a frame member such as a lid connected to the container as a second member. The waste toner collection container 220 includes a container constituting a waste toner storage portion (a waste toner storage chamber) as a first member, and a frame member such as a lid connected to the container as a second member. The respective containers and lids are joined by a hot melt as a connecting member.

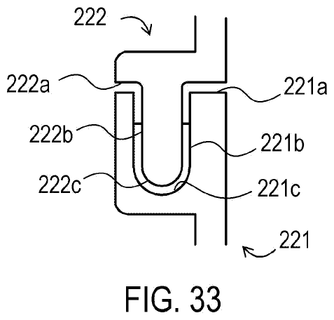

An example of the configuration of a joint portion between the two frame members (a first member and a second member) of the toner storage portion of the toner cartridges 251Y to 251K, and the waste toner collection portion of the waste toner collection container 220, and the like will be described. FIG. 33 is a cross-sectional view illustrating an example of the configuration of the joint portion of a container 221 and a lid 222 of the (waste) toner collection portion according to Embodiment 3.

The container 221 as the first member (the first frame body) is provided with an opening, and has a first surface 221a extending along an edge of the opening. The lid 222 as the second member (the second frame body) is connected to the container 221 to cover the opening, and has a second surface 222a extending along the direction in which the first surface 221a extends while opposing the first surface 221a.

The first surface 221a of the container 221 is provided with a recessed portion 221b, and the second surface 222a of the lid 222 is provided with a protruding portion 222b configured to be capable of engaging with the recessed portion 221b. The cross-sectional shapes of a bottom portion 221c of the recessed portion 221b and a tip portion 222c of the protruding portion 222b are both rounded. In a state where the container 221 and the lid 222 are positioned relative to each other, a gap is present between the first surface 221a and the second surface 222a, and between the bottom portion 221c of the recessed portion 221b and the tip portion 222c of the protruding portion 222b.

The container 221 and the lid 222 are connected (joined) by a hot melt 223, which is a connecting member applied to fill the area between the recessed portion 221b and the protruding portion 222b. The hot melt 223 is filled between the container 221 and the lid 222 to contact at least both the bottom portion 221c of the recessed portion 221b and the tip portion 222c of the protruding portion 222b.

With the container 221 and the lid 222 having such a joint portion, the hot melt 223 can, in the same manner as in Embodiment 1, be removed efficiently and reliably using a removal tool having an engagement portion formed in accordance with the recessed portion 221b and the protruding portion 222b.

The toner cartridges 251Y to 251K and the waste toner collection container 220, which are used and have been replaced by the user, can be recycled to an equivalent level of quality as a new component by cleaning the interiors and performing maintenance on the internal components, in the same manner as the process cartridge 5. At this time, processes for disengaging and reengaging the joint portion formed by the hot melt can be performed in the same manner as with the restoration process for the developing unit 15, described earlier in Embodiment 1.

As described above, according to the present embodiment, the hot melt can be removed efficiently, through hot melt removal using a removal tool, from a unit inside the image forming apparatus body as well, rather than being limited to process cartridges. This makes it possible to restore and reuse many process cartridges and components of internal units.

Although the present embodiment describes the toner cartridges 251 and the waste toner collection container 220 as internal units of the laser printer as examples, the present disclosure is not limited to the toner cartridges 251 and the waste toner collection container 220. For example, for other units provided in the image forming apparatus, if the unit is constituted by a plurality of members having similar joint portions, each of the plurality of members can be restored in the same manner, and those members can then be reused to manufacture the unit.

In the present embodiment, the toner cartridges 251 and the waste toner collection container 220 are described as units that can be replaced by the user, but the configuration is not limited thereto. For units that are fixed to the image forming apparatus and therefore cannot be removed by the user, if the unit is constituted by a plurality of members having similar joint portions, a similar restoration method and manufacturing method can be applied when remanufacturing the image forming apparatus.

According to the present disclosure, components of a unit joined using a connecting member can be efficiently restored.

### Embodiment 4

An electrophotographic image forming apparatus according to Embodiment 4 of the present disclosure will be described hereinafter with reference to the drawings.

Here, “electrophotographic image forming apparatus” (“image forming apparatus”, hereinafter) refers to an apparatus that forms an image on a recording material using an electrophotographic image forming method. Examples of the image forming apparatus include an electrophotographic copier, an electrophotographic facsimile apparatus, an electrophotographic printer (a laser printer, an LED printer, or the like), a multifunction peripheral combining these (a multifunction printer), an electrophotographic word processor, and the like. As a recording material, a sheet-shaped recording medium such as recording paper or a plastic sheet is included.

The image forming apparatus according to the present embodiment is an image forming apparatus that employs a what is known as a process cartridge system. A process cartridge is a unit that can be attached to and removed from the image forming apparatus, and is a unit having a photosensitive member and a process unit (e.g., a charging member, a developing member, a cleaning member, and the like) that works on the photosensitive member.

A mono-color laser printer to which one process cartridge is attachable and detachable will be described as the image forming apparatus in the following embodiments. Note that the number of process cartridges to be mounted in the image forming apparatus is not limited thereto, and for example, in a full-color laser printer, a plurality of process cartridges forming toner images of different colors from each other are configured in a removable manner.

### Overview of Entire Laser Printer

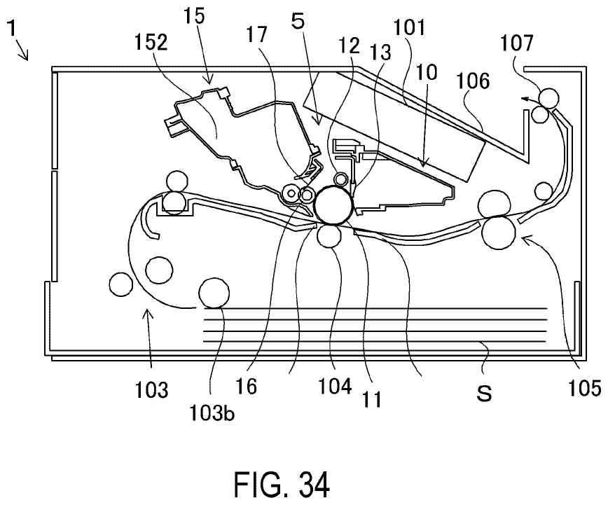

FIG. 34 is a schematic cross-sectional view illustrating the overall configuration of a laser printer 1 serving as an example of the image forming apparatus according to the present embodiment. As illustrated in FIG. 34, a sheet feeding portion 103, a transfer roller 104, a fixing portion 105, and a laser scanner 101 are installed in the laser printer 1 serving as the image forming apparatus. A process cartridge 5 is removably disposed in a laser printer body 1. The process cartridge 5 is constituted by a cleaning unit 10 including a photosensitive drum 11 serving as an image bearing member, and a developing unit 15 including a developing roller 16 serving as a developer bearing member that bears toner serving as a developer.

### Operations of Laser Printer

Operations by the laser printer serving as an example of the image forming apparatus according to the present embodiment will be described next. The photosensitive drum 11 rotationally driven by a drive source (not shown) is uniformly charged to a predetermined potential by the charging roller 12. A surface of the charged photosensitive drum 11 is subjected to image exposure by the laser scanner 101 based on image information, and the charge at the exposed portion is removed to form an electrostatic latent image. The electrostatic latent image on the photosensitive drum 11 is visualized as a toner image by supplying toner from the developing roller 16.

Meanwhile, a sheet S is conveyed along the sheet feeding portion 103 in parallel with such toner image forming operations. Specifically, a feeding roller 103b rotates to feed the sheet S. Thereafter, at the timing at which when the toner image on the photosensitive drum 11 reaches a transfer portion between the photosensitive drum 11 and the transfer roller 104, the sheet S is also conveyed to the transfer portion. When the sheet S passes through the transfer portion, the toner image is transferred to the sheet S as an unfixed image by applying a DC voltage to the transfer roller 104. Thereafter, the sheet S to which the toner image has been transferred is conveyed to the fixing portion 105. While the sheet S conveyed to the fixing portion 105 passes through the fixing portion 105, the unfixed image is heated and pressurized to be fixed on the surface of the sheet S. Thereafter, the sheet S is further conveyed by a discharge roller pair 107, and is discharged to and stacked on a discharge tray 106.

### Configuration of Process Cartridge

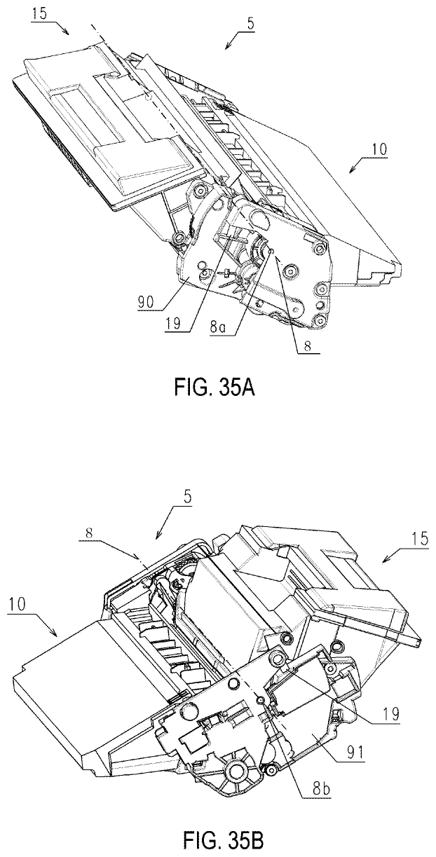

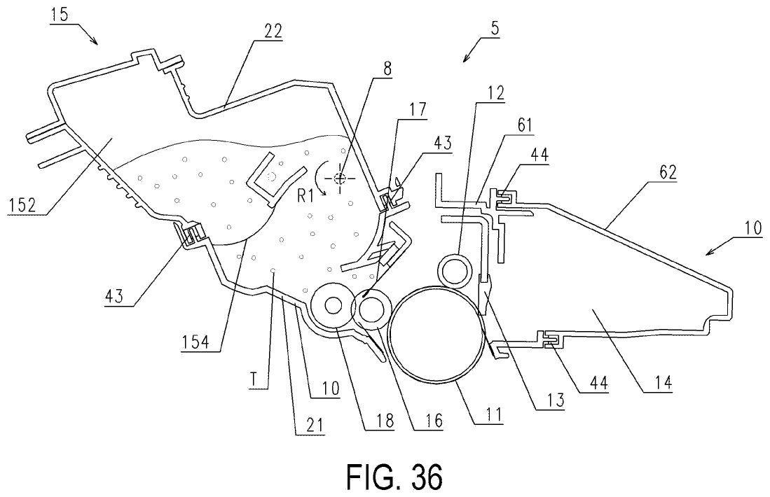

The configuration of the process cartridge 5 according to the present embodiment will be described in detail with reference to FIG. 35A and 35B and FIG. 36. FIGS. 35A and 35B are exterior perspective views of the process cartridge 5, where FIG. 35A is a schematic perspective view from one side of the process cartridge 5 in a direction perpendicular to FIG. 34 (an axial direction of the photosensitive drum 11), and FIG. 35B is a schematic perspective view from the other side. FIG. 36 is a schematic cross-sectional view of the process cartridge 5 when the process cartridge 5 is cut in a direction perpendicular to the axis of the photosensitive drum 11.

As illustrated in FIG. 35, the process cartridge 5 is constituted by the developing unit 15 and the cleaning unit 10, and the developing unit 15 and the cleaning unit 10 are coupled by coupling pins 8a and 8b. The developing unit 15 is coupled to the cleaning unit 10 so as to be capable of rotating about a straight line connecting the center axes of the coupling pins 8a and 8b (a rotation center 8).

As illustrated in FIG. 36, the charging roller 12 provided in the cleaning unit 10 is a contact charging-type charging member that contacts the photosensitive drum 11 and rotates under the rotation of the photosensitive drum 11. The cleaning blade 13 is an elastic rubber blade, and a tip portion thereof is disposed in contact with the photosensitive drum 11. The cleaning blade 13 serves as a cleaning member that removes toner remaining on the photosensitive drum 11. The toner collected by the cleaning blade 13 is stored in a waste toner containment portion 14 in the cleaning unit 10.

The developing unit 15 includes a developing roller 16, a developing blade 17, and a developer supply roller 18 as a developer. The developing unit 15 further includes a developing chamber 151, a developer storage chamber 152, and a stirring member 154. The toner in the developer storage chamber 152 is conveyed to the developer supply roller 18 while being stirred by the stirring member 154. The developer supply roller 18 contacts the developing roller 16 disposed in the developing chamber 151 to supply the toner. The developing blade 17 is disposed with the tip portion thereof in contact with the developing roller 16. The developing blade 17 serves to regulate the toner borne on the circumferential surface of the developing roller 16 to a thin layer.

The developing unit 15 is biased by a pressure spring 19 (see FIGS. 35A and 35B), which is an elastic member, and is configured such that the developing roller 16 contacts the photosensitive drum 11 about the rotation center 8. A moment in the direction R1 in FIG. 36 acts on the developing unit 15 by the biasing force from the pressure spring 19. As a result, the developing roller 16 can contact the photosensitive drum 11 at a predetermined pressure.

### Configuration of Developing Unit of Process Cartridge

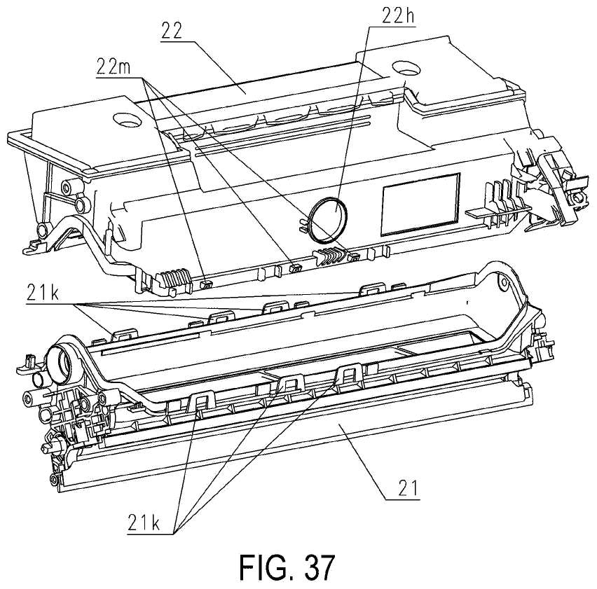

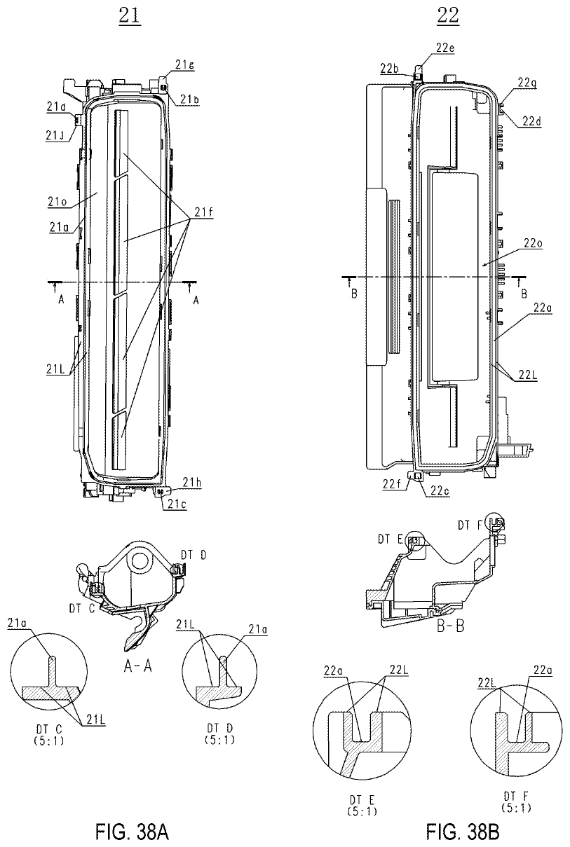

The configuration of the developing unit 15 will be described with reference to FIGS. 36 and 37 and FIGS. 38A and 38B. FIG. 37 is a perspective view illustrating a divided configuration of the developing unit 15. FIGS. 38A and 38B are diagrams illustrating joint portions between a developing container 21 and a developing cover 22, and are diagrams, cross-sectional views, and detailed views from opposite sides of each joint portion (the sides where each of openings is open). FIG. 38A is a diagram illustrating the developing container 21, and illustrates an A-A cross-section, as well as enlarged views DT_C and DT_D of the joint portion in the A-A cross-section. FIG. 38B is a diagram illustrating the developing cover 22, and illustrates a B-B cross-section, as well as enlarged views DT_E and DT_F of the joint portion in the B-B cross-section.

As illustrated in FIGS. 36 and 37, the developing unit is constituted by the developing container 21 as a resin first frame body that holds the developing roller 16 and the developing blade 17, which are main components, and the developing cover 22 as a resin second frame body that occupies a large frame part of the developer storage chamber 152. The developing roller 16 is rotatably supported by the developing container 21. The interior space of the developing unit 15, and in particular the developer storage chamber 152 serving as a storage portion, is formed by connecting the interior space of the developing container 21 with the interior space of the developing cover 22.

As illustrated in FIG. 38A, the developing container 21 has an opening (a first opening) 21o that leaves the interior space thereof open, and as illustrated in FIG. 38B, the developing cover 22 has an opening (a second opening) 22o that leaves the interior space thereof open. The opening 21o of the developing container 21 is an opening for the inside of the developing container 21 to communicate with the inside of the developing cover 22, and the opening 22o of the developing cover 22 is an opening for the inside of the developing cover 22 to communicate with the inside of the developing container 21. That is, the openings 21o and 22o are connected to each other, such that the interior space of the developing container 21 and the interior space of the developing cover 22 communicate with each other.

The developing container 21 and the developing cover 22 are joined to each other by joining the open edge portions of the respective openings 21o and 22o to each other in a sealed manner. A joint line 21L (a joint surface), which is an annular joint surface (a first surface), is provided at the open edge portions of the opening 21o of the developing container 21 (edges of a first opening) so as to surround the opening 21o of the developing container 21. Likewise, a joint line 22L (a joined surface), which is an annular joint surface (a second surface), is provided at the open edge portions of the opening 22o of the developing cover 22 (edges of a second opening) so as to surround the opening 22o of the developing cover 22.

A rib (protruding portion) 21a is provided in the surface of the joint line 21L of the developing container 21, annularly along the direction in which the joint line 21L extends surrounding the opening 21o, so as to protrude from the surface of the joint line 21L. In addition, a groove (recessed portion) 22a is provided in the surface of the joint line 22L of the developing cover 22, annularly along the direction in which the joint line 22L extends surrounding the opening 22o, so as to be recessed from the surface of the joint line 22L.

The annular rib 21a is inserted into the annular groove 22a, and the gap therebetween is sealed and joined by a hot melt 43, which is a thermally-melting adhesive (a connecting member; a joint member) as a joint member (described later), forming an annular joint portion between the developing container 21 and the developing cover 22. Through this, the developing container 21 and the developing cover 22 are integrated through the hot melt 43 serving as the joint member.

### Method for Manufacturing New Developing Unit

A method for manufacturing the developing unit 15 according to the present embodiment will be described in detail hereinafter along with a positioning configuration of the frame body. Note that many components such as a stirring member, a sealing member, and gears are assembled in the developing unit 15, but a method for assembling components related to main portions of the developing unit 15 according to the present embodiment will be described here, and descriptions of other components will be omitted as appropriate.

### New Product Process 1: Assembly of Developing Subunit

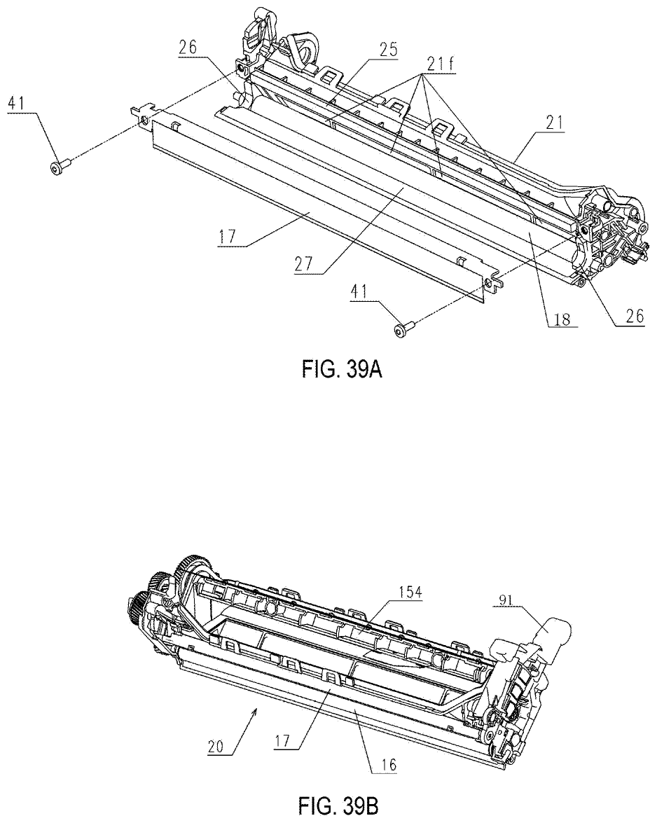

An assembly process for a developing subunit will be described with reference to FIGS. 39A and 39B. FIG. 39A is an assembly perspective view illustrating a process for assembling a developing blade with the developing container 21, and FIG. 39B is a completed perspective view of the developing subunit 20.

First, as illustrated in FIG. 39A, the developer supply roller 18 is attached to the developing container 21. Next, a blade back seal 25, an end seal 26, and a blowout prevention member 27, which are sealing members for sealing a periphery of a developing opening 21f of the developing container 21, are attached. Then, the developing blade 17 is assembled and fixed with screws 41, as illustrated. Furthermore, other components, such as the developing roller 16, gears, the stirring member 154, a side cover 91, and the like, are assembled, and the developing subunit 20 illustrated in FIG. 39B is complete.

In the present embodiment, prior to the joining of the developing unit, most of the components constituting the developing unit 15 are assembled in the developing container 21 to become the developing subunit 20.

### New Product Process 2: Application of Joint Member to Developing Cover

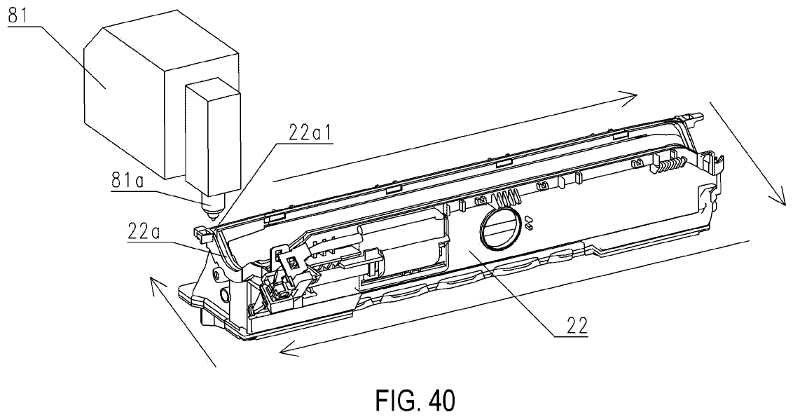

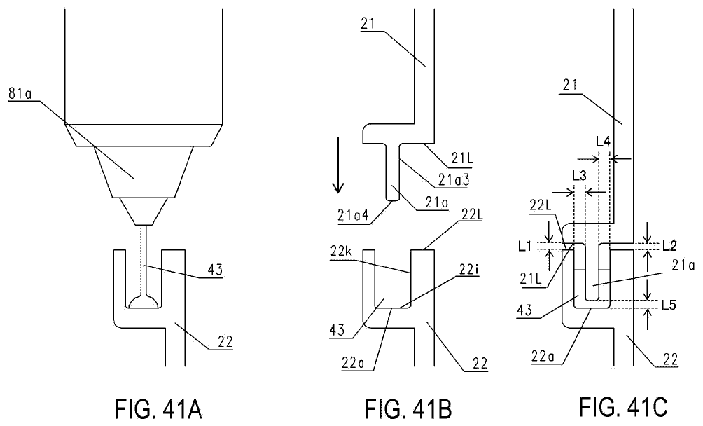

A process for applying the hot melt 43, which is the joint member, to the developing cover 22 will be described next with reference to FIG. 40 and FIGS. 41A to 41C. FIG. 40 is a perspective view illustrating a process for applying the hot melt to the developing cover 22 (an application process), and FIGS. 41A to 41C are schematic cross-sectional views illustrating the configuration of the joint portion between the developing container 21 and the developing cover 22 in detail.

As illustrated in FIG. 40, the hot melt 43, which is the joint member, is applied to the groove 22a formed across the entire periphery of the opening in the frame body of the developing cover 22. Starting from a buffer portion 22a1 of the groove 22a, an application nozzle 81a for a hot melt applicator apparatus 81 moves relative to the groove 22a along the direction in which the groove 22a extends annularly, and the hot melt 43 is applied in a single stroke in the direction of the arrow in the figure (over the entirety of the annular groove 22a at one time). At this time, the state in which the application nozzle 81a is brought toward the groove 22a and the hot melt is injected is illustrated in FIG. 41A.

### New Product Process 3: Joining of Developing Container and Developing Cover

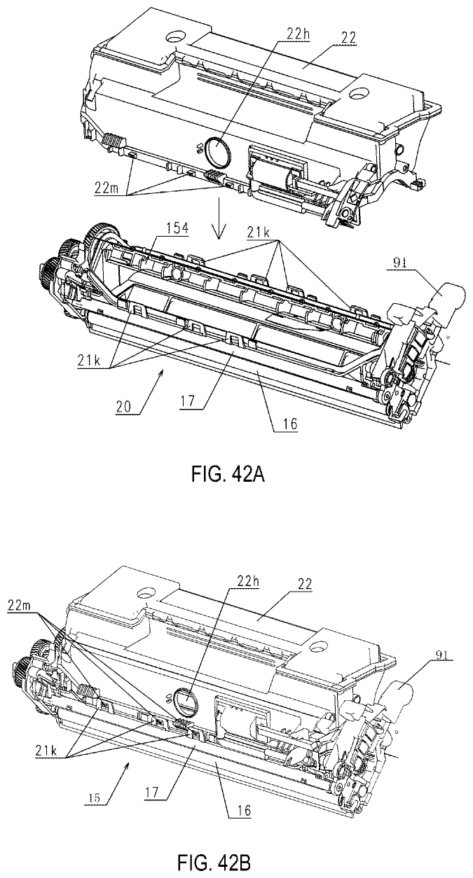

A joining process (a positioning process; a connection process) and a positioning configuration for the developing subunit 20 including the developing container 21 and the developing cover 22 will be described next with reference to FIGS. 38A and 38B, FIGS. 41A to 41C, and FIGS. 42A and 42B. FIG. 42A is a perspective view illustrating a state immediately before the developing subunit 20 and the developing cover 22 are joined (connected), and FIG. 42B is a perspective view illustrating a state after the developing subunit 20 and the developing cover 22 are joined (connected).

In the joining process, the developing cover 22 to which the hot melt 43 is applied is assembled to the developing subunit 20 as illustrated in FIG. 42A while the hot melt 43 is in the molten state, resulting in the joined state illustrated in FIG. 42B. Through this assembly, the joint portion between the developing subunit 20 and the developing cover 22 changes from the state illustrated in FIG. 41B to that illustrated in FIG. 41C, in which the rib 21a is inserted into the groove 22a such that at least the tip portion of the rib 21a is immersed in the hot melt 43 in the molten state.

As illustrated in FIG. 38A, the developing container 21 is provided with a first positioning boss 21b and a second positioning boss 21c for regulating the position in a longitudinal direction (a direction parallel to the center axis of the photosensitive drum 11) as the positioning configuration. On the other hand, as illustrated in FIG. 38B, the developing cover 22 is provided with a positioning hole 22b in a position opposite the first positioning boss 21b, and a rotation stopping hole 22c in a position opposite the second positioning boss 21c. The position in the longitudinal direction is regulated by fitting the first positioning boss 21b with the positioning hole 22b and fitting the second positioning boss 21c with the rotation stopping hole 22c.

Additionally, as illustrated in FIG. 38A, the developing container 21 is provided with a first abutting surface 21g, a second abutting surface 21h, and a third abutting surface 21j. On the other hand, as illustrated in FIG. 38B, the developing cover 22 is provided with a first abutting surface 22e, a second abutting surface 22f, and a third abutting surface 22g in positions opposite the stated abutting surfaces. These abutting surfaces constitute positioning portions for the assembling direction (the direction of the arrow in FIG. 42A) in the developing subunit 20 and the developing cover 22. In other words, the relative positions of the developing subunit 20 and the developing cover 22 in the assembling direction are regulated by the first abutting surfaces 21g and 22e abutting each other, the second abutting surfaces 21h and 22f abutting each other, and the third abutting surfaces 21j and 22g abutting each other. Each abutting surface is provided on the outer side of the joint line with respect to the interior space of the frame body.

Through this, the developing cover 22 is positioned relative to the developing subunit 20, and at this time, the joint portion is in the joined state illustrated in FIG. 41C. Accordingly, the developing subunit 20 and the developing cover 22 are joined (connected) over the hot melt 43 across the entirety of the joint portion as illustrated in FIG. 41C.

The state illustrated in FIG. 41C is a state in which the developing container 21 and the developing cover 22 are hermetically connected. In this connection state, gaps are provided between the developing container 21 and the developing cover 22, as indicated by L1 to L5 in the figure. That is, the joint surface 21L of the developing container 21 and the joint surface 22L of the developing cover 22 oppose each other with a gap between the developing container 21 and the developing cover 22 in the joining direction. More specifically, between the joint surface 21L and the joint surface 22L, a gap of L1 is formed on the outer side of the frame body with respect to a region where the rib 21a and the groove 22a are fitted, and a gap of L2 is formed on the inner side of the frame body. Furthermore, between the rib 21a and the groove 22a, a gap of L3 is formed between a side surface 21a3 of the rib 21a on the outer side of the frame body and a groove side surface 22k of the groove 22a on outer side of the frame body, and a gap of L4 is formed between the side surface 21a3 of the rib 21a on the inner side of the frame body and the groove side surface 22k of the groove 22a on the inner side of the frame body. Furthermore, a gap of L5 is formed between the tip of the rib 21a and a groove bottom surface 22i of the groove 22a. That is, the rib 21a is inserted into the groove 22a such that a tip surface 21a4 of the rib 21a and the groove bottom surface 22i of the groove 22a do not contact each other, and rather have a gap therebetween. In order to at least partially fill these gaps, the hot melt 43 is provided between the rib 21a and the groove 22a so as to be in contact with at least both the tip surface 21a4 of the rib 21a and the groove bottom surface 22i of the groove 22a.

### New Product Process 4: Engaging of Developing Container and Developing Cover

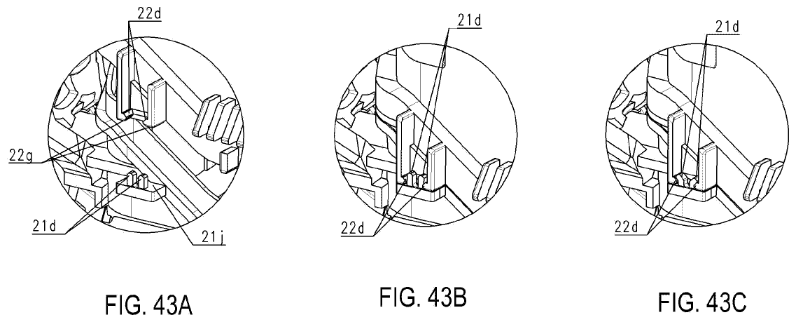

A method for engaging the developing subunit 20 and the developing cover 22 will be described next with reference to FIGS. 42A and 42B, and FIGS. 43A to 43C. FIGS. 43A to 43C are enlarged perspective views of the vicinity of engagement portions provided in the third abutting surfaces of the developing subunit 20 and the developing cover 22.

For example, if the cartridge is exposed to high temperatures during transport, or if pressure changes occur during air transport or transport at high altitudes, the internal pressure within the developer storage chamber 152 (FIG. 36), which is sealed to prevent toner leakage, may rise. This rise in pressure results in a load being applied to the developing subunit 20 and the developing cover 22 in the direction in which the joining of the two disengages (the direction opposite from the arrow direction in FIG. 42A). At this time, the center part of the frame body in the longitudinal direction deforms easily, leading to a risk that the joint by the hot melt will disengage.

As illustrated in FIG. 42A, in the present embodiment, a snap-fit shape 21k is provided on the developing container 21 side, and an engagement claw 22m is provided on the developing cover 22 side, at seven locations each. As illustrated in FIG. 42B, in the state where the developing subunit 20 and the developing cover 22 are joined, the engagement claw 22m engages with the snap-fit shape 21k, which prevents the joint portion from disengaging when the internal pressure in the developer storage chamber 152 rises.

Furthermore, the engagement portions provided at the same locations as the third abutting surfaces 21j and 22g among the three abutting surfaces will be described with reference to FIGS. 43A to 43C. In FIG. 43, the third abutting surface 21j on the developing container 21 side is provided with a fixed rib 21d as an engagement portion, and the third abutting surface 22g of the developing cover 22 is provided with a notch shape 22d as an engaged portion. FIG. 43A illustrates a state immediately before the developing subunit 20 and the developing cover 22 are joined, FIG. 43B illustrates a state immediately after being joined, and FIG. 43C illustrates a state after the engagement.

After the developing subunit 20 and the developing cover 22 approach each other as illustrated in FIG. 43A, when the developing subunit 20 and the developing cover 22 are joined as illustrated in FIG. 43B, the third abutting surfaces 21j and 22g abut each other, and the fixed rib 21d is inserted into the notch shape 22d. At this time, the fixed rib 21d and the notch shape 22d have a gap in the longitudinal direction, and thus are not involved in regulation in the longitudinal direction. Then, as illustrated in FIG. 43C, the tip of the fixed rib 21d is heated and deformed (plastic deformation) to engage with the notch shape 22d, which completes the fixing that regulates the distance between the third abutting surfaces 21j and 22g.

Through the engagement process described above, the developing subunit 20 and the developing cover 22 are positioned and fixed to each other, and the hot melt 43 is cooled and cured (a curing process), which integrates the developing subunit 20 with the developing cover 22 and completes the frame body of the developing unit 15.

New Product Process 5: Filling Developing Unit with Toner

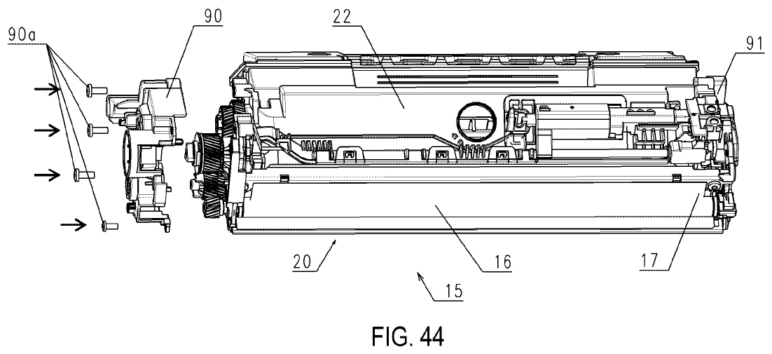

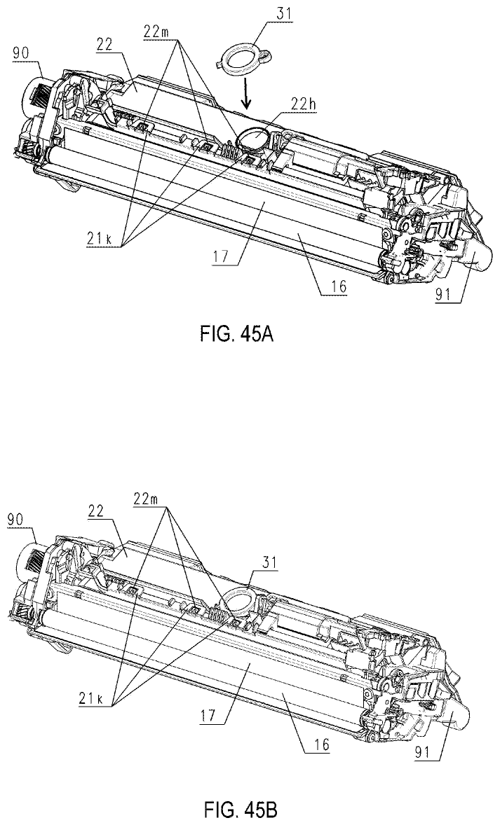

Finally, the remaining processes leading to the completion of the developing unit 15 will be described with reference to FIG. 44 and FIGS. 45A and 45B. FIG. 44 illustrates a process for attaching a side cover to the developing unit, and FIGS. 45A and 45B illustrate a process for filling the developing unit 15 with toner.

First, as illustrated in FIG. 44, the side cover 90 is assembled to the joined developing unit 15 with screws 90a.

Thereafter, a predetermined amount of toner is filled from a toner filling port 22h, which is a hole for filling toner provided in the developing cover 22 illustrated in FIG. 45A, after which the hole is sealed with a cap member 31, thus completing the developing unit 15, as illustrated in FIG. 45B.

### New Product Process 6: Coupling Cleaning Unit and Developing Unit

New Product Process 6 is a process for coupling the cleaning unit 10 and the developing unit 15.

New Product Process 6 will be described with reference to FIGS. 35A and 35B and FIG. 36. As illustrated in FIGS. 35A and 35B and FIG. 36, the cleaning unit 10 and the developing unit 15 are aligned such that holes in the developing unit 15 into which the coupling pins 8a and 8b of the cleaning unit 10 enter overlap. Then, the cleaning unit 10 and the developing unit 15 are recoupled by inserting the coupling pins 8a and 8b into the overlapping holes. Finally, the pressure spring 19 that biases the developing roller 16 to contact the photosensitive drum 11 with the rotation center 8 as a support point is attached. This completes the new product process for the process cartridge 5.

### Process Cartridge Disassembly and Reproduction Method

Next, a method for disassembling and reproducing (a method for manufacturing) the process cartridge 5 will be described in order according to the following Restoration Processes 1 to 9.
Restoration Process 1: Separation of Cleaning Unit and Developing Unit
Restoration Process 2: Residual Toner Processing
Restoration Process 3: Side Cover Separation
Restoration Process 4: Separation of Developing Container and Developing Cover
Restoration Process 5: Developing Unit Interior Maintenance
Restoration Process 6: Rejoining Developing Container and Developing Cover
Restoration Process 7: Side Cover Reattachment
Restoration Process 8: Toner Refilling
Restoration Process 9: Recoupling Cleaning Unit and Developing Unit

Note that the reproduction method according to the present embodiment includes a preparation process for preparing the process cartridge 5 serving as the base material before performing the stated Restoration Processes 1 to 9. For example, a used process cartridge 5 from which the toner has been consumed through image forming operations is used as the process cartridge 5 serving as the base material. The reproduction method according to the present embodiment is a method for reproducing a new developing unit 15 from the developing unit 15 of the process cartridge 5 serving as the base material. Furthermore, the reproduction method according to the present embodiment is a method for reproducing a new process cartridge from the process cartridge 5 serving as the base material.

The reproduction method according to the present embodiment will be described in detail hereinafter with reference to FIGS. 35A and 35B, FIGS. 36 and 40, FIGS. 43A to 43C, and FIGS. 46A and 46B to FIGS. 52A to 52C.

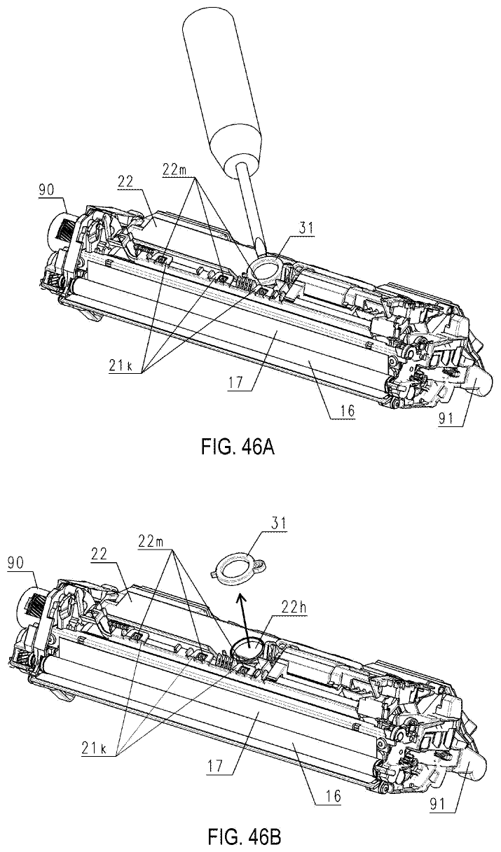

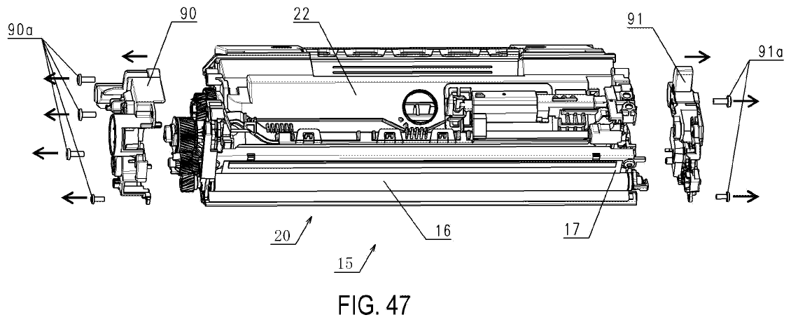

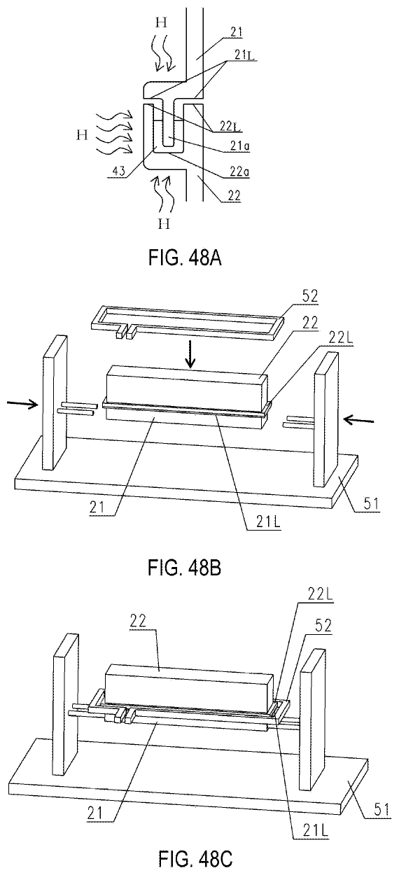

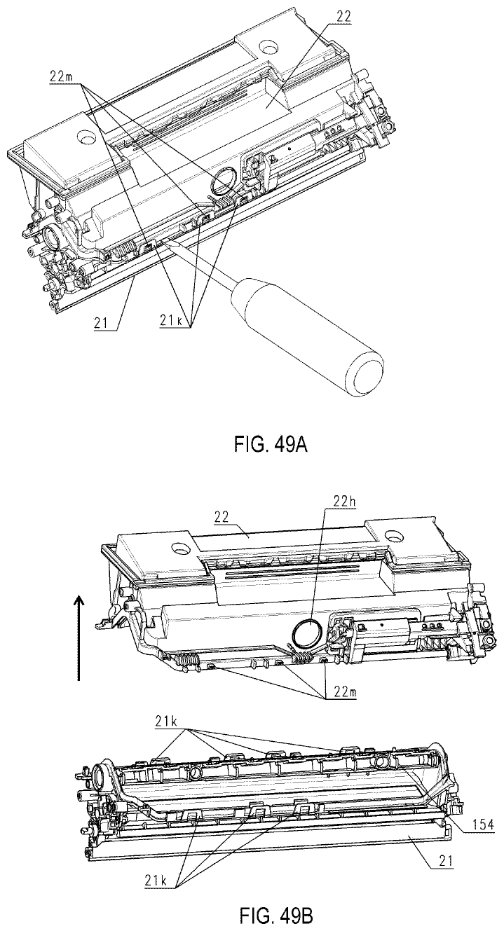

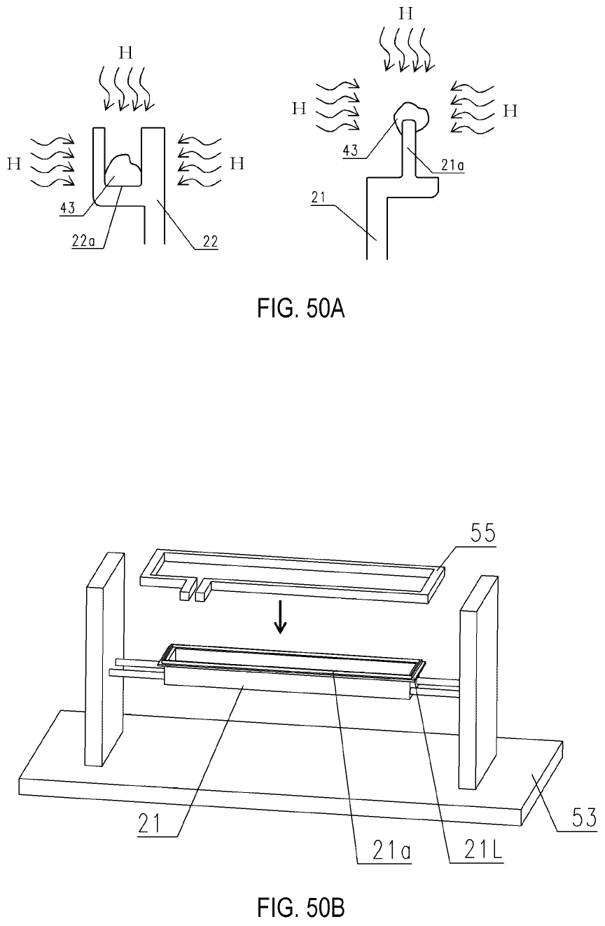

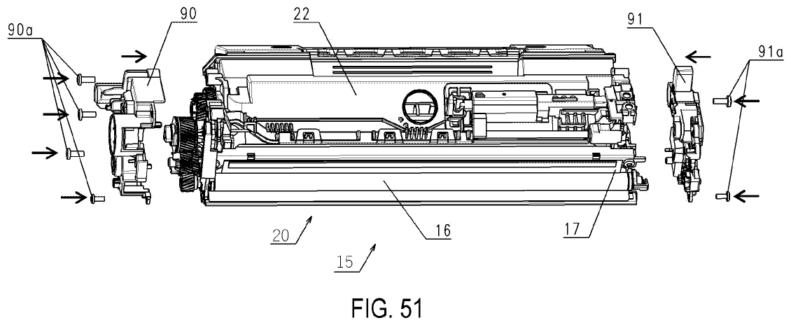

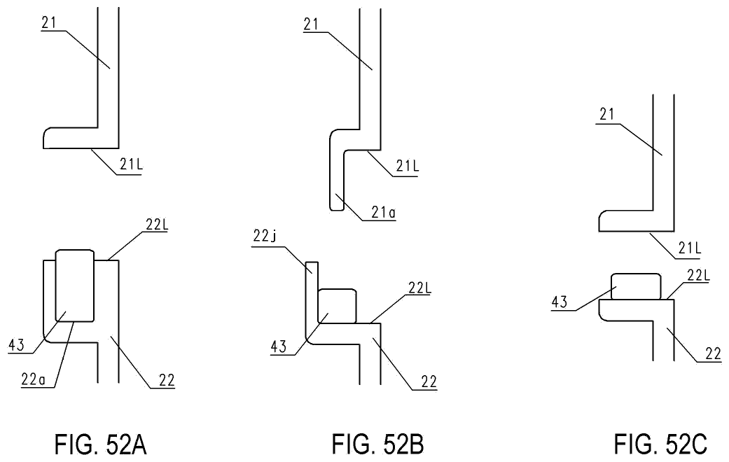

FIGS. 46A and 46B are perspective views of the developing unit 15, illustrating an example of a process for removing the toner cap 31 from the developing cover 22. FIG. 47 is a perspective view illustrating a process for removing side covers from the developing unit 15. FIGS. 48A to 48C are perspective views illustrating a process for warming the joint portion of the developing unit 15. FIGS. 49A and 49B are perspective views illustrating a process for separating the joint portion between the developing container 21 and the developing cover 22. FIGS. 50A and 50B are perspective views of a method using a jig, illustrating an example of a process for warming the disassembled developing container 21 and developing cover 22, respectively. FIG. 51 is a perspective view illustrating a process for reattaching side covers. FIGS. 52A to 52C are schematic cross-sectional views illustrating an example of the configuration of the joint portion between the developing container 21 and the developing cover 22 in detail.

### Restoration Process 1: Separation of Cleaning Unit and Developing Unit

Restoration Process 1 is a process for separating the cleaning unit 10 and the developing unit 15. Restoration Process 1 will be described with reference to FIGS. 35A and 35B and FIG. 36.

Restoration Process 1 is the reverse process of New Product Process 6, and first, the pressure spring 19 that biased the developing roller 16 to contact the photosensitive drum 11 with the rotation center 8 as a support point is removed, as illustrated in FIGS. 35A and 35B and FIG. 36. Next, the coupling pins 8a and 8b that couple the cleaning unit 10 and the developing unit 15 to each other are pulled from the holes provided in the cleaning unit 10 and the developing unit 15, respectively, to separate the cleaning unit 10 and the developing unit 15.

### Restoration Process 2: Residual Toner Processing

Restoration Process 2 is a process for removing toner remaining in the developing unit 15. Restoration Process 2 will be described with reference to FIGS. 46A and 46B.

First, as illustrated in FIG. 46A, the developing unit is held while the toner cap 31 and the toner filling port 22h of the developing cover 22 are facing upward vertically. This is to prevent residual toner from spilling out from the open toner filling port 22h.

Next, the toner cap 31 sealing the toner filling port 22h is removed. As illustrated in FIG. 46A, a flathead screwdriver or the like is inserted into the gap between the toner cap 31 and the toner filling port 22h. The toner cap 31 is then removed from the developing cover 22 using the principle of a lever or the like.

Then, as illustrated in FIG. 46B, the toner filling port 22h of the developing cover 22 is open, and thus the nozzle (not shown) joined to the suction apparatus (not shown) is inserted into the toner filling port 22h, and the residual toner is sucked out.

### Restoration Process 3: Side Cover Separation

Restoration Process 3 is a process for separating the side covers 90 and 91. Restoration Process 3 will be described with reference to FIG. 47.

As illustrated in FIG. 47, the screws 90a and 91a securing the side covers 90 and 91 to the developing unit 15 are removed with a screwdriver or the like, and the side covers 90 and 91 are removed from the developing unit 15. Furthermore, gears, the developing roller 16, the developing blade 17, and the like attached to the developing unit 15 are removed as necessary. At this time, maintenance is performed on the removed components by checking the state of wear, dirt, change in performance, and the like due to use, or are replaced during the reassembly in Restoration Process 7.

### Restoration Process 4: Separation of Developing Container and Developing Cover

Restoration Process 4 is a process for separating the joint portion between the developing container 21 and the developing cover 22.

As described in New Product Processes 3 and 4, the developing container 21 and the developing cover 22 are joined using the hot melt 43, which is a joint member, and furthermore, movement in the separation direction is regulated using snap-fitting or thermal caulking.

Restoration Process 4 will be described hereinafter with reference to FIGS. 48A to 48C and FIGS. 49A and 49B. FIGS. 48A to 48C are schematic diagrams illustrating a method for softening the hot melt 43, which is the joint member of the developing unit 15. FIG. 48A is an enlarged cross-sectional view of the joint portions 21L and 22L of the developing container 21 and the developing cover 22 joined by the hot melt 43, and FIGS. 48B and 48C illustrate a method for warming the joint portion of the developing unit 15 using a jig. FIGS. 48A to 48C schematically illustrate the developing container 21, the developing cover 22, the hot melt 43, and the like. FIGS. 49A and 49B are diagrams illustrating a process for separating the joint portion between the developing container 21 and the developing cover 22 when the hot melt 43 is in a softened state.

First, the tip portion of the fixed rib 21d (FIG. 43C), which is engaged with a fixing portion 22d through the heating and deformation (plastic deformation) in New Product Process 4 to prevent slipping out, is cut with a nipper or the like.

Next, as illustrated in FIG. 48A, the annular joint portion formed by the hot melt 43 is warmed to soften the hot melt, i.e., to a temperature at least the temperature at which the hot melt softens.

A method using a jig 51, as illustrated in FIGS. 48B and 48C, can be used, for example. The jig 51 can keep the developing unit 15 in a set orientation, and includes an annular-shaped heat conducting portion 52 along the annular joint portions 21L and 22L of the developing unit 15. The developing unit 15, where the developing container 21 and the developing cover 22 remain joined, is set in the jig 51. The heat conducting portion 52 is then moved closer to a position opposite the annular joint portions 21L and 22L of the developing unit 15. The entirety of the joint portions 21L and 22L is warmed by warming the heat conducting portion 52 with a heat generating element or a water pipe through which hot water passes, or by heating a heat conducting member itself.

The hot melt is softened by warming such that the temperature of the hot melt inside the wall of the resin components is held at a predetermined temperature of about 60 °C for 40 seconds. However, at this time, components other than hot melt are not deformed or degenerated by the heat. For example, the temperature of the joint portion of the hot melt is kept from exceeding the glass transition point of the resin material.

With the hot melt softened, a flathead screwdriver is inserted into the gap in the joint portion between the developing container 21 and the developing cover 22, as illustrated in FIG. 49A. Then, while disengaging the seven snap-fit shapes 21k from the seven engagement claws 22m opposite thereto, the inserted flathead screwdriver is moved according to the principle of the lever, and the developing container 21 and the developing cover 22 are separated as illustrated in FIG. 49B.

At this time, it is necessary to disengage the snap-fit shapes 21k from the engagement claws 22m while taking care not to break the snap-fit shapes 21k. To improve the work efficiency, a method can be used where the developing unit 15 is set onto a base (not shown) where the snap fit can be disengaged, and a flathead screwdriver or the like may be inserted into the gap in the joint portion between the developing container 21 and the developing cover 22 to separate the two.

Although the joint portions 21L and 22L of the developing container 21 and the developing cover 22 are in a state where hot melt remains, the joint portions 21L and 22L are stored so as not to come into contact with other components, apparatuses, or the like.

The following methods can be given as other methods for softening the hot melt.

For example, the developing unit 15, with the developing container 21 and the developing cover 22 still joined, may be placed in a thermostatic chamber to be warmed evenly. A method can also be used in which the joint portion is warmed evenly by applying warm air using a dryer or the like. Additionally, as long as the hot melt 43 of the joint portions 21L and 22L can be softened, the developing container 21 and the developing cover 22 need not be warmed evenly, and at least one thereof may be warmed.

Regardless of the method, it is sufficient for the temperature of the hot melt to be capable of being held at a predetermined temperature of about 60 °C for 40 seconds, to keep the joint portion from exceeding the glass transition point of the resin material.

### Restoration Process 5: Developing Unit Interior Maintenance

Restoration Process 5 is a process for performing maintenance on the interior of the developing unit 15 in a state where the developing container 21 and the developing cover 22 are separated.

Restoration Process 5 will be described with reference to FIGS. 49A and 49B. As illustrated in FIG. 49B, when the developing container 21 and the developing cover 22 are separated, the developer storage chamber 152 is exposed. Using the nozzle (not shown) connected to the suction apparatus (not shown) used in Restoration Process 3, the residual toner remaining inside the developing container 21 side and the developing cover 22 side, respectively, is sucked and cleaned out. In addition, the states of components such as the internal stirring member 154 and the developer supply roller 18 are confirmed, and maintenance and replacement are performed as necessary.

### Restoration Process 6: Rejoining Developing Container and Developing Cover

Restoration Process 6 is a process for rejoining the developing container 21 and the developing cover 22.

Restoration Process 6 will be described with reference to FIGS. 50A and 50B. FIGS. 50A and 50B are schematic diagrams illustrating a method for warming a hot melt for each component in the restoration process. FIGS. 50A and 50B schematically illustrate the developing container 21, the developing cover 22, the hot melt 43, and the like.

FIG. 50A is an enlarged cross-sectional view of the joint portions 21L and 22L of the developing container 21 and the developing cover 22 to which the hot melt adheres. FIG. 50B illustrates a jig 53 holding the developing container 21, and the jig 53 includes an annular heat conducting portion 55 along the annular joint portion 21L of the developing container 21.

In Restoration Process 6, first, as illustrated in FIG. 50A, the developing container 21 and the developing cover 22 are warmed so that the hot melt 43 remaining on the joint portions 21L and 22L of the developing container 21 and the developing cover 22 softens again (a heating process).

For example, the jig 53 is used, as illustrated in FIG. 50B. The developing container 21 to which the hot melt 43 in a cured state adheres is set in the jig 53 with the joint surface to which the hot melt 43 adheres facing upward in the vertical direction. Next, the heat conducting portion 55 is moved to a position facing the annular joint portion 21L of the developing container 21, and closer to the hot melt. Note that at this time, the heat conducting portion 55 does not directly contact the hot melt. The hot melt 43 adhering to the rib 21a of the joint portion 21L is warmed by warming the heat conducting portion 55 with a heat generating element or a water pipe through which hot water passes, or by heating a heat conducting member itself. Likewise, the hot melt 43 adhering to the groove 22a of the joint portion 22L of the developing cover 22 is warmed using a jig in the same manner.

The hot melt is softened by holding the temperature of the hot melt at a predetermined temperature of about 60 °C for about 40 seconds. However, at this time, components other than hot melt are not deformed or degenerated by the heat. For example, the temperature of the joint portion to which the hot melt adheres is kept from exceeding the glass transition point of the resin material.

Next, as in New Product Processes 3 and 4, in the state where the hot melt 43 is softened, the developing container 21 and the developing cover 22 are positioned in a predetermined opposing state (a positioning process), and are joined (connected) to each other by curing the hot melt 43. That is, the rib 21a provided annularly on the joint surface 21L of the developing container 21 is inserted into the groove 22a provided annularly on the joint surface 22L of the developing cover 22, and the joint surfaces 21L and 22L are joined, positioned, and engaged.

However, the fixed rib 21d provided at the same location as the third abutting surfaces 21j and 22g is not heated and deformed (plastic deformation) to engage the notch shape 22d, as performed in New Product Process 4 (see FIG. 43C). The engagement process in Restoration Process 6 is only a process for engaging the seven snap-fit shapes 21k provided in the developing container 21 illustrated in FIG. 49B with the opposing seven engagement claws 22m provided in the developing cover 22.

Through the foregoing, the developing container 21 and the developing cover 22 are rejoined.

The following methods can be given as other methods for softening the hot melt.

For example, the developing container 21 and the developing cover 22 to which the hot melt 43 adheres are placed in a thermostatic chamber with the joint surfaces to which the hot melt 43 adheres facing upward in the vertical direction, respectively.

For example, warm air is applied to the annular joint surfaces 21L and 22L of the developing container 21 or the developing cover 22 using a dryer or the like, and the hot melt 43 adhering thereto is warmed evenly.

For example, the annular joint surfaces 21L and 22L of the developing container 21 or the developing cover 22 are irradiated with laser light to warm the remaining hot melt 43. At this time, adjusting the irradiation depth of the laser light to the hot melt makes it possible to warm the hot melt efficiently while minimizing the influence of the laser light on the joint surfaces 21L and 22L. In addition, in the processes including and following the separation of the joint portion between the developing container 21 and the developing cover 22 in Restoration Process 5, the hot melt 43 remaining on the developing container 21 and the developing cover 22 may adhere to a place other than the rib 21a of the developing container 21 or the groove 22a of the developing cover 22. In such a case, the residual hot melt may be left as it is, and the applicator apparatus 81 may be used in the groove 22a of the developing cover 22 in the same manner as in New Product Process 2 to add more of the hot melt 43 as necessary (FIG. 40).

The method of warming the hot melt 43 in this process so as to soften the hot melt again can also be applied in the manufacture of a new developing unit 15. In other words, after “New Product Process 2: Applying Joint Member to Developing Cover”, the hot melt 43, which is the joint member, can be applied even if “New Product Process 3: Joining Developing Container and Developing Cover” could not be performed in a molten state. After “New Product Process 2: Application of Joint Member to Developing Cover” is performed, in a normal manufacturing process, the hot melt 43, which is the joint member, can be performed the following “New Product Process 3: Joining of Developing Container and Developing Cover” in a molten state. However, if, for example, a malfunction occurs in New Product Process 3 and the process stops, the developing cover 22 to which the hot melt was applied in New Product Process 2 cannot proceed to New Product Process 3, and the applied hot melt 43 hardens. Until now, in such a situation, the developing cover 22 to which the hot melt applied had solidified and adhered had been discarded. However, if the method of softening the hot melt 43 in Restoration Process 6 is used again, the developing cover 22 on which the hot melt hardened before the joining can be used again in New Product Process 3. Being able to use the developing cover 22 and the hot melt, which thus far have been discarded, makes it possible to reduce waste of components and materials, which leads to a reduction in the cost of the process cartridge and a reduction in the environmental impact.

### Restoration Process 7: Side Cover Reattachment

Restoration Process 7 is a process for reattaching the side covers 90 and 91 removed in Restoration Process 3. This is performed using the reverse procedure from Restoration Process 3.

First, components such as gears and developing rollers that have been removed or replaced are reattached to the developing unit 15 as necessary. Then, as illustrated in FIG. 51, the positions of the side covers 90 and 91 are aligned with the developing unit 15, and the screws 90a and 91a are secured again using a screwdriver or the like.

Restoration Process 8: Refilling Developing Unit with Toner

Restoration Process 8 is a toner refilling process for filling the developing unit 15 with new toner. The toner refilling process is the same as the toner filling process in New Product Process 5 (the process of filling toner for the first time).

By filling a predetermined amount of toner from the toner filling port 22h provided in the developing cover 22 and then sealing the toner filling port 22h with a cap member 31, the developing unit 15 is completed, as illustrated in FIGS. 45A and 45B.

### Restoration Process 9: Recoupling Cleaning Unit and Developing Unit

Restoration Process 9 is a process for recoupling the cleaning unit 10 and the developing unit 15.

Replacement and maintenance is performed for the cleaning unit 10 and the internal components separated in Restoration Process 1, and is coupled again with the developing unit 15 refilled with toner through the same procedure as in New Product Process 6. This completes the restoration process for the process cartridge 5.

As described above, in the reproduction method according to the present embodiment, in addition to refilling the developing unit 15 with toner, the joint portion between of the developing cover 22 and the developing container 21 of the developing unit 15 is separated, which makes it possible to perform maintenance and replacement of the internal components as well. In addition, components can be reused without removing the hot melt remaining at the time of disassembly, which greatly reduces the labor involved in the reproduction, and hot melt that has thus far been discarded can also be reused. A process cartridge having the same performance as a new product can be reproduced at a low cost, while avoiding distortion in the frame body, enabling precision components to be positioned as normal, and ensuring toner leakage and image defects do not occur.

In addition, when producing a new product, components that had thus far been discarded during line stops can now be used. This makes it possible to reduce the manufacturing cost of the process cartridge and further reduce the environmental impact.

In the separation of the developing container 21 and the developing cover 22 in Restoration Process 4, the part where the tip portion of the fixed rib 21d that is engaged with the notch shape 22d due to thermal deformation (plastic deformation) to prevent slipping out is cut is not restored in the restoration process. In the present embodiment, the remanufactured toner cartridge is of the same quality as a new product, but is left in this state so as to be identifiable as a restored product. This is because, as described above, restored product process cartridges are reproduced by reusing most components, which greatly reduces the environmental impact compared to new product process cartridges, and provides a high commercial value. Reliably distinguishing between new and restored products in their finished state is effective in the commercial distribution of process cartridges, which are consumables for image forming apparatuses.

Although the annular joint surface in the present embodiment is the rib 21a provided on the joint surface 21L of the developing container 21 and the groove 22a provided on the joint surface 22L of the developing cover 22, the rib shape and the groove shape may be reversed. In addition, as in Variation 1 illustrated in FIG. 52A, the configuration may omit the rib shape on the joint surface. Likewise, as in Variation 2 illustrated in FIG. 52B, both sides may have rib shapes. Specifically, a rib 22j (a second protruding portion) may be provided in the joint surface 22L of the developing cover 22 further outward, in a direction from the interior of the developer storage chamber 152 serving as a storage portion toward an exterior thereof, than the rib 21a (a first protruding portion) provided in the joint surface 21L of the developing container 21. The hot melt 43 is applied to an inner side of the rib 22j and contacts the rib 21a so as to cover at least a tip side of the rib 21a. In addition, as in Variation 3 illustrated in FIG. 52C, the configuration may omit both the rib shape and the groove shape on the joint surfaces. It is sufficient for the hot melt to be capable of joining the joint surface 21L of the developing container 21 to the joint surface 22L of the developing cover 22 without a gap therebetween.

Although a manufacturing method of the present disclosure, and a case where a reproduction method is applied, have been described in detail thus far with respect to the developing unit 15 in particular as a container of the process cartridge 5, the present disclosure can also be applied to the cleaning unit 10 illustrated in FIGS. 34 and 36. In other words, the cleaning unit 10 includes a cleaning container 61 as a first member, a cleaning cover 62 as a second member, and a hot melt 44 as a connecting member at a joint portion between the two, which constitute a waste toner containment portion 14 as a container. The same manufacturing method and the disassembly/restoration method as those used for the developing unit 15 can be applied to the cleaning unit 10, with the same effects being achieved.

### Embodiment 5

Embodiment 5 of the present disclosure (an example of warming after rejoining) will be described. In the present embodiment, the order of the processes in Restoration Process 6 of Embodiment 4 are changed, but the other configurations and processes are the same as in Embodiment 4.

In Restoration Process 6b according to the present embodiment, the developing container 21 and the developing cover 22 are first rejoined while the hot melt adhering to the developing container 21 and the developing cover 22 remains cured, and the hot melt is softened after the rejoining. In other words, the order of the hot melt softening process (heating process) and the rejoining process (positioning process) is reversed from that in Restoration Process 6.

First, the developing container 21 and the developing cover 22 are positioned and engaged in the same manner as in Restoration Process 6, with the hot melt adhering to the developing container 21 and the developing cover 22 remaining cured. Then, as in Restoration Process 6, the fixed rib 21d provided at the same location as the third abutting surfaces 21j and 22g is not heated and deformed (plastic deformation) to engage the notch shape 22d, as perform in New Product Process 4.

At this time, loads or distortions occur in the developing container 21 and the developing cover 22 due to the effects of the cured hot melt.

Next, the hot melt 43 at the joint portion between the developing container 21 and the developing cover 22 is warmed so as to soften again. This can be done using the same method as the plurality of methods for warming the joint portion between the developing container 21 and the developing cover 22 (FIGS. 48A to 48C), described in the example in “Restoration Process 4: Separation of Developing Container and Developing Cover” in Embodiment 4.

When the hot melt softens, the hot melt 43 expands to the joint portion between the developing container 21 and the developing cover 22, and the joint portion can be sealed without gaps. In addition, the loads and distortions produced in the developing container 21 and the developing cover 22 are eliminated, and the developing container 21 and the developing cover 22 are joined together with good precision.

As described above, in the reproduction method according to the present embodiment as well, in addition to refilling the developing unit 15 with toner, the joint portion between of the developing cover 22 and the developing container 21 of the developing unit 15 is separated, which makes it possible to perform maintenance and replacement of the internal components as well. In addition, components can be reused without removing the hot melt remaining at the time of disassembly, which greatly reduces the labor involved in the reproduction, and hot melt that has thus far been discarded can also be reused. A process cartridge having the same performance as a new product can be reproduced at a low cost, while avoiding distortion in the frame body, enabling precision components to be positioned as normal, and ensuring toner leakage and image defects do not occur.

### Embodiment 6

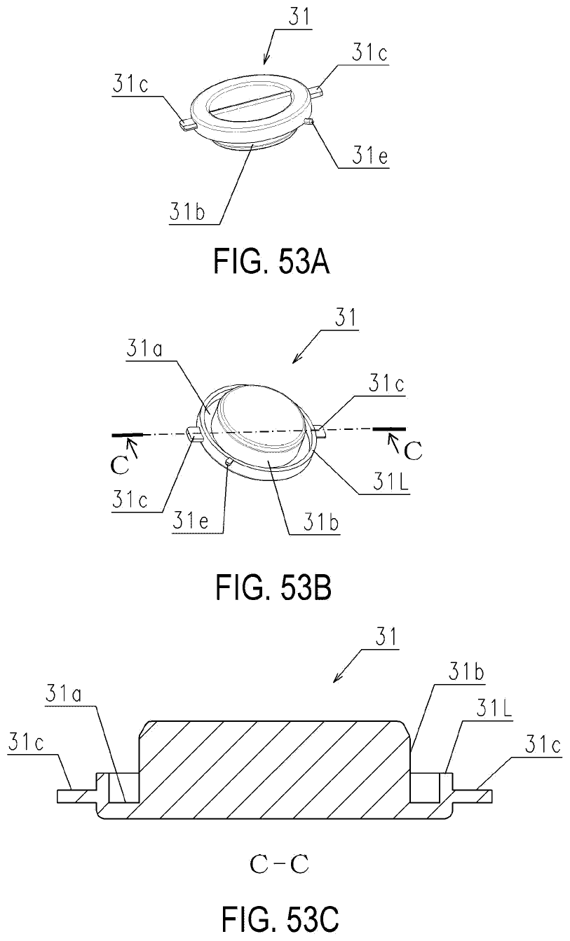

Embodiment 6 according to the present disclosure (an example of joining the toner cap) pertains to the process of joining/removing the toner cap 31 to/from the developing cover in
New Product Process 5: Filling Developing Unit with Toner
Restoration Process 2: Residual Toner Processing
Restoration Process 8: Refilling Developing Unit with Toner of Embodiment 4. In the present embodiment, the process of using the hot melt 43 as a joint member that joins the toner cap 31 as a first member to the toner filling port 22h of the developing cover 22 of the developing unit 15 as a second member will be described as
New Product Process 5b: Toner Cap Joining
Restoration Process 2b: Toner Cap Separation
Restoration Process 8b: Toner Cap Rejoining
The present embodiment will be described in detail hereinafter with reference to FIGS. 53A to 55C to FIGS. 55A to 55C.

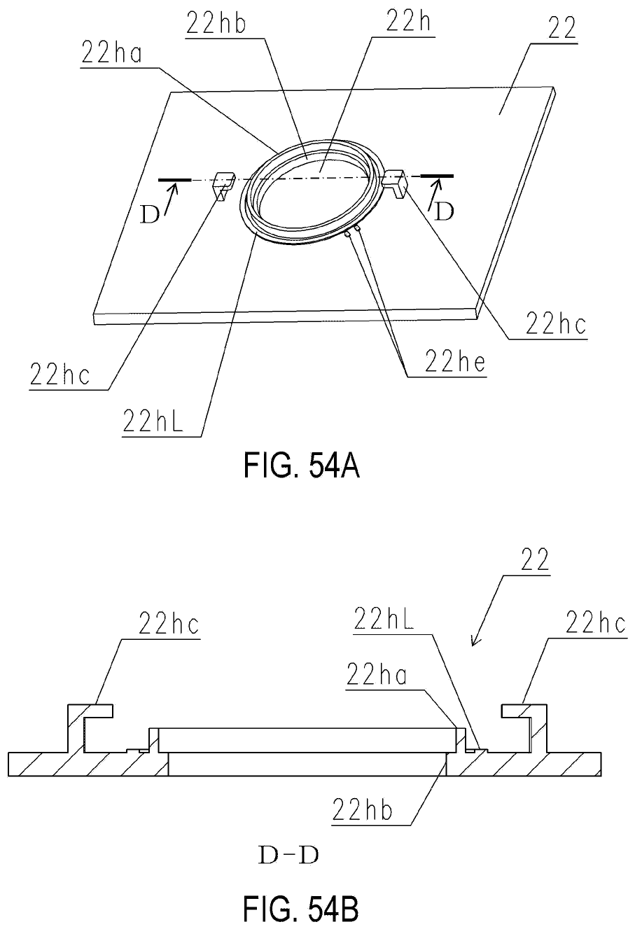

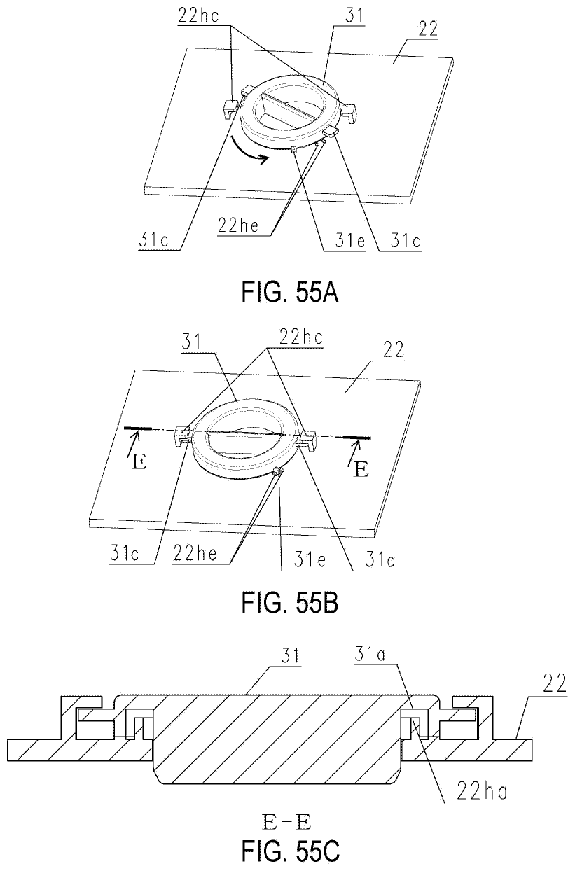

FIGS. 53A to 53C are detailed views of the toner cap 31, FIGS. 54A and 54B are detailed views of the periphery of the toner filling port 22h of the developing cover 22, and FIGS. 55A to 55C are diagrams illustrating a process for attaching the toner cap 31 to the toner filling port 22h.

From among FIGS. 53A to 53C, FIG. 53A is a perspective view of the toner cap 31 taken from the outside of the developing unit 15, and FIG. 53B is a perspective view taken from the other side. FIG. 53C is a C-C cross-sectional view from FIG. 53B. The toner cap 31 has a circular, thin plate structure. The toner cap 31 includes a joint surface 31L along an outer circumferential part of the circle, and a groove (recessed portion) 31a provided annularly along the joint surface 31L. In addition, the toner cap 31 has a circular protruded shape 31b in the center; on the outer circumferential part of the circle, two flange-like shapes 31c are positioned opposite each other to prevent slippage, and a protrusion 31e used to prevent rotation is furthermore provided.

From among FIGS. 54A and 54B, FIG. 54A is a perspective view of the developing cover 22 taken from the outside of the developing unit 15, and FIG. 54B is a D-D cross-sectional view from FIG. 54A. A filling port 22h of the developing cover 22 has a hole shape 22hb, and a circular rib shape (protruding portion) 22ha is provided on the outer wall side of the developing cover 22 along the hole shape 22hb. A joint surface 22hL is provided on the radially outer side of the rib 22ha; furthermore, ridge-like shapes 22hc are provided at two opposing locations on the radially outer side, and a rotation stopping protrusion 22he is provided. The circular protruded shape 31b in the center of the toner cap 31 and the hole shape 22hb of the filling port 22h are in a relationship of fitting together.

From among FIGS. 55A to 55C, FIG. 55A is a diagram illustrating the toner cap 31 being attached to the toner filling port 22h, and FIG. 55B is a diagram illustrating a state after the toner cap 31 has been attached to the toner filling port 22h. FIG. 55C is an E-E cross-sectional view from FIG. 55B.

### New Product Process 5b: Toner Cap Joining

In the present embodiment, after the toner is filled in New Product Process 5 of Embodiment 4, a hot melt is applied to the groove 31a of the toner cap 31 illustrated in FIG. 53B. While the hot melt is soft, the toner cap 31 is attached to the toner filling port 22h. In other words, as illustrated in FIG. 55A, the circular protruded shape 31b in the center part of the toner cap 31 is fitted to and inserted into the hole shape 22hb of the toner filling port 22h, and the joint surface 31L of the toner cap 31 is pushed until abutting the joint surface 22hL of the developing cover 22. Next, the toner cap 31 is rotated relative to the developing cover 22 in the direction of the arrow in FIG. 55A, and the flange-like shapes 31c move to the underside of the ridge-like shapes 22hc provided in the developing cover 22. Finally, the rotation stopping protrusion 31e of the toner cap 31 overcomes the rotation stopping protrusion 22he of the developing cover, and the rotation of the toner cap 31 is regulated as illustrated in FIG. 55B. At this time, the rib 22ha of the toner filling port 22h enters the groove 31a of the toner cap 31, and the state is the same as that in FIG. 55C.

As a result, the toner cap 31 is positioned relative to the developing cover 22, joined in a state where the gap is sealed by the hot melt, and is further secured by the anti-pullout and rotation stopping configurations. As a result, even if the developing unit 15 with which the toner cap 31 is assembled is subjected to high temperatures during transport as a toner cartridge, the internal pressure in the developing container rises, or the like, the toner cap 31 will not come off, and the toner can remain sealed.

### Restoration Process 2b: Toner Cap Separation

A process for removing the toner cap 31 when performing residual toner processing, and Restoration Process 2b, in the restoration process according to the present embodiment, will be described next. As described in Reproduction Process 2 of Embodiment 4, the developing unit is first held while the toner cap 31 and the toner filling port 22h of the developing cover 22 are facing upward vertically (FIG. 46A). The joint portion of the toner cap 31 is then warmed from the outside of the developing unit 15 to soften the hot melt 43, which is the joint member.

The same method as in the example described in Reproduction Process 2 of Embodiment 4 can be used as the method for softening the hot melt 43.

However, in Restoration Process 2b according to the present embodiment, since residual toner remains in the interior of the developing unit 15, it is desirable to limit the heating to the periphery of the toner cap 31 such that the residual toner does not exceed the melting point of the toner. If the residual toner melts and sticks to the wall surfaces and internal components of the developer storage chamber 152, the maintenance burden may increase, preventing the quality of the reproduced product from being equivalent to that of a new product.

Once the hot melt 43 of the toner cap 31 softens, the toner cap 31 is rotated in the direction opposite from the arrow in FIG. 55A, and the rotation stopper 31e overcomes the rotation stopping protrusion 22he on the developing cover 22 side. Furthermore, the slippage preventing shapes 31c rotate from underneath of the ridge-like shapes 22hc on the developing cover 22 side to the point of escape, resulting in the state illustrated in FIG. 55A. When in this state a flathead screwdriver is inserted between the toner cap 31 and the developing cover 22, or the toner cap 31 is pulled by pliers or the like, the toner cap 31 separates from the developing cover 22, and the toner filling port 22h appears, as illustrated in FIG. 46A.

### Restoration Process 8b: Toner Cap Rejoining

A process for rejoining the toner cap 31, and Restoration Process 8b, will be described next in the restoration process according to the present embodiment. After refilling the developing unit 15 with toner, the hot melt adhering to the periphery of the toner cap 31 and the toner filling port 22h of the developing cover 22 softens again, and the toner cap 31 is joined to the developing cover 22 in the same manner as in New Product Process 5b according to the present embodiment, described earlier. The method described in Restoration Process 6 of Embodiment 4 can be used as the method for softening the hot melt again. However, in Restoration Process 8b according to the present embodiment, the developing unit 15 contains the refilled toner. It is therefore desirable for the developing cover 22 to be heated only around the periphery of the hot melt adhering to the periphery of the toner filling port 22h, to ensure the toner does not exceed the melting point.

While the hot melt is soft, the toner cap 31 is attached to the toner filling port 22h through the same procedure as New Product Process 5b of the present embodiment.

Embodiment 6 has been described thus far. According to the present embodiment, the toner cap 31 can be reused, and the restoration rate in the reproduction can be further improved. In addition, during the production process of the developing unit 15, the joint members can be grouped together as a single type of the hot melt 43, which makes it possible to reduce the production load involved in materials procurement and management.

Additionally, like the method described in Embodiment 5, in the present embodiment, the toner cap 31 can be attached to the toner filling port 22h while the residual hot melt remains cured, and the process for heating the joint portion can be performed thereafter as well. When the hot melt softens after attaching the toner cap 31, the hot melt 43 expands to the joint portion between the toner cap 31 and the toner filling port 22h, and the joint portion can be sealed without gaps.

### Embodiment 7

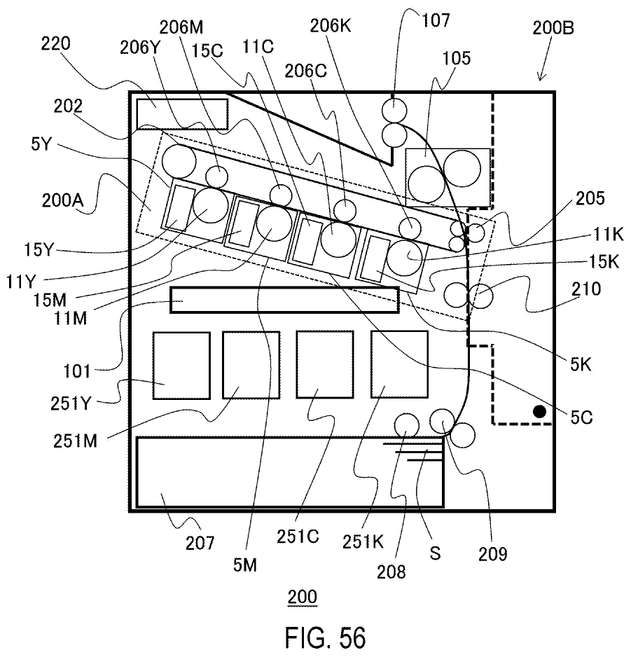

Embodiment 7 according to the present disclosure (an example of reproduction of a unit of a main body) pertains to a restoration process for an internal unit attached to the image forming apparatus body. Embodiment 7 of the present disclosure will be described with reference to FIG. 56.

FIG. 56 is a schematic cross-sectional view illustrating the overall configuration of a full-color laser printer 200 serving as an example of the image forming apparatus according to the present embodiment.

An overview of the full-color laser printer 200 will be described with reference to FIG. 56. Note that components having the same functions as the monochrome laser printer 1, which is the image forming apparatus according to Embodiment 4, will be given the same reference signs, and the functions will not be described again. The internal units according to the present embodiment are the toner cartridges 251Y, 251M, 251C, and 251K, and the waste toner collection container 220, which will be described later.

The laser printer 200 includes an apparatus body 200B including an electrophotographic image forming portion 200A, and the toner cartridges 251Y to 251K, each of which is removable from (attachable to/detachable from) the apparatus body 200B, as a plurality of cartridges. Note that “apparatus body 200B” according to the present embodiment refers to a part of the laser printer 200 excluding the toner cartridges 251Y to 251K.

The image forming portion 200A includes four process cartridges 5Y, 5M, 5C, and 5K, a laser scanner 101, an intermediate transfer belt 202, primary transfer rollers 206, and a secondary transfer roller 205.

The four process cartridges 5Y, 5M, 5C, and 5K have substantially identical configurations, except that the colors of toner contained in the developing units 15 differ from each other. In other words, each of the process cartridges 5Y to 5K includes a photosensitive drum 11 serving as an image bearing member and the developing unit 15 serving as a developer, as well as a charging apparatus and a cleaning apparatus (not shown). The process cartridges 5Y, 5M, 5C, and 5K are image forming units that form a monochrome toner image on the photosensitive drum 11 using yellow, magenta, cyan, and black toners, respectively.

The toner cartridges 251Y to 251K contain yellow, magenta, cyan, and black toners, respectively, as a developer for refilling the developing unit 15. The plurality of toner cartridges 251Y to 251K correspond to the plurality of developing units 15. The toner cartridges 251Y to 251K mounted in the apparatus body 200B are connected to (communicate with) the corresponding developing unit 15 via a refilling apparatus (a hopper) provided in the apparatus body 200B. If the toner contained in the toner cartridges 251Y to 251K is consumed and an image of a quality satisfactory to the user can no longer be formed, the toner cartridges can be replaced by the user.

Note that the developer contained in the developing unit 15 may be a two-component developer containing toner and a carrier, or may be a single-component developer mainly composed of toner. In addition, the developer contained in the toner cartridges 251Y to 251K may be composed of only toner, or a small amount of carrier may be mixed with the toner.

The intermediate transfer belt 202 is an endless intermediate transfer member. The intermediate transfer belt 202 is stretched over a plurality of rollers so as to contact the photosensitive drum 11 of each of the process cartridges 5Y to 5K, and is rotationally driven in the counterclockwise direction in the figure. The four primary transfer rollers 206 are disposed at positions opposite the photosensitive drums 11 of the process cartridges 5Y to 5K, respectively, with the intermediate transfer belt 202 therebetween. The secondary transfer roller 205 is disposed at a position opposite one of the rollers on which the intermediate transfer belt 202 is stretched (a secondary transfer inner roller), with the intermediate transfer belt 202 therebetween. A transfer portion where the image (the toner image) is transferred onto the sheet S (a secondary transfer portion) is formed as a nip portion between the intermediate transfer belt 202 and the secondary transfer roller 205. The process cartridges 5Y to 5K are disposed below the intermediate transfer belt 202, and the laser scanner 101 serving as an exposer is disposed below the process cartridges 5Y to 5K. The waste toner collection container 220, which collects toner remaining on the intermediate transfer belt 202 after the secondary transfer, is disposed to the upper-left of the intermediate transfer belt 202. The toner remaining on the intermediate transfer belt 202 is collected by a cleaning unit (not shown) and collected in the waste toner collection container 220. The waste toner collection container 220 can be replaced by the user when filled with waste toner.

The laser printer 200 also includes a fixing apparatus 105 as a fixer. The fixing apparatus 105 is a thermal fixing apparatus having, for example, a fixing roller, a pressure roller that is pressed against the fixing roller, and a halogen lamp serving as a heater for heating a toner image. The configuration is not limited to the foregoing, however, and for example, a ceramic heater may be disposed in an interior space of a flexible tubular film, and the toner image may be thermally fixed by a film heated by non-radiant heat from the ceramic heater.

Additionally, the laser printer 200 includes a mechanism for conveying the sheets S one by one and supplying the sheets to the image forming portion 200A. Specifically, a cassette 207 serving as a stacking portion (a storage portion) where the sheets S are stacked and stored, a pickup roller 208 that picks up the sheets S from the cassette 207, and a separation roller pair 209 that conveys the sheets S while separating the sheets S one by one are disposed. A registration roller pair 210, which conveys the sheet S fed from the cassette 207 to the secondary transfer portion, and the discharge roller pair 107, which discharges the sheet S that has passed through the secondary transfer portion and the fixing apparatus 105 to the outside of the apparatus body 200B, are also provided.

As described in the foregoing overall description of the laser printer 200, the toner cartridges 251Y, 251M, 251C, and 251K and the waste toner collection container 220, which are internal units, can be replaced by the user. The toner storage portions of the toner cartridges 251Y to 251K and the waste toner storage portion of the waste toner collection container 220 have the same joining configuration as the developing unit 15 according to Embodiment 4. In other words, the container serving as the first member and the lid serving as the second member are provided, and the container and the lid are joined by a hot melt serving as a joint member.

The toner cartridges 251Y to 251K and the waste toner collection container 220, which are used and have been replaced by the user, can be recycled to an equivalent level of quality as a new component by cleaning the interiors and performing maintenance on the internal components, in the same manner as the process cartridge 5. At this time, processes for disengaging and reengaging the joint portion formed by the hot melt can be performed in the same manner as with the restoration process for the developing unit 15, as described in Embodiment 4.

As described above, according to the present embodiment, components of other internal units in the image forming apparatus body, in addition to the process cartridge, can be reused without removing the hot melt remaining during the disassembly in the reproduction process. As a result, the labor involved in the reproduction can be greatly reduced, and the hot melt that has thus far been discarded can also be reused. An internal component having the same performance as a new product can be reproduced at a low cost, while avoiding distortion in the frame body, enabling precision components to be positioned as normal, and ensuring toner leakage and image defects do not occur.

Although the present embodiment describes the toner cartridges 251 and the waste toner collection container 220 as internal units of the laser printer as examples, the internal units to which the present disclosure can be applied are not limited thereto. For example, if a unit can be reused by disassembling and rejoining the joint portions for other components in the image forming apparatus body, the present disclosure can be applied, and provides the same effects.

In the present embodiment, the toner cartridges 251 and the waste toner collection container 220 are described as units that can be replaced by the user, but the units to which the present disclosure can be applied are not limited to those configurations. For example, even with a unit that cannot be replaced while the image forming apparatus body is being used, if the unit can be reused by disassembling and rejoining the joint portions when remanufacturing the image forming apparatus body, the same effects can be achieved.

According to the present disclosure, the manufacturing cost of a container containing developer used in an image forming apparatus can be reduced.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-073052, filed Apr. 25, 2025 and Japanese Patent Application No. 2025-072945, filed Apr. 25, 2025, which are hereby incorporated by references herein in their entirety.

What is claimed is:

1. A restoration method for restoring a first member of a unit used in an image forming apparatus to a reusable state, the unit including the first member having a first engagement portion, a second member having a second engagement portion engaged with the first engagement portion, and a connecting member interposed between the first engagement portion and the second engagement portion and connected to both the first member and the second member, at least one of the first engagement portion and the second engagement portion includes a recessed portion and the other of the first engagement portion and the second engagement portion being configured to be engageable with the recessed portion by entering into the recessed portion, the restoration method comprising:
a separating step of separating the first member and the second member;
an adhering step of adhering the connecting member, which remains on the first engagement portion and which is heated, to a third engagement portion of a removal tool by bringing the third engagement portion into engagement with the first engagement portion of the first member; and
a removing step of removing the connecting member from the first member by separating the removal tool from the first engagement portion of the first member.

2. The restoration method according to claim 1, wherein
in the adhering step, the third engagement portion of the removal tool is heated to a temperature at which the connecting member melts when the third engagement portion contacts the connecting member.

3. The restoration method according to claim 2, wherein
in the adhering step, the third engagement portion of the removal tool is heated to a temperature not higher than a glass transition point of the first member.

4. The restoration method according to claim 1, further comprising:
a heating step of heating the first member and melting the connecting member before the adhering step.

5. The restoration method according to claim 4, wherein
in the adhering step, the first member is heated to a temperature not higher than a glass transition point of the first member.

6. The restoration method according to claim 1, wherein
one of the first member and the second member is a first frame body provided with an opening and having a first surface extending along an edge of the opening, and a remaining one of the first member and the second member is a second frame body connected to the first frame body so as to cover the opening and having a second surface opposing the first surface and extending along a direction in which the first surface extends,
one of the first engagement portion and the second engagement portion includes a projection provided on one of the first surface and the second surface, and a remaining one of the first engagement portion and the second engagement portion includes a recess provided on a remaining one of the first surface and the second surface,
the protruding portion is inserted into the recessed portion such that a tip surface of the protruding portion and a bottom surface of the recessed portion do not contact, and
the connecting member is provided between the protruding portion and the recessed portion so as to contact both the tip surface of the protruding portion and the bottom surface of the recessed portion.

7. The restoration method according to claim 6, wherein
the first engagement portion is the recessed portion and the second engagement portion is the protruding portion,
in a case in which a direction in which the removal tool approaches the first member in the adhering step is taken as an approach direction and a direction in which the removal tool separates from the first member in the removing step is taken as a separation direction,
the third engagement portion of the removal tool has an adhering surface facing in the separation direction and is configured to be insertable into the recessed portion, and a distance from an end surface of the removal tool in the approach direction to the adhering surface is smaller than a depth of the recessed portion, and
in the adhering step, the connecting member is adhered to the adhering surface by engaging the third engagement portion with the recessed portion.

8. The restoration method according to claim 7, wherein
the adhering surface is an end surface of the third engagement portion in the separation direction.

9. The restoration method according to claim 7, wherein
the adhering surface is provided in plurality and the plurality of adhering surfaces are formed in the third engagement portion.

10. The restoration method according to claim 7, wherein
the adhering surface is formed inside the third engagement portion, and
the third engagement portion has a first hole extending from an end surface of the third engagement portion in the approach direction to the adhering surface and a second hole extending from the adhering surface to an end surface of the third engagement portion in the separation direction.

11. The restoration method according to claim 6, wherein
the first engagement portion is the protruding portion and the second engagement portion is the recessed portion,
in a case in which a direction in which the removal tool approaches the first member in the adhering step is taken as an approach direction and a direction in which the removal tool separates from the first member in the removing step is taken as a separation direction,
the third engagement portion has a tip surface in the approach direction, a groove recessed from the tip surface in the separation direction and configured such that the protruding portion is insertable thereinto, and a step recessed from the tip surface in the separation direction and disposed adjacent to the groove in a view in the separation direction, and
in the adhering step, the connecting member is adhered to the step by engaging the third engagement portion with the protruding portion.

12. The restoration method according to claim 11, wherein
the adhering and the removing are performed, with the tip surface facing upward in a vertical direction.

13. The restoration method according to claim 6, wherein
the first engagement portion extends annularly along the edge of the opening, and
the third engagement portion extends annularly along the first engagement portion.

14. The restoration method according to claim 13, wherein
the first engagement portion includes a first portion that is flat and a second portion that is flat at a different position from that of the first portion in a direction along the edge, and
the second portion extends in such a manner as to be farther away from the first portion in a direction orthogonal to the first portion as the second portion extends in the direction along the edge.

15. The restoration method according to claim 1, wherein
the first member has a first positioning portion, and the second member has a second positioning portion that engages with the first positioning portion and positions the second member relative to the first member,
the removal tool has a third positioning portion that engages with the first positioning portion and positions the removal tool relative to the first member, and
in the adhering, the third positioning portion is engaged with the first positioning portion.

16. The restoration method according to claim 1, wherein
the first member and the second member are formed of a resin.

17. The restoration method according to claim 1, wherein
the connecting member is formed by curing a molten resin.

18. The restoration method according to claim 1, wherein
the unit is a developing unit, including a developing roller and a developer storage chamber containing developer therein, and configured to be attachable to and detachable from a body of the image forming apparatus, and
one of the first member and the second member is a first frame body inside which the developing roller is provided and which constitutes a part of the developer storage chamber, and the other of the first member and the second member is a second frame body constituting the developer storage chamber, together with the first member.

19. The restoration method according to claim 1, wherein
the unit is a toner cartridge, having a developer storage chamber containing developer therein, and configured to be attachable to and detachable from a body of the image forming apparatus, and
one of the first member and the second member is a container constituting the developer storage chamber, and the other of the first member and the second member is a lid to be connected to the container.

20. The restoration method according to claim 1, wherein
the unit is a waste toner collection container, including a waste toner storage chamber to collect and contain therein waste toner generated by the image forming apparatus, and configured to be attachable to and detachable from a body of the image forming apparatus, and
one of the first member and the second member is a container constituting the waste toner storage chamber, and the other of the first member and the second member is a lid to be connected to the container.

21. The restoration method according to claim 1, wherein
the unit is a unit fixed to the body of the image forming apparatus to be non-removable.

22. A method for manufacturing a unit used in an image forming apparatus, the unit including the first member having a first engagement portion, a second member having a second engagement portion engaged with the first engagement portion, and a connecting member interposed between the first engagement portion and the second engagement portion and connected to both the first member and the second member, at least one of the first engagement portion and the second engagement portion includes a recessed portion and the other of the first engagement portion and the second engagement portion being configured to be engageable with the recessed portion by entering into the recessed portion, the manufacturing method comprising:
a joining step of joining the first member restored by a restoration method with the second member using the connecting member, wherein
the restoration method for the first member comprises:
a separating step of separating the first member and the second member;
an adhering step of adhering the connecting member, which remains on the first engagement portion and which is heated, to a third engagement portion of a removal tool by bringing the third engagement portion into engagement with the first engagement portion of the first member; and
a removing step of removing the connecting member from the first member by separating the removal tool from the first engagement portion of the first member.

23. A method for manufacturing a container for containing a developer, the container including:
a first member provided with an opening, the first member having a first surface extending along an edge of the opening;
a second member covering the opening and forming a storage portion for containing the developer, together with the first member, the second member having a second surface extending along a direction, in which the first surface extends, while opposing the first surface; and
a connecting member that is connected to both the first surface and the second surface and having thermoplasticity, and
the method for manufacturing the container comprising:
a heating step of heating at least one of the first member and the second member to which the connecting member in a hardened state adheres, in a state where the first surface and the second surface are not connected via the connecting member, to at least a temperature at which the connecting member softens.

24. The method for manufacturing the container according to claim 23, further comprising:
a positioning step of positioning the first member and the second member such that the first surface and the second surface oppose each other in a state where the connecting member is softened by the heating step.

25. The method for manufacturing the container according to claim 23, further comprising:
a positioning step of positioning the first member and the second member such that the first surface and the second surface oppose each other before the heating step.

26. The method for manufacturing the container according to claim 23, wherein
in the heating step, the temperature to which the one of the first member and the second member is heated is a temperature lower than a glass transition point of a material of each of the first member and the second member.

27. The method for manufacturing the container according to claim 23, further comprising:
a separating step of separating the first member and the second member connected by the connecting member before the heating step.

28. The method for manufacturing the container according to claim 27, further comprising:
a removing step of, prior to the separating step, removing developer remaining in the storage portion;
a connecting step of, after the heating step, connecting the first member and the second member using the connecting member by curing the connecting member, in a state where the first member and the second member are positioned such that the first surface and the second surface oppose each other; and
a refilling step of, after the connecting step, refilling the storage portion with developer.

29. The method for manufacturing the container according to claim 23, further comprising:
an applying step of, before the heating step, applying the connecting member to the one of the first member and the second member;
a connecting step of, after the heating step, connecting the first member and the second member using the connecting member by curing the connecting member, in a state where the first member and the second member are positioned such that the first surface and the second surface oppose each other; and
a filling step of, after the connecting step, filling the storage portion with developer for a first time.

30. The method for manufacturing the container according to claim 23, wherein
the container further includes:
a protruding portion provided on one of the first surface and the second surface; and
a recessed portion, which is provided on the other of the first surface and the second surface and into which the protruding portion is inserted such that a tip surface of the protruding portion and a bottom surface of the recessed portion are not in contact, and
the connecting member is provided between the protruding portion and the recessed portion to adhere to both the tip surface of the protruding portion and the bottom surface of the recessed portion.

31. The method for manufacturing the container according to claim 23, wherein
the container includes a recessed portion provided on the one of the first surface and the second surface, and
the manufacturing method for the container further comprises an applying step of applying the connecting member to the recessed portion.

32. The method for manufacturing the container according to claim 23, wherein
the container further includes:
a first protruding portion provided on the first surface; and
a second protruding portion provided on the second surface, the second protruding portion positioned further outward than the first protruding portion in a direction from an interior of the storage portion toward an exterior thereof, and
the method for manufacturing the container further comprises an applying step of applying the connecting member to the second surface at a position further inward than the second protruding portion.

33. The method for manufacturing the container according to claim 23, wherein
the first surface extends annularly along the edge of the opening, and
the second surface extends annularly along the first surface.

34. The method for manufacturing the container according to claim 23, wherein
the first member is a first frame body constituting a frame body of the container, and
the second member is a second frame body constituting the frame body of the container, together with the first frame body.

35. The method for manufacturing the container according to claim 34, wherein
the container includes a developing roller configured to bear a developer, the developing roller being rotatably supported by the first frame body.

36. The method for manufacturing the container according to claim 34, wherein
the container further includes:
a photosensitive drum configured to bear a toner image; and
a cleaning member fixed to the first frame body to contact the photosensitive drum, and
the storage portion is configured to contain developer removed from the photosensitive drum by the cleaning member.

37. The method for manufacturing the container according to claim 23, wherein
the first member is a member constituting a frame body of the container,
the opening is a filling port for the developer, and
the second member is a cap for sealing the filling port.

38. A method for disassembling a container for containing a developer, the container including:
a first member provided with an opening, the first member having a first surface extending along an edge of the opening;
a second member covering the opening and forming a storage portion for containing the developer, together with the first member, the second member having a second surface extending along a direction, in which the first surface extends, while opposing the first surface; and
a connecting member that is connected to both the first surface and the second surface and having thermoplasticity, and
the method for disassembling the container comprising:
a heating step of heating at least one of the first member and the second member for which the first surface and the second surface are connected by the connecting member, to at least a temperature at which the connecting member softens; and
a separating step of separating the first member and the second member such that the first member and the second member are not connected by the connecting member in a state where the connecting member is softened by the heating.
